(19) United States
(12) Patent Application Publication
(10) Pub. No.: US 2014/0013735 A1
(43) Pub. Date: Jan. 16, 2014

(54) FLUID STORAGE IN COMPRESSED-GAS ENERGY STORAGE AND RECOVERY SYSTEMS

(71) Applicants: Troy O. McBride, Norwich, VT (US); David Perkins, Kensington, NH (US); Dax Kepshire, Amesbury, MA (US); Benjamin R. Bollinger, Topsfield, MA (US); Arne LaVen, Hampton, NH (US); Jon Bessette, Tewksbury, MA (US)

(72) Inventors: Troy O. McBride, Norwich, VT (US); David Perkins, Kensington, NH (US); Dax Kepshire, Amesbury, MA (US); Benjamin R. Bollinger, Topsfield, MA (US); Arne LaVen, Hampton, NH (US); Jon Bessette, Tewksbury, MA (US)

(21) Appl. No.: 14/024,960

(22) Filed: Sep. 12, 2013

Related U.S. Application Data
(63) Continuation of application No. 13/827,465, filed on Mar. 14, 2013.
(60) Provisional application No. 61/659,164, filed on Jun. 13, 2012.
(60) Provisional application No. 61/695,393, filed on Aug. 31, 2012.

(51) Int. Cl. F17C 1/00

(52) U.S. Cl. CPC F17C 1/007
USPC 60/398

(57) ABSTRACT

In various embodiments, lined underground reservoirs and/or insulated pipeline vessels are utilized for storage of compressed fluid in conjunction with energy storage and recovery systems.

### RELATED APPLICATIONS

This application is a continuation of U.S. patent application Ser. No. 13/827,465, filed Mar. 14, 2013, which claims the benefit of and priority to U.S. Provisional Patent Application No. 61/659,164, filed Jun. 13, 2012, and U.S. Provisional Patent Application No. 61/695,393, filed Aug. 31, 2012. The entire disclosure of each of these applications is hereby incorporated herein by reference.

### STATEMENT REGARDING FEDERALLY SPONSORED RESEARCH

This invention was made with government support under DE-OE0000231 awarded by the DOE. The government has certain rights in the invention.

### FIELD OF THE INVENTION

In various embodiments, the present invention relates to gas storage, gas distribution, pneumatics, power generation, and energy storage, and more particularly, to fluid systems for energy storage and recovery.

### BACKGROUND

It is often desirable to store energy in the form of a fluid, such as compressed air or a fluid fuel (e.g., methane), that may be at non-ambient temperature and under high pressure (e.g., 3,000 psi). The energy may be stored at times of low demand or over supply, and the stored energy may be utilized at times of high demand or low supply in various ways: for example, methane may be used to generate industrial process heat, compressed air may be used to power mechanical devices directly, and methane or compressed air may be used by power generators that produce electricity. Retrievable or reversible modes of energy storage include chemical potential energy (i.e., fuel), elastic potential energy (i.e., the energy inherent in a compressed gas or liquid or in a compressed or stretched elastic solid), gravitational potential energy (i.e., the energy inherent in any mass by virtue of its altitude), latent energy (i.e., the energy inherent in a body by virtue of its phase state), electric energy (e.g., the energy inherent in separated electrical charges, as in a charged battery or capacitor), and exergy (i.e., the extractable work latent in a body that is at a temperature higher or lower than the temperature of a heat reservoir such as the body's environment). In systems that employ an energy-storing fluid, the cost of insulated and/or pressure-resistant vessels to contain the fluid is often a large part of the net cost, over the lifetime of the system, of storing and retrieving an average unit of energy.

Storing energy in the form of compressed gas has a long history and components tend to be well tested and reliable, and have long lifetimes. The general principle of compressed-gas or compressed-air energy storage (CAES) is that generated energy (e.g., electric energy) is used to compress gas (e.g., air), thus converting the original energy to pressure potential energy; this potential energy is later recovered in a useful form (e.g., converted back to electricity) via gas expansion coupled to an appropriate mechanism. Advantages of compressed-gas energy storage include low specific-energy costs, long lifetime, low maintenance, reasonable energy density, and good reliability.

If a body of gas is at the same temperature as its environment, and expansion occurs slowly relative to the rate of heat exchange between the gas and its environment, then the gas will remain at approximately constant temperature as it expands. This process is termed “isothermal” expansion. Isothermal expansion of a quantity of high-pressure gas stored at a given temperature recovers approximately three times more work than would “adiabatic expansion,” that is, expansion where no heat is exchanged between the gas and its environment—e.g., because the expansion happens rapidly or in an insulated chamber. Gas may also be compressed isothermally or adiabatically.

An ideally isothermal energy-storage cycle of compression, storage, and expansion would have 100% thermodynamic efficiency. An ideally adiabatic energy-storage cycle would also have 100% thermodynamic efficiency, but there are many practical disadvantages to the adiabatic approach. These include the production of higher temperature and pressure extremes within the system, heat loss during the storage period, and inability to exploit environmental (e.g., cogenerative) heat sources and sinks during expansion and compression, respectively. In an isothermal system, the cost of adding a heat-exchange system is traded against resolving the difficulties of the adiabatic approach. In either case, mechanical energy from expanding gas is typically converted to electrical energy before use.

An efficient and novel design for storing energy in the form of compressed gas utilizing near isothermal gas compression and expansion has been shown and described in U.S. Pat. No. 7,832,207, filed Apr. 9, 2009 (the '207 patent) and U.S. Pat. No. 7,874,155, filed Feb. 25, 2010 (the '155 patent), the disclosures of which are hereby incorporated herein by reference in their entireties. The '207 and '155 patents disclose systems and techniques for expanding gas isothermally in staged cylinders and intensifiers over a large pressure range in order to generate electrical energy when required. Mechanical energy from the expanding gas may be used to drive a hydraulic pump/motor subsystem that produces electricity. Systems and techniques for hydraulic-pneumatic pressure intensification that may be employed in systems and methods such as those disclosed in the '207 and '155 patents are shown and described in U.S. Pat. No. 8,037,678, filed Sep. 10, 2010 (the '678 patent), the disclosure of which is hereby incorporated herein by reference in its entirety.

In the systems disclosed in the '207 and '155 patents, reciprocal mechanical motion is produced during recovery of energy from storage by expansion of gas in the cylinders. This reciprocal motion may be converted to electricity by a variety of techniques, for example as disclosed in the '678 patent as well as in U.S. Pat. No. 8,117,842, filed Feb. 14, 2011 (the '842 patent), the disclosure of which is hereby incorporated herein by reference in its entirety. The ability of such systems to either store energy (i.e., use energy to compress gas into a storage reservoir) or produce energy (i.e., expand gas from a storage reservoir to release energy) will be apparent to any person reasonably familiar with the principles of electrical and pneumatic machines.

The net monetary cost at which energy-storage systems deliver from storage a unit of energy (e.g., a kilowatt hour [kWh] of electrical energy, a BTU of natural gas) depends in part on the cost at which the system stores each unit of compressed gas. The net cost of energy storage by a system employing compressed gas is also influenced by the cost of conditioning the stored, compressed gas by heating, cooling, and/or the addition and removal of other gases or fluids. There is therefore a need for facilities that can store and in some cases thermally condition large quantities of compressed gas at relatively low cost, including the costs of construction and maintenance.

### SUMMARY

In various embodiments, the invention includes the employment of one or more pressure vessels and/or one or more insulated pipeline vessels (IPVs) and/or one or more lined underground reservoirs (LURs) as pressurized-fluid storage containers for a system that stores energy in the form of a compressed fluid (e.g., high pressure gas). The terms “IPV” and “LUR” will be clarified shortly, below. In general, the quantity of energy to be stored may be characterized as “low,” “medium,” or “large.” The cost-effectiveness of a storage container type is, in general, affected by the quantity of energy (i.e., fluid) to be stored. For storage of low energy quantities, pressure vessels (e.g., commercially-produced cylindrical tanks) and/or IPVs will in general be most cost-effective for fluid storage; for storage of medium energy quantities, IPVs and/or LURs will in general be most cost-effective for fluid storage; and for storage of large energy quantities, LURs and/or large scale geological storage (e.g., salt cavern, aquifer) will be in general be most cost-effective for fluid storage.

Herein, the terms “thermal energy” and “exergy” are employed interchangeably, usually to signify extractable work latent in a body that is at a temperature higher than that of the body's environment. Hybrid systems that store energy in one or more fluids that contain energy in one or more retrievable or reversible forms can also be envisaged and are contemplated herein even when not explicitly mentioned or described.

The term “insulated pipeline vessel” or “IPV” refers herein to a segment of pressure-resistant pipeline (e.g., pipeline designed to transport natural gas), of whatever length, that has been sealed at its ends (other than to the extent that perforations are provided for the delivery of fluids into and removal of fluids from the IPV) and covered by one or more layers of insulation and possibly by other protective materials as well. Herein, “IPV” may also refer to a series of pipe segments joined together and sealed, or an array of such segments or series of joined segments. An array of pipe segments employed as an IPV is herein referred to as an “IPV array.” An IPV also may be equipped with perforations, valves, and other devices to control the admission and release of gas and/or liquid; may be equipped with sensors for detecting and reporting flow, volume, temperature, pressure, strain, or other qualities of the vessel's contents or of the vessel's own fabric; may contain devices for the exchange of heat between the vessel's fluid contents and external sources or sinks of thermal energy; and may be encased in or buried under a layer or layers of earth, gravel, or other materials. The term “insulated pipeline vessel” or “IPV” may also refer herein to two or more IPVs, as just described, interconnected so as to form a single system for the storage of fluid. IPVs may have lengths well in excess (e.g., >100×) of their diameters, and may not fall within ASME regulations for pressure vessels. IPVs may include or consist essentially of (i) a thermally insulating material (e.g., one or more plastics or polymers) or (ii) a base material that is more conductive (e.g., one or more metals or metal alloys such as steel) that is (a) at least partially buried within an insulating material (e.g., earth, soil, gravel, etc.), (b) has a thermally insulating material impregnated therewithin, and/or (c) has a thermally insulating material disposed on its inner and/or outer surface. In various embodiments, the thermal heat conduction through the walls of the IPV is no greater than 5 Watts per degree Celsius per cubic meter of storage volume (e.g., no more than 250 Watts lost due to heat conduction for fluid contained in an IPV, where the fluid is 50° C. warmer than the surroundings, for every 1.3 meter length of a 1 meter inner diameter pipe), and in preferred embodiments the thermal conductance is no greater than 2 Watts per degree Celsius per cubic meter of storage volume, or even no greater than 1 Watt per degree Celsius per cubic meter of storage volume. For reference, an uninsulated pipe may lose more than 1000 watts (W) per degree Celsius per cubic meter of storage volume (e.g., more than 50,000 W lost due to heat conduction for fluid contained in the pipe, where the fluid is 50° C. warmer than the surroundings, for every 1.3 meter length of a 1 meter inner diameter pipe).

An LUR is a cavity in rock (primarily crystalline bedrock) that is lined with steel, concrete, and/or other materials that enable the cavity to serve as a vessel containing fluids (e.g., natural gas, air, an air-water mixture) at high pressure (e.g., 150 atmospheres, 250 atmospheres, or higher) without significant fluid leakage either into or out of the cavity. Various embodiments of the invention employ techniques for the excavation of open, vertical shafts in the construction of LURs and for the thermal conditioning of fluids stored in LURs that have been constructed by open-shaft and other techniques.

Typically, construction of an LUR entails excavation of a large, vertically cylindrical cavity (e.g., 20-50 meters in diameter and 50-115 meters tall) with a domed roof and rounded invert (floor). Excavation may be via sloping access tunnels or the sinking of a vertical shaft. The domed roof may be constructed after excavation of the cavity. A vertically oriented shape enhances the stability of the excavation by minimizing roof area, while rounding of the roof and the invert increases roof strength and enables fluid-pressure stresses on the inner liner (e.g., steel skin) to be distributed more evenly.

An LUR cavity may be located at various depths below the ground (e.g., 100 meters to 200 meters), depending on rock type and other constraints, and may be lined with a multi-layer lining that may be constructed, wholly or partly, either during excavation or after excavation. The lining typically includes a layer of reinforced concrete (e.g., approximately 1 meter thick) and a thin (e.g., 12-15 mm) inner liner of carbon steel. The lining may also include other layers, such as a layer of thermal insulation (e.g., perlite concrete) and/or a network of pipes to drain groundwater away from the cavity liner. One purpose of the inner liner is to act as an impermeable barrier, both to retain the fluid contents of the cavity and to keep fluids (e.g., groundwater) from entering the cavity. A purpose of the concrete layer is to act as a distributor of forces exerted by the contents of the LUR on the surrounding lining layers and rock mass, and by the surrounding rock mass on the LUR lining layers: that is, the concrete layer assures the most even possible transfer of forces from fluid within the LUR to the surrounding rock mass and distributes any local strains in the rock mass (e.g., from the opening of natural rock fractures) at the concrete/rock interface) as evenly as possible across the concrete and thus across the inner liner. Smooth distribution of forces across the inner liner is desirable because the inner liner is typically thin (to conserve materials and so reduce cost): its composition and thickness, and hence its cost, will depend on the maximum local circumferential strain that any part of it must be able to resist during operation. Therefore, preventing the occurrence of excessive local strain on any part of the inner liner is advantageous.

To further minimize local circumferential strains on the inner liner, a viscous layer (e.g., approximately 5 mm thick and made of a bituminous (tarry) material) may be placed between the steel and the concrete layers of the liner. This viscous layer will allow some slippage between the inner liner and the concrete, contributing to the reduction of local strains.

These and other features and advantages of LUR linings in various embodiments of the invention will be further disclosed and clarified in the drawings and accompanying explanations. The foregoing description of liner construction techniques and materials is exemplary: other techniques for construction, and other materials for the inner liner and various other portions of the cavity liner, may be employed.

Conventional storage facilities for compressed gas rely primarily on (a) compressed-gas bottles, or (b) depleted oil fields, salt caverns, or aquifer formations, into which compressed gas may be injected. The use of oil fields, salt caverns, and aquifers tightly constrains site selection, which is disadvantageous. The various surface-vessel options tend to occupy relatively large areas of land, which can be site-constraining, and are materials-intensive, which raises cost. For a commercially realistic energy-storage capacity, the areal footprint of a compressed gas energy storage and generation facility located at or near the surface of the earth will typically consist mostly of storage.

A number of advantages are realized by using LURs with energy storage systems relying on compressed gas. An LUR facility, both during and after construction, tends to disturb its surface environs relatively little compared to surface-sited storage facilities of comparable capacity, which, as noted above, can occupy significant area. The ability to site an LUR wherever suitable earth material (e.g., bedrock) allows for the construction of energy storage and generation facilities nearer to demand in some cases, reducing transmission costs. Herein, any earth material suitable for the construction of an LUR is referred to as “bedrock.” Being embedded deeply in bedrock, LURs are relatively secure from accidental or malicious damage, making compressed-gas LURs a particularly safe way to store large amounts of energy; indeed, compressed-air LUR storage is probably one of the safest ways to store large amounts of energy yet devised, since LUR air storage is not accompanied by the possibility of detonation, deflagration, explosive decompression, dam bursting, release of toxins, release of suffocating gases, and other hazards associated with various other energy-storage technologies. The environmental impact of a compressed-air LUR is low both because its surface footprint is low and its water usage is low compared to pumped-reservoir storage, the latter being especially of advantage in arid or semiarid regions.

Another advantage of compressed-gas LUR storage is that an LUR may enable the storage of compressed gas fluids at lower per-unit cost than most other methods of storage. Lower cost is achieved because in an LUR, outward-acting pressure forces are borne by surrounding bedrock rather than by the constructed fabric of the vessel itself. This greatly reduces the quantities of relatively expensive materials (e.g., steel, carbon fiber, reinforced concrete) needed to contain each unit of pressurized fluid as compared to free-standing high-pressure vessels that must bear all loads internally. Further, because an LUR may be relatively large (e.g., approximately 30,000 m³), its surface-to-volume ratio is low compared to that of a multiplicity of smaller vessels, further reducing material and construction costs per unit of fluid stored.

Another potential advantage is that an LUR may, when the temperature of its contents is lower than that of the surrounding rock, harvest energy from the earth's innate heat. Heat that flows from surrounding rock to fluids in an LUR may be partially converted to electricity by the energy-conversion portion of an energy storage and generation system.

Provisions may be made for the exchange of heat between a heat-transfer fluid (e.g., water with additives) and the air (or other gas) within an LUR: for example, water may be sprayed or foamed into the LUR to either warm or cool the air within, and may then be pumped out to partake in further heat exchanges and/or to be recycled within the system. Such provisions may be advantageous for the operation of an energy storage and generation system. For example, lowering the temperature of fluids within an LUR may be employed to reduce energy loss to, or increase energy gain from, surrounding rock, or may be employed to reduce pressure changes and associated mechanical stresses on the LUR's lining layers and surrounding rock. Such provisions may enable the conveyance of heat obtained from external surface sources (e.g., waste heat from a thermal power plant) to the fluid contents of the LUR, in which case the LUR will store energy both as the elastic potential energy of compressed air and as the thermal energy of warm fluids.

The construction of LURs as storage reservoirs for energy-storage systems employing compressed air and near-isothermal compression and expansion is therefore advantageous as regards surface footprint, siting flexibility, safety, cost per unit of energy stored, and other aspects of cost and operation.

Embodiments of the present invention may be utilized in energy storage and generation systems utilizing compressed gas. In a compressed-gas energy storage system, gas is stored at high pressure (e.g., approximately 3,000 psi). This gas may be expanded into a cylinder having a first compartment (or “chamber”) and a second compartment separated by a piston slidably disposed within the cylinder (or by another boundary mechanism). A shaft may be coupled to the piston and extend through the first compartment and/or the second compartment of the cylinder and beyond an end cap of the cylinder, and a transmission mechanism may be coupled to the shaft for converting a reciprocal motion of the shaft into a rotary motion, as described in the '678 and '842 patents. Moreover, a motor/generator may be coupled to the transmission mechanism. Alternatively or additionally, the shaft of the cylinders may be coupled to one or more linear generators, as described in the '842 patent.

As also described in the '842 patent, the range of forces produced by expanding a given quantity of gas in a given time may be reduced through the addition of multiple, series-connected cylinder stages. That is, as gas from a high-pressure reservoir is expanded in one chamber of a first, high-pressure cylinder, gas from the other chamber of the first cylinder is directed to the expansion chamber of a second, lower-pressure cylinder. Gas from the lower-pressure chamber of this second cylinder may either be vented to the environment or directed to the expansion chamber of a third cylinder operating at still lower pressure; the third cylinder may be similarly connected to a fourth cylinder; and so on.

The principle may be extended to more than two cylinders to suit particular applications. For example, a narrower output force range for a given range of reservoir pressures is achieved by having a first, high-pressure cylinder operating between, for example, approximately 3,000 psig and approximately 300 psig and a second, larger-volume, lower-pressure cylinder operating between, for example, approximately 300 psig and approximately 30 psig. When two expansion cylinders are used, the range of pressure within either cylinder (and thus the range of force produced by either cylinder) is reduced as the square root relative to the range of pressure (or force) experienced with a single expansion cylinder, e.g., from approximately 100:1 to approximately 10:1 (as set forth in the '853 application). Furthermore, as set forth in the '678 patent, N appropriately sized cylinders can reduce an original operating pressure range R to R^{1/N}. Any group of N cylinders staged in this manner, where N≧2, is herein termed a cylinder group.

Every compression or expansion of a quantity of gas, where such a compression or expansion is herein termed “a gas process,” is generally one of three types: (1) adiabatic, during which the gas exchanges no heat with its environment and, consequently, rises or falls in temperature, (2) isothermal, during which the gas exchanges heat with its environment in such a way as to remain at constant temperature, and (3) polytropic, during which the gas exchanges heat with its environment but its temperature does not remain constant. Perfectly adiabatic gas processes are not practical because some heat is always exchanged between any body of gas and its environment (ideal insulators and reflectors do not exist); perfectly isothermal gas processes are not practical because for heat to flow between a quantity of gas and a portion of its environment (e.g., a body of liquid), a nonzero temperature difference must exist between the gas and its environment—e.g., the gas must be allowed to heat during compression in order that heat may be conducted to the liquid. Hence real-world gas processes are typically polytropic, though they may approximate adiabatic or isothermal processes.

The Ideal Gas Law states that for a given quantity of gas having mass m, pressure p, volume V, and temperature T, pV=mRT, where R is the gas constant (R=287 J/K·kg for air). For an isothermal process, T is a constant throughout the process, so pV=C, where C is some constant.

For a polytropic process, as will be clear to persons familiar with the science of thermodynamics, pVⁿ=C throughout the process, where n, termed the polytropic index, is some constant generally between 1.0 and 1.6. For n=1, pVⁿ=pV^{l}=pV=C, i.e., the process is isothermal. In general, a process for which n is close to 1 (e.g., 1.05) may be deemed approximately isothermal.

For an adiabatic process, pV^{γ}=C, where γ, termed the adiabatic coefficient, is equal to the ratio of the gas's heat capacity at constant pressure C_{P} to its heat capacity at constant volume, C_{V}, i.e., γ=C_{P}/C_{V}. In practice, γ is dependent on pressure. For air, the adiabatic coefficient γ is typically between 1.4 and 1.6.

Herein, we define a “substantially isothermal” gas process as one having n≦1.1. The gas processes conducted within cylinders described herein are preferably substantially isothermal with n≦1.05. Herein, wherever a gas process taking place within a cylinder assembly or storage reservoir is described as “isothermal,” this word is synonymous with the term “substantially isothermal.”

The amount of work done in compression or expansion of a given quantity of gas varies substantially with polytropic index n. For compressions, the lowest amount of work done is for an isothermal process and the highest for an adiabatic process, and vice versa for expansions. Hence, for gas processes such as typically occur in the compressed-gas energy storage systems described herein, the end temperatures attained by adiabatic, isothermal, and substantially isothermal gas processes are sufficiently different to have practical impact on the operability and efficiency of such systems. Similarly, the thermal efficiencies of adiabatic, isothermal, and substantially isothermal gas processes are sufficiently different to have practical impact on the overall efficiency of such energy storage systems. For example, for compression of a quantity of gas from initial temperature of 20° C. and initial pressure of 0 psig (atmospheric) to a final pressure of 180 psig, the final temperature T of the gas will be exactly 20° C. for an isothermal process, approximately 295° C. for an adiabatic process, approximately 95° C. for a polytropic compression having polytropic index n=1.1 (10% increase in n over isothermal case of n=1), and approximately 60° C. for a polytropic compression having polytropic index n=1.05 (5% increase in n over isothermal case of n=1). In another example, for compression of 1.6 kg of air from an initial temperature of 20° C. and initial pressure of 0 psig (atmospheric) to a final pressure of approximately 180 psig, including compressing the gas into a storage reservoir at 180 psig, isothermal compression requires approximately 355 kilojoules of work, adiabatic compression requires approximately 520 kilojoules of work, and a polytropic compression having polytropic index n=1.045 requires approximately 375 kilojoules of work; that is, the polytropic compression requires approximately 5% more work than the isothermal process, and the adiabatic process requires approximately 46% more work than the isothermal process.

It is possible to estimate the polytropic index n of gas processes occurring in cylinder assemblies such as are described herein by empirically fitting n to the equation pVⁿ=C, where pressure p and volume V of gas during a compression or expansion, e.g., within a cylinder, may both be measured as functions of time from piston position, known device dimensions, and pressure-transducer measurements. Moreover, by the Ideal Gas Law, temperature within the cylinder may be estimated from p and V, as an alternative to direct measurement by a transducer (e.g., thermocouple, resistance thermal detector, thermistor) located within the cylinder and in contact with its fluid contents. In many cases, an indirect measurement of temperature via volume and pressure may be more rapid and more representative of the entire volume than a slower point measurement from a temperature transducer. Thus, temperature measurements and monitoring described herein may be performed directly via one or more transducers, or indirectly as described above, and a “temperature sensor” may be one of such one or more transducers and/or one or more sensors for the indirect measurement of temperature, e.g., volume, pressure, and/or piston-position sensors.

The systems described herein, and/or other embodiments employing foam-based heat exchange, liquid-spray heat exchange, and/or external gas heat exchange, may draw or deliver thermal energy via their heat-exchange mechanisms to external systems (not shown) for purposes of cogeneration, as described in U.S. Pat. No. 7,958,731, filed Jan. 20, 2010 (the '731 patent), the entire disclosure of which is incorporated by reference herein.

The compressed-air energy storage and recovery systems described herein are preferably “open-air” systems, i.e., systems that take in air from the ambient atmosphere for compression and vent air back to the ambient atmosphere after expansion, rather than systems that compress and expand a captured volume of gas in a sealed container (i.e., “closed-air” systems). The systems described herein generally feature one or more cylinder assemblies for the storage and recovery of energy via compression and expansion of gas. The systems also include (i) a reservoir for storage of compressed gas after compression and supply of compressed gas for expansion thereof, and (ii) a vent for exhausting expanded gas to atmosphere after expansion and supply of gas for compression. The storage reservoir may include or consist essentially of, e.g., one or more IPVs, LURs, pressure vessels, (i.e., containers for compressed gas that may have rigid exteriors or may be inflatable, that may be formed of various suitable materials such as metal or plastic, and that may or may not fall within ASME regulations for pressure vessels), or caverns (i.e., naturally occurring or artificially created cavities that are typically located underground). Open-air systems typically provide superior energy density relative to closed-air systems.

Furthermore, the systems described herein may be advantageously utilized to harness and recover sources of renewable energy, e.g., wind and solar energy. For example, energy stored during compression of the gas may originate from an intermittent renewable energy source of, e.g., wind or solar energy, and energy may be recovered via expansion of the gas when the intermittent renewable energy source is nonfunctional (i.e., either not producing harnessable energy or producing energy at lower-than-nominal levels). As such, the systems described herein may be connected to, e.g., solar panels or wind turbines, in order to store the renewable energy generated by such systems.

In an aspect, embodiments of the invention feature a method of fabricating a lined underground reservoir. Rock is excavated at a site location to form an open shaft extending below ground level. A fluid-impermeable (i.e., impermeable to liquid such as water and/or gas such as air or natural gas) liner substantially enclosing an interior volume for containing at least one of compressed gas or heat-transfer liquid is assembled within or above the shaft. The interior volume is smaller than the total volume of the open shaft. The liner includes or consists essentially of an invert section enclosing a bottom of the interior volume, a dome section enclosing a top of the interior volume opposite the bottom, and a sidewall section substantially gaplessly spanning the invert and dome sections. After assembly, the liner is disposed within the shaft below ground level. A surround material is disposed to at least partially fill a gap between an outer surface of the liner and an inner surface of the shaft around at least a portion of the outer surface of the liner. After assembly of the liner and disposal of the surround material so as to form a surrounded liner, an overfill material is disposed over the surrounded liner to fill at least a portion of a space between the ground level and the surrounded liner. The interior volume enclosed by the liner is fluidly connected to a fluid source or fluid sink external to the surrounded liner, thereby forming the lined underground reservoir.

Embodiments of the invention may feature one or more of the following in any of a variety of different combinations. The surround material may include or consist essentially of concrete or metal-reinforced concrete (e.g., concrete internally reinforced with a network of metal such as rebar). The liner may include or consist essentially of steel and/or plastic. The overfill material may include or consist essentially of rock, concrete, and/or metal-reinforced concrete. The overfill material may include or consist essentially of a volume of heat-transfer liquid (e.g., water). The overfill material may be the fluid source and/or fluid sink. Prior to disposing the overfill material, a plug, shaped to laterally distribute upward-acting forces resulting when the liner contains pressurized fluid, may be formed within the shaft. A width of the shaft around the plug may be larger than a width of the shaft around the surrounded liner. A cross-section of the plug, e.g., a cross-section in a plane approximately perpendicular to ground level, may be substantially trapezoidal or hexagonal. Prior to disposing the surround material, spacer may be disposed on the liner that defines at least a portion of the gap between the outer surface of the liner and the inner surface of the shaft around at least a portion of the outer surface of the liner. The shaft may be substantially fully formed prior to any portion of the liner being disposed therein. At least a portion of the surround material may be disposed within the shaft prior to the liner being disposed within the shaft. A mechanism for generating a foam or droplet spray may be disposed within the interior volume. The mechanism may be fluidly connected to a source of heat-transfer fluid external to the surrounded liner. An area within the interior volume of the liner proximate the invert section may be fluidly connected to a sink of heat-transfer fluid external to the surrounded liner.

Assembling the liner may include or consist essentially of supporting a first portion of the liner above a bottom surface of the shaft such that a top surface of the first portion of the liner is proximate ground level, disposing a second portion of the liner on the top surface of the first portion of the liner to form an at least partially assembled liner, and lowering the at least partially assembled liner such that a top surface of the second portion of the liner is proximate ground level. Supporting the first portion of the liner may include or consist essentially of floating the first portion of the liner on a liquid within the shaft. Lowering the at least partially assembled liner may include or consist essentially of removing liquid from the shaft. Assembling the liner may include or consist essentially of filling at least a portion of the shaft with a liquid, floating a first portion of the liner on the liquid, proximate ground level, disposing a second portion of the liner on the first portion of the liner, and removing liquid from the shaft until a top surface of the second portion of the liner is proximate ground level. At least a portion of the surround material may be disposed on the inner surface of the shaft prior to filling the at least a portion of the shaft with the liquid. A spacer may be disposed on the first portion of the liner. The spacer may define at least a portion of the gap between the outer surface of the liner and the inner surface of the shaft around at least a portion of the outer surface of the liner. After the surround material is disposed within the gap, the surround material may have a substantially uniform thickness, defined by the spacer, around the liner. A portion of the surround material may be attached to each of the first and second sections of the liner proximate ground level. Each portion of the surround material may include or consist essentially of a network of metal.

During disposal of the surround material, the interior volume of the liner may be at least partially filled with a liquid such that a top surface of the liquid is approximately coplanar with a top surface of the surround material. The sidewall section of the liner may include or consist essentially of a plurality of substantially cylindrical segments, and each cylindrical segment may include or consist essentially of a plurality of discrete curved portions connected at interfaces therebetween. The plurality of discrete curved portions may be welded together at the interfaces to form each of the substantially cylindrical segments. The fluid source or fluid sink external to the surrounded liner may be a compressed-gas energy storage and recovery system configured to store gas in the interior volume after compression thereof and extract gas from the interior volume before expansion thereof. The energy storage and recovery system may store, e.g., compressed air or natural gas, within the interior volume and/or extract it therefrom. A network of drainage pipes for channeling liquid away from the liner may be disposed between the outer surface of the liner and the inner surface of the shaft. Concrete may be sprayed on the network of drainage pipes. At least a portion of the surround material may be disposed within the shaft before the liner is assembled. The surround material may include or consist essentially of (i) a network of drainage pipes and (ii) concrete reinforced with metal. The shaft may be deepened after a first portion of the surround material is disposed within the shaft, and, thereafter, a second portion of the surround material may be disposed on the first portion of the surround material. The assembled liner may not be self-supporting in the absence of the surround material. The shaft may be deepened after a first portion of the liner is assembled within the shaft, and, thereafter, a second portion of the liner may be attached to the first portion of the liner.

A portion of the surround material may be disposed over the dome section of the liner. The surround material may include or consist essentially of a concrete layer and, disposed between the concrete layer and the liner, a viscous layer for mitigating force on the liner. The concrete layer may include therewithin a network of metal (e.g., the concrete may be metal-reinforced concrete). The shaft may be substantially vertical. A region of the shaft disposed above the assembled liner may have a width or diameter approximately equal to or greater than a width or diameter of the assembled liner. The entire shaft may have a width or diameter approximately equal to or greater than a width or diameter of the assembled liner. During assembly of the liner and disposal of the surround material, the site location may be free of sub-surface access tunnels having a sufficiently large size and/or sufficiently shallow slope to accommodate vehicular traffic. Excavating rock may include or consist essentially of (a) excavating one or more holes at the site location where the shaft is to be formed, (b) placing an explosive in the one or more holes, (c) detonating the explosive to pulverize the rock, (d) removing the pulverized rock, and (e) optionally, repeating steps (a)-(d). Excavating rock may include or consist essentially of (a) pulverizing rock with a cutting mechanism mounted on a translatable telescoping boom to form at least a portion of the shaft, (b) removing the pulverized rock, and (c) optionally, lowering the cutting mechanism and boom into the at least a portion of the shaft and repeating steps (a) and (b). The surrounded liner may be configured to contain a fluid pressure of at least 200 bar, and the rock at the site location may have a rock mass rating of at least 50. The rock at the site location may have a rock mass rating RMR, and the surrounded liner may be configured to contain a maximum fluid pressure P in MPa defined by P≦(RMR×0.83)−25. A thickness of the liner may be insufficient to withstand a maximum internal fluid pressure of the lined underground reservoir, and the lined underground reservoir may be configured to withstand the maximum internal fluid pressure, notwithstanding the insufficient thickness of the liner, via at least one of the overfill or rock surrounding the surrounded liner withstanding a portion of the internal fluid pressure.

In another aspect, embodiments of the invention feature a method of energy storage utilizing a compressed-gas energy storage system selectively fluidly connected to a lined underground reservoir at least partially surrounded by rock. Gas is substantially isothermally compressed with the energy storage system at a compression temperature. The compressed gas is transferred to the lined underground reservoir for storage. Thereafter, heat is exchanged between the stored compressed gas and the rock at least partially surrounding the lined underground reservoir to change a temperature of the stored gas to a storage temperature different from the compression temperature. The compressed gas may be thermally conditioned during transfer to the lined underground reservoir by (i) spraying droplets of a heat-transfer liquid into the gas and/or (ii) forming a foam comprising the gas and a heat-transfer liquid. The storage temperature may be lower than the compression temperature. The storage temperature may be higher than the compression temperature.

In yet another aspect, embodiments of the invention feature a compressed-gas energy storage and recovery system that includes or consists essentially of a cylinder assembly for compressing gas to store energy and/or expanding gas to recover energy, a heat-exchange subsystem for thermally conditioning the gas during the compression and/or expansion via heat exchange between the gas and a heat-transfer liquid, a lined underground reservoir for storing compressed gas and/or heat-transfer fluid in an interior volume thereof, the lined underground reservoir being substantially impermeable to fluid and comprising an inner steel layer surrounded by an outer concrete layer, a source of heat-transfer fluid fluidly connected to the interior volume of the lined underground reservoir, and a sink for heat-transfer fluid fluidly connected to the interior volume of the lined underground reservoir.

Embodiments of the invention may feature one or more of the following in any of a variety of different combinations. A nozzle for introducing heat-transfer fluid into the interior volume as a spray of droplets or as a foam may be disposed within the interior volume of the lined underground reservoir. A first pipe may fluidly connect the cylinder assembly to the interior volume of the lined underground reservoir. A second pipe may fluidly connect the source of heat-transfer fluid to the nozzle. A third pipe may fluidly connect an area proximate a bottom portion of the interior volume of the lined underground reservoir and the sink for heat-transfer fluid. A pump may be configured to transfer heat-transfer fluid through the third pipe to the sink for heat-transfer fluid. The source of heat-transfer fluid and the sink for heat-transfer fluid may be the same body of liquid. The source of heat-transfer fluid and the sink for heat-transfer fluid may be two discrete and separate bodies of liquid.

In a further aspect, embodiments of the invention feature a compressed-gas energy storage and recovery system that includes or consists essentially of a cylinder assembly for at least one of compressing gas to store energy or expanding gas to recover energy, a heat-exchange subsystem for thermally conditioning the gas via heat exchange between the gas and a heat-transfer liquid, and selectively fluidly connected to the cylinder assembly, one or more insulated pipeline vessels (IPVs) for at least one of (i) storage of gas after compression, (ii) supply of compressed gas for expansion, (iii) storage of heat-transfer liquid, or (iv) supply of heat-transfer liquid.

Embodiments of the invention may feature one or more of the following in any of a variety of different combinations. Each IPV may include or consist essentially of a base material at least partially surrounded by insulation for retarding heat exchange between contents of the IPV and surroundings of the IPV. Each IPV may include, disposed on at least a portion of its interior surface, a corrosion-resistant coating. At least one IPV may contain gas at a pressure higher than an ambient pressure and/or at a temperature higher than an ambient temperature. The one or more IPVs may be at least partially buried underground. At least one IPV may include an unburied access point for the inflow and outflow of gas and/or heat-transfer liquid. Each IPV may be at least partially disposed within a separate fill capsule (i) containing insulating fill and (ii) including an outer envelope substantially impermeable to liquid and/or air. Each fill capsule may be at least partially buried underground. The one or more IPVs may include or consist essentially of a plurality of IPVs, and two or more IPVs may be at least partially disposed within a fill capsule (i) containing insulating fill and (ii) including an outer envelope substantially impermeable to at least one of liquid or air. The fill capsule may be at least partially buried underground. All of the plurality of IPVs may be at least partially disposed within the fill capsule. The one or more IPVs may be each substantially linear and disposed lengthwise at a first non-zero angle to the horizontal such that a downhill end of each IPV is lower than an uphill end. At least one IPV may include, proximate the downhill end thereof, a first access point for the inflow and outflow of heat-transfer liquid. The at least one IPV may include, proximate the first access point, a second access point for the inflow and outflow of gas. The second access point may be disposed at a distance from the downhill end sufficient to prevent blockage of the second access point by heat-transfer liquid accumulating proximate the downhill end. A manifold pipe may be fluidly connectable to the first access points of one or more IPVs. The manifold pipe may be inclined lengthwise at a second non-zero angle to the horizontal. The manifold pipe may be disposed approximately perpendicular to lengths of the one or more IPVs. The second non-zero angle may be different from the first non-zero angle. At least two of the one or more IPVs may be fluidly connected by a connector. The connector may include or consist essentially of a manifold and/or a U-bend connector. At least one IPV may include therewithin a mechanism for the introduction of heat-transfer liquid. The mechanism for the introduction of heat-transfer liquid may include or consist essentially of a nozzle, a spray head, and/or a spray rod. A pump may supply heat-transfer liquid to the mechanism. Each IPV may have a length exceeding its diameter by a factor of at least 100. Each IPV may not fall within ASME regulations for pressure vessels. The heat-exchange subsystem may include a mechanism for (i) the introduction of heat-transfer liquid into gas in the form of droplets and/or (ii) the mingling of heat-transfer liquid with gas to form foam.

In yet a further aspect, embodiments of the invention feature a compressed-gas energy storage and recovery system that includes or consists essentially of a cylinder assembly for compressing gas to store energy and/or expanding gas to recover energy, and a storage system for the storage of compressed gas and/or heat-transfer liquid. The storage system includes or consists essentially of a first approximately planar array of insulated pipeline vessels (IPVs). The first array is inclined at a first non-zero angle to the horizontal in a first direction and disposed at a second angle to the horizontal in a second direction perpendicular to the first direction.

Embodiments of the invention may feature one or more of the following in any of a variety of different combinations. The second angle may be approximately zero or may be non-zero. The second angle may be different from the first angle. At least two of the IPVs of the first array may be fluidly connected to each other via at least one connector. The at least one connector may include or consist essentially of a manifold and/or at least one U-bend connector. The storage system may include, disposed over the first array, a second approximately planar array of IPVs. The second array may be approximately parallel to the first array. The second array may be inclined at a third non-zero angle to the horizontal in the first direction and disposed at a fourth angle to the horizontal in the second direction. The fourth angle may be approximately zero or may be non-zero. The second angle may be approximately equal to the fourth angle. The first angle may be approximately equal to the third angle. The first angle may be different from the third angle. Relative to the horizontal, an absolute value of the first angle may be approximately equal to an absolute value of the third angle. At least one of the IPVs of the first array may be fluidly connected to at least one of the IPVs of the second array by at least one connector. The at least one connector may include or consist essentially of a manifold or at least one U-bend connector. Each IPV may include or consist essentially of a base material at least partially surrounded by insulation for retarding heat exchange between contents of the IPV and surroundings of the IPV.

In another aspect, embodiments of the invention feature a compressed-gas energy storage and recovery system that includes or consists essentially of a cylinder assembly for at least one of compressing gas to store energy or expanding gas to recover energy, a heat-exchange subsystem for thermally conditioning the gas via heat exchange between the gas and a heat-transfer liquid, and selectively fluidly connected to the cylinder assembly, a lined underground reservoir for at least one of (i) storage of gas after compression, (ii) supply of compressed gas for expansion, (iii) storage of heat-transfer liquid, or (iv) supply of heat-transfer liquid.

Embodiments of the invention may feature one or more of the following in any of a variety of different combinations. The lined underground reservoir may include a liner at least partially surrounded by at least one of earth, dirt, or gravel. The liner may include or consist essentially of steel and/or concrete. A coating for sealing the liner to prevent fluid flow therethrough, preventing corrosion or degradation of the liner, and/or for thermally insulating the liner may be disposed on an inner surface of the liner and/or an outer surface of the liner. At least a portion of the lined underground reservoir may be disposed below ground level. The lined underground reservoir may include therein a liquid containment region disposed above a bottom surface of the lined underground reservoir. A spray head and/or nozzle for introducing heat-transfer liquid and/or foam may be disposed within the lined underground reservoir. The lined underground reservoir may include a container buried beneath and surrounded by at least one of earth, dirt, or gravel. The container may include or consist essentially of steel. Concrete, an insulating material, fiberglass, and/or carbon fiber may be disposed between the container and the earth, dirt, and/or gravel. The concrete, insulating material, fiberglass, and/or carbon fiber may be disposed directly on the container with substantially no gap or air therebetween. A circulation apparatus for pumping liquid disposed proximate a bottom surface of the lined underground reservoir to a point outside of the lined underground reservoir may be disposed within the lined underground reservoir. The lined underground reservoir may include therein a liquid containment region disposed above a bottom surface of the lined underground reservoir. A second circulation apparatus for pumping liquid disposed in the liquid containment region to a point outside of the lined underground reservoir may be disposed within the lined underground reservoir. A pipe for transferring gas between the cylinder assembly and the lined underground reservoir may extend from the cylinder assembly to a point within an interior volume of the lined underground reservoir. The lined underground reservoir may include or consist essentially of a plurality of discrete containers disposed within a shaft extending below ground level.

These and other objects, along with advantages and features of the invention, will become more apparent through reference to the following description, the accompanying drawings, and the claims. Furthermore, it is to be understood that the features of the various embodiments described herein are not mutually exclusive and can exist in various combinations and permutations. Note that as used herein, the terms “pipe,” “piping” and the like shall refer to one or more conduits that are rated to carry gas or liquid between two points. Thus, the singular term should be taken to include a plurality of parallel conduits where appropriate. Herein, the terms “liquid” and “water” interchangeably connote any mostly or substantially incompressible liquid, the terms “gas” and “air” are used interchangeably, and the term “fluid” may refer to a liquid, a gas, or a mixture of liquid and gas (e.g., a foam) unless otherwise indicated. As used herein unless otherwise indicated, the terms “approximately” and “substantially” mean±10%, and, in some embodiments, ±5%. Herein, any fluid at a pressure higher than ambient atmospheric pressure is said to be “pressurized.” A “valve” is any mechanism or component for controlling fluid communication between fluid paths or reservoirs, or for selectively permitting control or venting. The term “cylinder” refers to a chamber, of uniform but not necessarily circular cross-section, which may contain a slidably disposed piston or other mechanism that separates the fluid on one side of the chamber from that on the other, preventing fluid movement from one side of the chamber to the other while allowing the transfer of force/pressure from one side of the chamber to the next or to a mechanism outside the chamber. At least one of the two ends of a chamber may be closed by end caps, also herein termed “heads.” As utilized herein, an “end cap” is not necessarily a component distinct or separable from the remaining portion of the cylinder, but may refer to an end portion of the cylinder itself. Rods, valves, and other devices may pass through the end caps. A “cylinder assembly” may be a simple cylinder or include multiple cylinders, and may or may not have additional associated components (such as mechanical linkages among the cylinders). The shaft of a cylinder may be coupled hydraulically or mechanically to a mechanical load (e.g., a hydraulic motor/pump or a crankshaft) that is in turn coupled to an electrical load (e.g., rotary or linear electric motor/generator attached to power electronics and/or directly to the grid or other loads), as described in the '678 and '842 patents. As used herein, “thermal conditioning” of a heat-exchange fluid does not include any modification of the temperature of the heat-exchange fluid resulting from interaction with gas with which the heat-exchange fluid is exchanging thermal energy; rather, such thermal conditioning generally refers to the modification of the temperature of the heat-exchange fluid by other means (e.g., an external heat exchanger). The terms “heat-exchange” and “heat-transfer” are generally utilized interchangeably herein. Unless otherwise indicated, motor/pumps described herein are not required to be configured to function both as a motor and a pump if they are utilized during system operation only as a motor or a pump but not both. Gas expansions described herein may be performed in the absence of combustion (as opposed to the operation of an internal-combustion cylinder, for example). The term “thermal well” refers herein to any mass (e.g., a quantity of fluid in an insulated container, or a solid thermal mass in an insulated container, or a portion of the earth) with which heat may be exchanged, whose temperature may be raised or lowered compared to some other mass (e.g., the environment), and which tends to retain rather than to dissipate any thermal energy stored within itself. Alternatively or additionally, a thermal well may employ material phase changes (e.g., melting and solidifying of a material) to store and release energy. As used herein, a “recessed” or “underground” storage reservoir is at least partially surrounded by and/or buried in material such as earth, dirt, gravel, and/or water or other liquid. Recessed storage reservoirs may be formed in (and may occupy substantially all of the space of) artificial and/or natural caverns.

### BRIEF DESCRIPTION OF THE DRAWINGS

In the drawings, like reference characters generally refer to the same parts throughout the different views. Cylinders, rods, and other components are depicted in cross section in a manner that will be intelligible to all persons familiar with the art of pneumatic and hydraulic cylinders. Also, the drawings are not necessarily to scale, emphasis instead generally being placed upon illustrating the principles of the invention. In the following description, various embodiments of the present invention are described with reference to the following drawings, in which:

FIG. 1A is a schematic drawing of an energy storage and generation facility employing lined underground reservoirs, accordance with various embodiments of the invention;

FIG. 1B is a schematic drawing of an energy storage and generation facility employing insulated pipeline vessels, accordance with various embodiments of the invention;

FIG. 1C is a schematic drawing of an energy storage and generation facility employing lined underground reservoirs, accordance with various embodiments of the invention;

FIG. 1D is a schematic drawing of an energy storage and generation facility employing lined underground reservoirs, accordance with various embodiments of the invention;

FIG. 2 is a schematic drawing of various components of a compressed-gas energy storage system in accordance with various embodiments of the invention;

FIG. 3 is a schematic drawing of the major components of a compressed air energy storage and recovery system in accordance with various embodiments of the invention;

FIG. 4 is a schematic drawing of various components of a compressed-gas energy storage system in accordance with various embodiments of the invention;

FIG. 5 is a schematic drawing of various components of a multi-cylinder compressed-gas energy storage system in accordance with various embodiments of the invention;

FIG. 6A is a schematic drawing of an insulated pipeline vessel in accordance with various embodiments of the invention;

FIG. 6B is a schematic drawing of an insulated pipeline vessel and piping for accessing the contents thereof in accordance with various embodiments of the invention;

FIG. 6C is a schematic drawing of an insulated pipeline vessel and a device for thermally regulating the contents thereof in accordance with various embodiments of the invention;

FIG. 7A is a schematic drawing of an array of insulated pipeline vessels in accordance with various embodiments of the invention;

FIG. 7B is a schematic drawing of an illustrative liquid-collection scheme for an IPV array in accordance with various embodiments of the invention;

FIG. 7C is a schematic drawing of an illustrative, generalized, single-layer IPV array in accordance with various embodiments of the invention;

FIG. 7D is a schematic drawing of an illustrative, generalized, two-layer IPV array with parallel layers in accordance with various embodiments of the invention;

FIG. 7E is a schematic drawing of an illustrative, generalized, two-layer IPV array with layers at different angles in accordance with various embodiments of the invention;

FIG. 7F is a schematic drawing of an illustrative, generalized, serpentine IPV array in accordance with various embodiments of the invention;

FIG. 8 is a schematic drawing of a lined underground reservoir system for the storage and thermal conditioning of pressurized fluid in accordance with various embodiments of the invention;

FIG. 9A is a schematic drawing of a lined underground reservoir system for the storage and thermal conditioning of pressurized fluid in accordance with various embodiments of the invention;

FIG. 9B is a schematic drawing of a lined underground reservoir system for the storage and thermal conditioning of pressurized fluid, showing access tunnels built with level topography in accordance with various embodiments of the invention;

FIG. 9C is a schematic drawing of a lined underground reservoir system for the storage and thermal conditioning of pressurized fluid, showing access tunnels built with high-relief topography in accordance with various embodiments of the invention;

FIG. 10 is a schematic drawing of a lined underground reservoir system for the storage and thermal conditioning of pressurized fluid, showing a spiraling access tunnel in accordance with various embodiments of the invention;

FIG. 11 is a schematic drawing of stages in the excavation of an open shaft for the creation of a recessed lined underground reservoir in accordance with various embodiments of the invention;

FIG. 12A is a schematic drawing of a device for excavating an open shaft in accordance with various embodiments of the invention;

FIG. 12B is a schematic drawing of a device for excavating an open shaft in accordance with various embodiments of the invention;

FIG. 13 is a schematic drawing of a pipe network draining water from the vicinity of a lined underground reservoir in accordance with various embodiments of the invention;

FIG. 14A is a schematic drawing of a multilayered lining for a lined underground reservoir in accordance with various embodiments of the invention;

FIG. 14B is a schematic drawing of a multilayered lining for a lined underground reservoir in accordance with various embodiments of the invention;

FIGS. 15A and 15B are schematic drawings of the effects of pressure-driven expansion upon a lined underground reservoir and surrounding rock in accordance with various embodiments of the invention;

FIG. 16 is a plot of the deformation of a steel reservoir lining for three temperature and pressure cycles in accordance with various embodiments of the invention;

FIG. 17 is a schematic drawing of stages in the construction of an inner liner for a lined underground reservoir in accordance with various embodiments of the invention;

FIG. 18 is a schematic drawing of stages in the construction of a lined underground reservoir in accordance with various embodiments of the invention;

FIG. 19 is a schematic drawing of stages in the construction of a lined underground reservoir in accordance with various embodiments of the invention;

FIG. 20 is a schematic drawing of stages in the construction of a lined underground reservoir in accordance with various embodiments of the invention;

FIG. 21A is a schematic drawing of stages in the construction of a lined underground reservoir in accordance with various embodiments of the invention;

FIG. 21B is a schematic drawing of stages in the construction of a lined underground reservoir in accordance with various embodiments of the invention;

FIG. 21C is a schematic drawing of stages in the construction of a lined underground reservoir in accordance with various embodiments of the invention;

FIG. 21D is a schematic drawing showing details of the liner of a lined underground reservoir in accordance with various embodiments of the invention;

FIG. 22 is a schematic drawing of a stage in the assembly of the liner of a lined underground reservoir in accordance with various embodiments of the invention;

FIG. 23 is a schematic drawing of stages in the construction and lining of a lined underground reservoir in accordance with various embodiments of the invention;

FIG. 24A is a schematic drawing of a lined underground reservoir showing a first design for a pressure barrier in accordance with various embodiments of the invention;

FIG. 24B is a schematic drawing of a lined underground reservoir showing a second design for a pressure barrier in accordance with various embodiments of the invention;

FIG. 24C is a schematic drawing of a lined underground reservoir showing the action of forces in the absence of a pressure barrier in accordance with various embodiments of the invention;

FIG. 24D is a schematic drawing of a lined underground reservoir showing the action of forces in the presence of a pressure barrier in accordance with various embodiments of the invention;

FIG. 25 is a schematic drawing of a lined underground reservoir employing construction cavities for the housing of machinery and storage of liquid in accordance with various embodiments of the invention;

FIG. 26 is a schematic drawing of a lined underground reservoir employing a portion of a shaft for the storage of liquid in accordance with various embodiments of the invention;

FIG. 27 is a schematic drawing of a lined underground reservoir system in which the lined cavity protrudes above the surface in accordance with various embodiments of the invention;

FIG. 28 is a schematic drawing of a lined underground reservoir system in which the lined cavity protrudes above the surface and provisions are made for the circulation of a heat-transfer fluid within the reservoir in accordance with various embodiments of the invention;

FIG. 29 is a schematic drawing of a cylinder assembly with apparatus for the generation of foam external to the cylinder in accordance with various embodiments of the invention;

FIG. 30 is a schematic drawing of a cylinder assembly with apparatus for the generation of foam external to the cylinder and provision for bypassing the foam-generating apparatus in accordance with various embodiments of the invention;

FIG. 31 is a schematic drawing of a cylinder assembly with apparatus for the generation of foam in a vessel external to the cylinder in accordance with various embodiments of the invention;

FIG. 32 is a schematic drawing of a cylinder assembly with apparatus for the generation of foam in a vessel external to the cylinder in accordance with various embodiments of the invention;

FIG. 33A is a plot of metal stress range as a function of cycle number for a lined underground reservoir pressurized gas storage system in accordance with various embodiments of the invention;

FIG. 33B, incorporating, as shown, partial views FIG. 33B-1, FIG. 33B-2, and FIG. 33B-3, is a tabular presentation of the rock mass rating system utilized in accordance with various embodiments of the invention;

FIG. 34 is a table and plot of criteria for rock quality pertaining to the construction of lined underground reservoirs in accordance with various embodiments of the invention;

FIG. 35 is a plot of the total construction cost of a lined underground reservoir as a function of reservoir volume and overlying topography in accordance with various embodiments of the invention;

FIG. 36 is a plot of the construction cost per cubic meter of a lined underground reservoir as a function of reservoir volume and overlying topography in accordance with various embodiments of the invention;

FIG. 37 is a plot of the total construction cost of a lined underground reservoir as a function of reservoir volume, broken out by cost sector, in accordance with various embodiments of the invention; and

FIG. 38 is a plot of the construction time of a lined underground reservoir as a function of reservoir volume and overlying topography in accordance with various embodiments of the invention.

### DETAILED DESCRIPTION

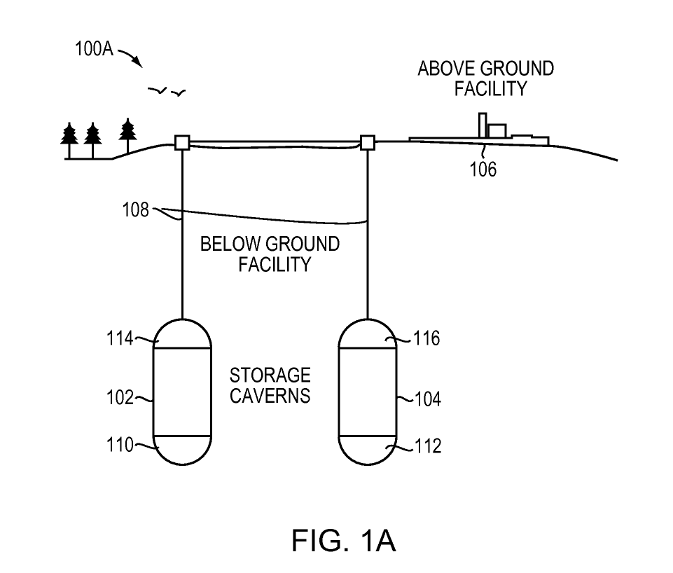

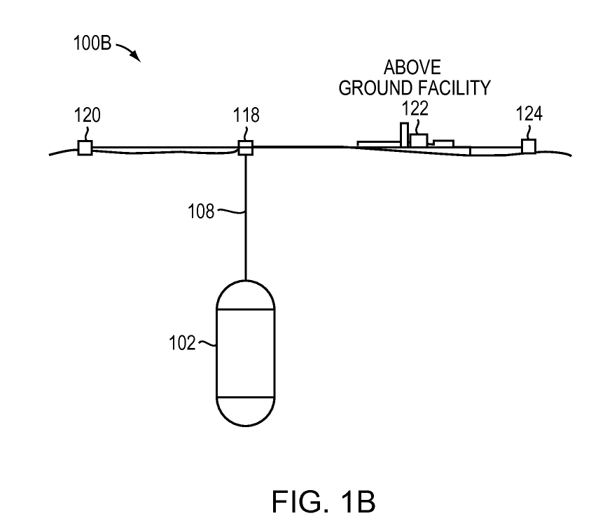

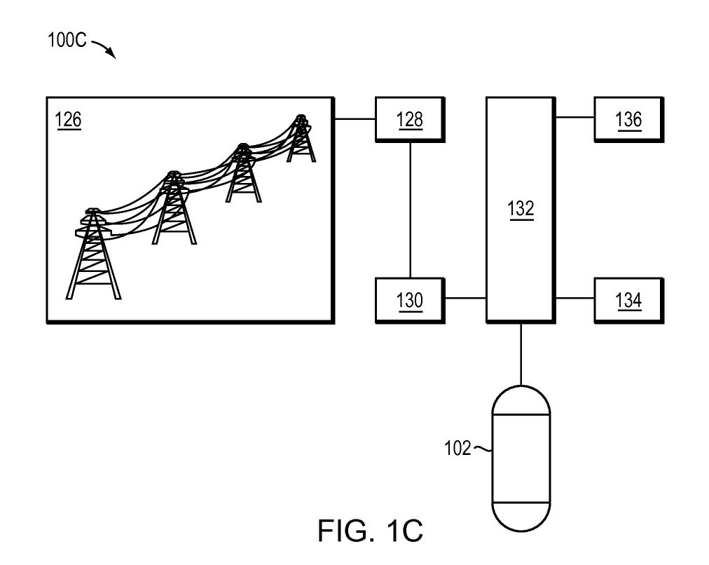

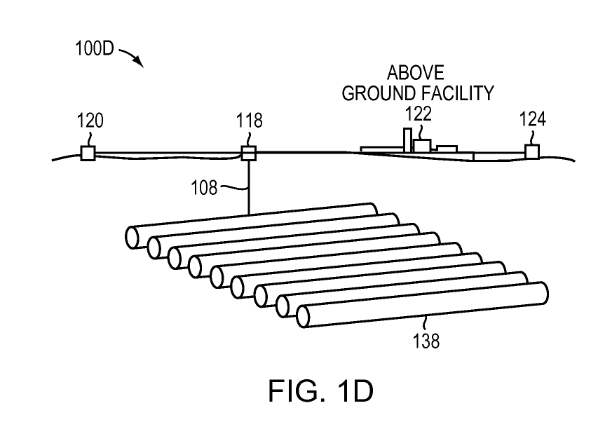

FIG. 1A schematically depicts an illustrative facility 100A for the storage and generation of energy that employs two lined underground reservoirs (LURs) 102, 104 to store pressurized fluids. The LURs 102, 104 may exchange fluids with an above-ground facility 106 via piping 108. The LURs 102, 104 depicted in FIG. 1A are of a capsule-like form typical for such reservoirs, namely, cylindrical with rounded inverts (floors) 110, 112 and domed ceilings (114, 116). Linings and other details of the LURs 102, 104 and other components of the system 100A are omitted from FIG. 1A for clarity. The above-ground facility 106 may be a gas processing facility that injects high-pressure gas for storage in the LURs 102, 104 and extracts the gas for distribution, or the facility 106 may be a generating facility that burns a fuel, e.g., natural gas, stored in the LURs 102, 104. Alternatively, the facility 106 may be a storage and generating facility that burns natural gas and renders such combustion more efficient by using compressed air from LURs 102, 104, where the compressed air in the LURs 102, 104 may be provided by pumping air during hours of low electrical demand. The facility 106 may even be a compressed-air-only energy storage and generation facility that pumps air into both LURs 102, 104 during hours of low electrical demand or high generation by an associated renewable-energy facility (e.g., wind farm and/or solar cells; not shown) and generates energy by running generators using the energy released by expanding air from the LURs 102, 104. In particular, the above-ground facility 106 may be a compressed-air energy storage and generation facility that uses approximately isothermal compression and storage as detailed herein.

FIG. 1B schematically depicts an illustrative system 100B that employs LUR 102 to store an energy-storing fluid (e.g., methane, hydrogen, compressed gas). LUR 102 exchanges the fluid through piping 108 at a surface access point 118, which features attachment points for piping and valves for directing and measuring fluid flow. The surface access point 118 receives the fluid from a source/sink 120 (e.g., well, hydrogen generator, shipping terminal) and may, in some modes of operation, direct the fluid to the source/sink 120. The surface access point 118 may also be connected to an aboveground fluid-handling facility 122. The fluid-handling facility 122 may process the fluid (e.g., cool and compress methane or reform methane with steam to produce hydrogen), or may utilize the energy contained within the fluid to produce electricity. The product of the fluid-handling facility 122 (i.e., a fluid, electricity, etc.) may be delivered to an external user 124 (e.g., power grid) or may, in some modes of operation, be directed to the LUR 102 or to the external source/sink 120. In various other embodiments, some or all components of system 100B, in addition to the LUR 102, are located underground.

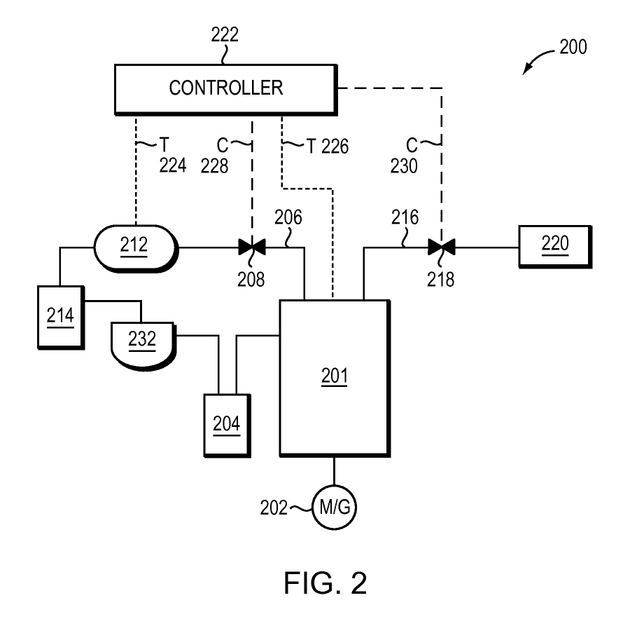

FIG. 1C schematically depicts an illustrative system 100C for the storage of energy and the generation of electricity that employs an LUR 102 to store compressed air. System 100C interconverts electrical energy with both thermal energy and the elastic potential energy of compressed air. To compress air for storage, system 100C draws electrical power from a source/sink 126 (e.g., power grid). The electrical power from the source/sink 126 may be passed through a transformer 128. After transformation, the power drives a motor/generator 130. The motor/generator 130 drives a compressor/expander 132 (e.g., turbine, reciprocating piston, systems depicted in FIGS. 2-5, etc.) that raises ambient air to a higher-than-ambient pressure. The pressurized air is stored in the LUR 102. Heat from the pressurized air is extracted and stored in a thermal energy sink 134 (e.g., atmosphere, body of water, thermal well).

To generate electricity from compressed air released from storage, compressed air from the LUR 102 is expanded to a near-ambient pressure in the compressor/expander 132 in a manner that performs mechanical work. Heat from a thermal energy source (e.g., combusted methane, waste heat from a fuel-burning generator) may be added to the air being expanded in the compressor/expander 132 and is partially converted to mechanical work. The mechanical work derived from the compressed air and the thermal energy added thereto is directed to the motor/generator 130. Electricity produced by the motor/generator 130 is directed through the transformer 128 and thence to the source/sink 126.

In various other embodiments, system 100C does not include a discrete thermal energy sink 134 or thermal energy source 136. Motor/generator 130 may be a single electric machine, or may consist of a separate motor and separate generator. Compressor/expander 132 may be a single system or may be separate compressor unit and separate expander unit.

FIG. 1D schematically depicts an illustrative system 100D that employs an array of insulated pipeline vessels (IPVs) 138 to store an energy-storing fluid (e.g., methane, hydrogen, compressed gas). The IPV array 138, which may be located either aboveground or partially or substantially wholly belowground, exchanges the fluid through piping 108 at access point 118, which includes attachment points for piping and valves for directing and measuring fluid flow. The surface access point 118 receives the fluid from source/sink 120 (e.g., well, hydrogen generator, shipping terminal) and may, in some modes of operation, direct the fluid to the source/sink 120. The surface access point 118 is also connected to aboveground fluid-handling facility 122. The fluid-handling facility 122 may process the fluid (e.g., cool and compress methane or reform methane with steam to produce hydrogen), or may utilize the energy contained within the fluid to produce electricity. The product of the fluid-handling facility 122 (i.e., a fluid, electricity, or other) may be delivered to an external user 124 (e.g., power grid) or may, in some modes of operation, be directed to the IPV array 138 or to the external source/sink 120. In various other embodiments, some or all components of system 100D are located underground, including the IPV array 138; also in various other embodiments, more than one IPV array may be employed by system 100D, in addition to one or more LURs (not shown).

FIG. 2 depicts an illustrative system 200 that may be part of a larger system, not otherwise depicted, for the storage and release of energy. Subsequent figures will clarify the application of embodiments of the invention to such a system. The system 200 depicted in FIG. 2 features an assembly 201 for compressing and expanding gas. Expansion/compression assembly 201 may include or consist essentially of either one or more individual devices for expanding or compressing gas (e.g., turbines or cylinder assemblies that each may house a movable boundary mechanism) or a staged series of such devices, as well as ancillary devices (e.g., valves) not depicted explicitly in FIG. 2.

An electric motor/generator 202 (e.g., a rotary or linear electric machine) is in physical communication (e.g., via hydraulic pump, piston shaft, or mechanical crankshaft) with the expansion/compression assembly 201. The motor/generator 202 may be electrically connected to a source and/or sink of electric energy not explicitly depicted in FIG. 2 (e.g., an electrical distribution grid or a source of renewable energy such as one or more wind turbines or solar cells).

The expansion/compression assembly 201 may be in fluid communication with a heat-transfer subsystem 204 that alters the temperature and/or pressure of a fluid (i.e., gas, liquid, or gas-liquid mixture such as a foam) extracted from expansion/compression assembly 201 and, after alteration of the fluid's temperature and/or pressure, returns at least a portion of it to expansion/compression assembly 201. Heat-transfer subsystem 204 may include pumps, valves, and other devices (not depicted explicitly in FIG. 2) ancillary to its heat-transfer function and to the transfer of fluid to and from expansion/compression assembly 201. Operated appropriately, the heat-transfer subsystem 204 enables substantially isothermal compression and/or expansion of gas inside expansion/compression assembly 201.

Connected to the expansion/compression assembly 201 is a pipe 206 with a control valve 208 that controls a flow of fluid (e.g., gas) between assembly 201 and a storage reservoir 212 (e.g., one or more pressure vessels, IPVs, and/or LURs). The storage reservoir 212 may be in fluid communication with a heat-transfer subsystem 214 that alters the temperature and/or pressure of fluid removed from storage reservoir 212 and, after alteration of the fluid's temperature and/or pressure, returns it to storage reservoir 212. A second pipe 216 with a control valve 218 may be in fluid communication with the expansion/compression assembly 201 and with a vent 220 that communicates with a body of gas at relatively low pressure (e.g., the ambient atmosphere).

A control system 222 receives information inputs from any of expansion/compression assembly 201, storage reservoir 212, and other components of system 200 and sources external to system 200. These information inputs may include or consist essentially of pressure, temperature, and/or other telemetered measurements of properties of components of system 201. Such information inputs, here generically denoted by the letter “T,” are transmitted to control system 222 either wirelessly or through wires. Such transmission is denoted in FIG. 2 by dotted lines 224, 226.

The control system 222 may selectively control valves 208 and 218 to enable substantially isothermal compression and/or expansion of a gas in assembly 201. Control signals, here generically denoted by the letter “C,” are transmitted to valves 208 and 218 either wirelessly or through wires. Such transmission is denoted in FIG. 2 by dashed lines 228, 230. The control system 222 may also control the operation of the heat-transfer assemblies 204, 214 and of other components not explicitly depicted in FIG. 2. The transmission of control and telemetry signals for these purposes is not explicitly depicted in FIG. 2.

The control system 222 may be any acceptable control device with a human-machine interface. For example, the control system 222 may include a computer (for example a PC-type) that executes a stored control application in the form of a computer-readable software medium. More generally, control system 222 may be realized as software, hardware, or some combination thereof. For example, control system 222 may be implemented on one or more computers, such as a PC having a CPU board containing one or more processors such as the Pentium, Core, Atom, or Celeron family of processors manufactured by Intel Corporation of Santa Clara, Calif., the 680×0 and POWER PC family of processors manufactured by Motorola Corporation of Schaumburg, Ill., and/or the ATHLON line of processors manufactured by Advanced Micro Devices, Inc., of Sunnyvale, Calif. The processor may also include a main memory unit for storing programs and/or data relating to the methods described above. The memory may include random access memory (RAM), read only memory (ROM), and/or FLASH memory residing on commonly available hardware such as one or more application specific integrated circuits (ASIC), field programmable gate arrays (FPGA), electrically erasable programmable read-only memories (EEPROM), programmable read-only memories (PROM), programmable logic devices (PLD), or read-only memory devices (ROM). In some embodiments, the programs may be provided using external RAM and/or ROM such as optical disks, magnetic disks, or other storage devices.

For embodiments in which the functions of controller 222 are provided by software, the program may be written in any one of a number of high-level languages such as FORTRAN, PASCAL, JAVA, C, C++, C#, LISP, PERL, BASIC or any suitable programming language. Additionally, the software can be implemented in an assembly language and/or machine language directed to the microprocessor resident on a target device.

As described above, the control system 222 may receive telemetry from sensors monitoring various aspects of the operation of system 200, and may provide signals to control valve actuators, valves, motors, and other electromechanical/electronic devices. Control system 222 may communicate with such sensors and/or other components of system 200 (and other embodiments described herein) via wired or wireless communication. An appropriate interface may be used to convert data from sensors into a form readable by the control system 222 (such as RS-232 or network-based interconnects). Likewise, the interface converts the computer's control signals into a form usable by valves and other actuators to perform an operation. The provision of such interfaces, as well as suitable control programming, is clear to those of ordinary skill in the art and may be provided without undue experimentation.

System 200 may be operated so as to compress gas admitted through the vent 220 and store the gas thus compressed in reservoir 212. For example, in an initial state of operation, valve 208 is closed and valve 218 is open, admitting a quantity of gas into expansion/compression assembly 201. When a desired quantity of gas has been admitted into assembly 201, valve 218 may be closed. The motor/generator 202, employing energy supplied by a source not explicitly depicted in FIG. 2 (e.g., the electrical grid), then provides mechanical power to expansion/compression assembly 201, enabling the gas within assembly 201 to be compressed.

During compression of the gas within assembly 201, fluid (i.e., gas, liquid, or a gas-liquid mixture) may be circulated between assembly 201 and heat-exchange assembly 204. Heat-exchange assembly 204 may be operated in such a manner as to enable substantially isothermal compression of the gas within assembly 201. During or after compression of the gas within assembly 201, valve 208 may be opened to enable high-pressure fluid (e.g., compressed gas or a mixture of liquid and compressed gas) to flow to reservoir 212. Heat-exchange assembly 214 may be operated at any time in such a manner as alter the temperature and/or pressure of the fluid within reservoir 212.

That system 200 may also be operated so as to expand compressed gas from reservoir 212 in expansion/compression assembly 201 in such a manner as to deliver energy to the motor/generator 202 will be apparent to all persons familiar with the operation of pneumatic, hydraulic, and electric machines.

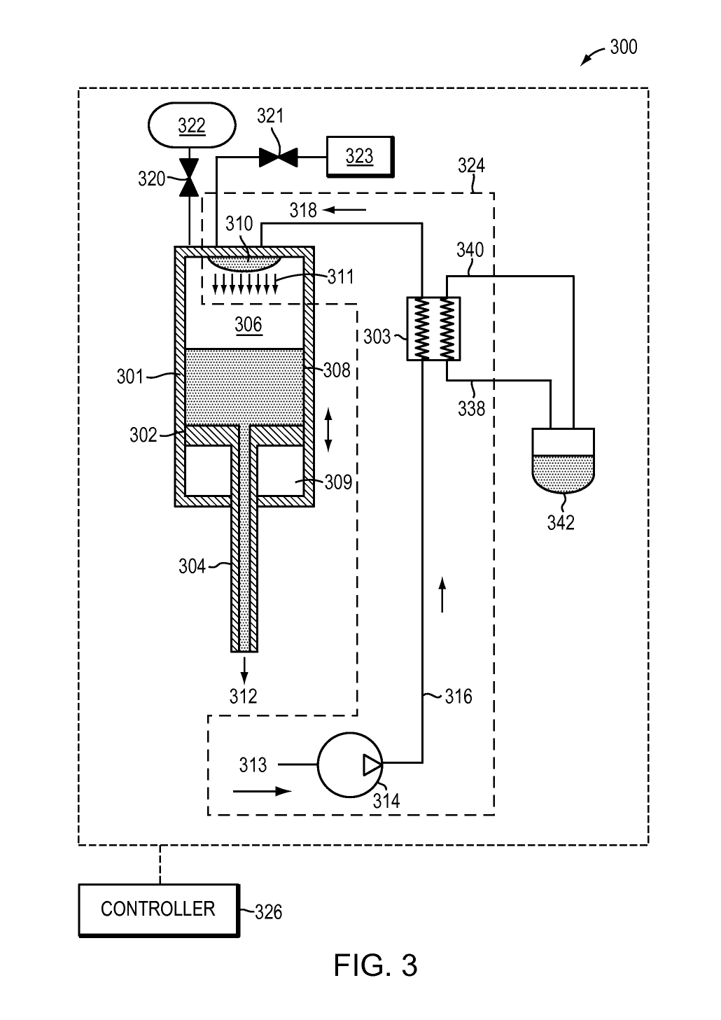

FIG. 3 depicts an illustrative system 300 that features a cylinder assembly 301 (i.e., an embodiment of assembly 201 in FIG. 2) in communication with a reservoir 322 (212 in FIG. 1) and a vent to atmosphere 323 (220 in FIG. 2). In the illustrative system 300 shown in FIG. 3, the cylinder assembly 301 contains a piston 302 slidably disposed therein. In some embodiments the piston 302 is replaced by a different boundary mechanism dividing cylinder assembly 301 into multiple chambers, or piston 302 is absent entirely, and cylinder assembly 301 is a “liquid piston.” The cylinder assembly 301 may be divided into, e.g., two pneumatic chambers or one pneumatic chamber and one hydraulic chamber. The piston 302 is connected to a rod 304, which may contain a center-drilled fluid passageway with fluid outlet 312 extending from the piston 302. The rod 304 is also attached to, e.g., a mechanical load (e.g., a crankshaft or a hydraulic system) that is not depicted. The cylinder assembly 301 is in liquid communication with a heat-transfer subsystem 324 that includes or consists essentially of a circulation pump 314 and a spray mechanism 310 to enable substantially isothermal compression/expansion of gas. Heat-transfer fluid circulated by pump 314 may be passed through a heat exchanger 303 (e.g., tube-in-shell- or parallel-plate-type heat exchanger). Spray mechanism 310 may include or consist essentially of one or more spray heads (e.g., disposed at one end of cylinder assembly 301) and/or spray rods (e.g., extending along at least a portion of the central axis of cylinder assembly 301). In other embodiments, a foam, rather than a spray of droplets, is created to facilitate heat exchange between liquid and gas during compression and expansion of gas within the cylinder assembly 301, as described in U.S. patent application Ser. No. 13/473,128, filed May 16, 2012 (the '128 application), the entire disclosure of which is incorporated by reference herein. Foam may be generated by foaming gas with heat-exchange liquid in a mechanism (not shown, described in more detail below) external to the cylinder assembly 301 and then injecting the resulting foam into the cylinder assembly 301. Alternatively or additionally, foam may be generated inside the cylinder assembly 301 by the injection of heat-exchange liquid into cylinder assembly 301 through a foam-generating mechanism (e.g., spray head, rotating blade, one or more nozzles), partly or entirely filling the pneumatic chamber of cylinder assembly 301. In some embodiments, droplets and foams may be introduced into cylinder assembly 301 simultaneously and/or sequentially. Various embodiments may feature mechanisms (not shown in FIG. 3) for controlling the characteristics of foam (e.g., bubble size) and for breaking down, separating, and/or regenerating foam.

System 300 further includes a first control valve 320 (208 in FIG. 2) in communication with a storage reservoir 322 and cylinder assembly 301, and a second control valve 321 (218 in FIG. 2) in communication with a vent 323 and cylinder assembly 301. A control system 326 (222 in FIG. 2) may control operation of, e.g., valves 322 and 321 based on various system inputs (e.g., pressure, temperature, piston position, and/or fluid state) from cylinder assembly 301 and/or storage reservoir 322. Heat-transfer fluid (liquid or circulated by pump 314 enters through pipe 313. Pipe 313 may be (a) connected to a low-pressure fluid source (e.g., fluid reservoir (not shown) at the pressure to which vent 323 is connected or thermal well 342); (b) connected to a high-pressure source (e.g., fluid reservoir (not shown) at the pressure of reservoir 322); (c) selectively connected (using valve arrangement not shown) to low pressure during a compression process and to high pressure during an expansion process; (d) connected to changing-pressure fluid 308 in the cylinder 301 via connection 312; or (e) some combination of these options.

In an initial state, the cylinder assembly 301 may contain a gas 306 (e.g., air introduced to the cylinder assembly 301 via valve 321 and vent 323) and a heat-transfer fluid 308 (which may include or consist essentially of, e.g., water or another suitable liquid). When the gas 306 enters the cylinder assembly 301, piston 302 is operated to compress the gas 306 to an elevated pressure (e.g., approximately 3,000 psi). Heat-transfer fluid (not necessarily the identical body of heat-transfer fluid 308) flows from pipe 313 to the pump 314. The pump 314 may raise the pressure of the heat-exchange fluid to a pressure (e.g., up to approximately 3,015 psig) somewhat higher than the pressure within the cylinder assembly 301, as described in U.S. Pat. No. 8,359,856, filed Jan. 19, 2011 (the '856 patent), the entire disclosure of which is incorporated by reference herein. Alternatively or in conjunction, embodiments of the invention add heat (i.e., thermal energy) to, or remove heat from, the high-pressure gas in the cylinder assembly 301 by passing only relatively low-pressure fluids through a heat exchanger or fluid reservoir, as detailed in U.S. patent application Ser. No. 13/211,440, filed Aug. 17, 2011 (the '440 application), the entire disclosure of which is incorporated by reference herein.

Heat-transfer fluid is then sent through a pipe 316, where it may be passed through a heat exchanger 303 (where its temperature is altered) and then through a pipe 318 to the spray mechanism 310. The heat-transfer fluid thus circulated may include or consist essentially of liquid or foam. Spray mechanism 310 may be disposed within the cylinder assembly 301, as shown; located in the storage reservoir 322 or vent 323; or located in piping or manifolding around the cylinder assembly, such as pipe 318 or the pipes connecting the cylinder assembly to storage reservoir 322 or vent 323. The spray mechanism 310 may be operated in the vent 323 or connecting pipes during compression, and a separate spray mechanism may be operated in the storage reservoir 322 or connecting pipes during expansion. Heat-transfer spray 311 from spray mechanism 310 (and/or any additional spray mechanisms), and/or foam from mechanisms internal or external to the cylinder assembly 101, enable substantially isothermal compression of gas 306 within cylinder assembly 301.

In some embodiments, the heat exchanger 303 is configured to condition heat-transfer fluid at low pressure (e.g., a pressure lower than the maximum pressure of a compression or expansion stroke in cylinder assembly 301), and heat-transfer fluid is thermally conditioned between strokes or only during portions of strokes, as detailed in the '440 application. Embodiments of the invention are configured for circulation of heat-transfer fluid without the use of hoses that flex during operation through the use of, e.g., tubes or straws configured for non-flexure and/or pumps (e.g., submersible bore pumps, axial flow pumps, or other in-line style pumps) internal to the cylinder assembly (e.g., at least partially disposed within the piston rod thereof), as described in U.S. patent application Ser. No. 13/234,239, filed Sep. 16, 3011 (the '239 application), the entire disclosure of which is incorporated by reference herein.

At or near the end of the compression stroke, control system 326 opens valve 320 to admit the compressed gas 306 to the storage reservoir 322. Operation of valves 320 and 321 may be controlled by various inputs to control system 326, such as piston position in cylinder assembly 301, pressure in storage reservoir 322, pressure in cylinder assembly 301, and/or temperature in cylinder assembly 301.

As mentioned above, the control system 326 may enforce substantially isothermal operation, i.e., expansion and/or compression of gas in cylinder assembly 301, via control over, e.g., the introduction of gas into and the exhausting of gas out of cylinder assembly 301, the rates of compression and/or expansion, and/or the operation of the heat-exchange subsystem in response to sensed conditions. For example, control system 326 may be responsive to one or more sensors disposed in or on cylinder assembly 301 for measuring the temperature of the gas and/or the heat-exchange fluid within cylinder assembly 301, responding to deviations in temperature by issuing control signals that operate one or more of the system components noted above to compensate, in real time, for the sensed temperature deviations. For example, in response to a temperature increase within cylinder assembly 301, control system 326 may issue commands to increase the flow rate of spray 311 of heat-exchange fluid 308.

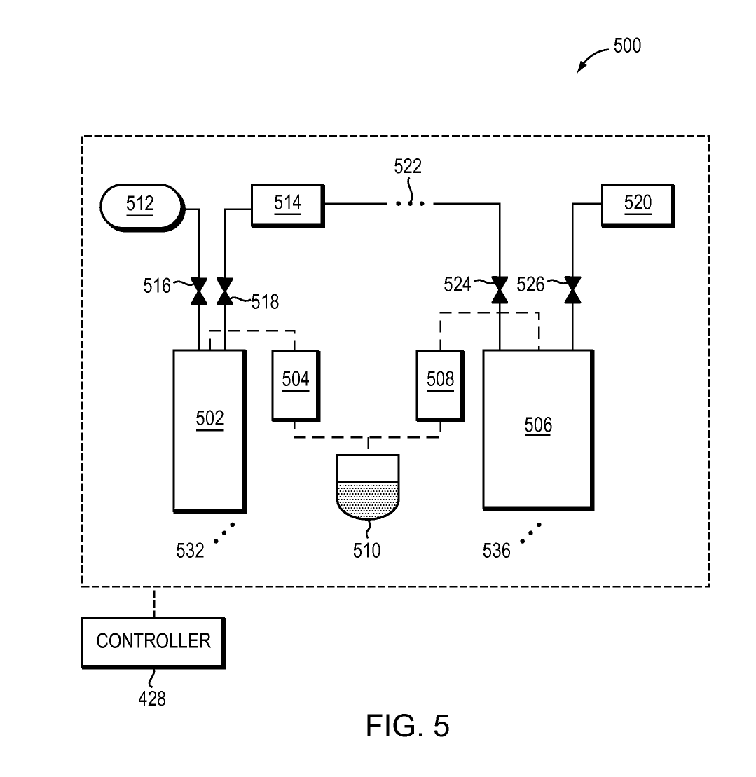

Furthermore, embodiments of the invention may be applied to systems in which cylinder assembly 301 (or a chamber thereof) is in fluid communication with a pneumatic chamber of a second cylinder (e.g., as shown in FIG. 5). That second cylinder, in turn, may communicate similarly with a third cylinder, and so forth. Any number of cylinders may be linked in this way. These cylinders may be connected in parallel or in a series configuration, where the compression and expansion is done in multiple stages.

The fluid circuit of heat exchanger 303 may be filled with water, a coolant mixture, an aqueous foam, or any other acceptable heat-exchange medium. In alternative embodiments, a gas, such as air or refrigerant, is used as the heat-exchange medium. In general, the fluid is routed by conduits to a large reservoir of such fluid in a closed or open loop. One example of an open loop is a well or body of water from which ambient water is drawn and the exhaust water is delivered to a different location, for example, downstream in a river. In a closed-loop embodiment, a cooling tower may cycle the water through the air for return to the heat exchanger. Likewise, water may pass through a submerged or buried coil of continuous piping where a counter heat-exchange occurs to return the fluid flow to ambient temperature before it returns to the heat exchanger for another cycle.

In various embodiments, the heat-exchange fluid is conditioned (i.e., pre-heated and/or pre-chilled) or used for heating or cooling needs by connecting the fluid inlet 338 and fluid outlet 340 of the external heat-exchange side of the heat exchanger 303 to an installation such as a heat-engine power plant, an industrial process with waste heat, a heat pump, and/or a building needing space heating or cooling, as described in the '731 patent. Alternatively, the external heat-exchange side of the heat exchanger 303 may be connected to a thermal well 342 as depicted in FIG. 3. The thermal well 342 may include or consist essentially of a large water reservoir that acts as a constant-temperature thermal fluid source for use with the system. Alternatively, the water reservoir may be thermally linked to waste heat from an industrial process or the like, as described above, via another heat exchanger contained within the installation. This allows the heat-exchange fluid to acquire or expel heat from/to the linked process, depending on configuration, for later use as a heating/cooling medium in the energy storage/conversion system. Alternatively, the thermal well 342 may include two or more bodies of energy-storage medium, e.g., a hot-water thermal well and a cold-water thermal well, that are typically maintained in contrasting energy states in order to increase the exergy of system 300 compared with a system in which thermal well 342 includes a single body of energy-storage medium. Storage media other than water may be utilized in the thermal well 342; temperature changes, phase changes, or both may be employed by storage media of thermal well 342 to store and release energy. Thermal or fluid links (not shown) to the atmosphere, ground, and/or other components of the environment may also be included in system 300, allowing mass, thermal energy, or both to be added to or removed from the thermal well 342. Moreover, as depicted in FIG. 3, the heat-transfer subsystem 324 does not interchange fluid directly with the thermal well 342, but in other embodiments, fluid is passed directly between the heat-transfer subsystem 324 and the thermal well 342 with no heat exchanger maintaining separation between fluids.

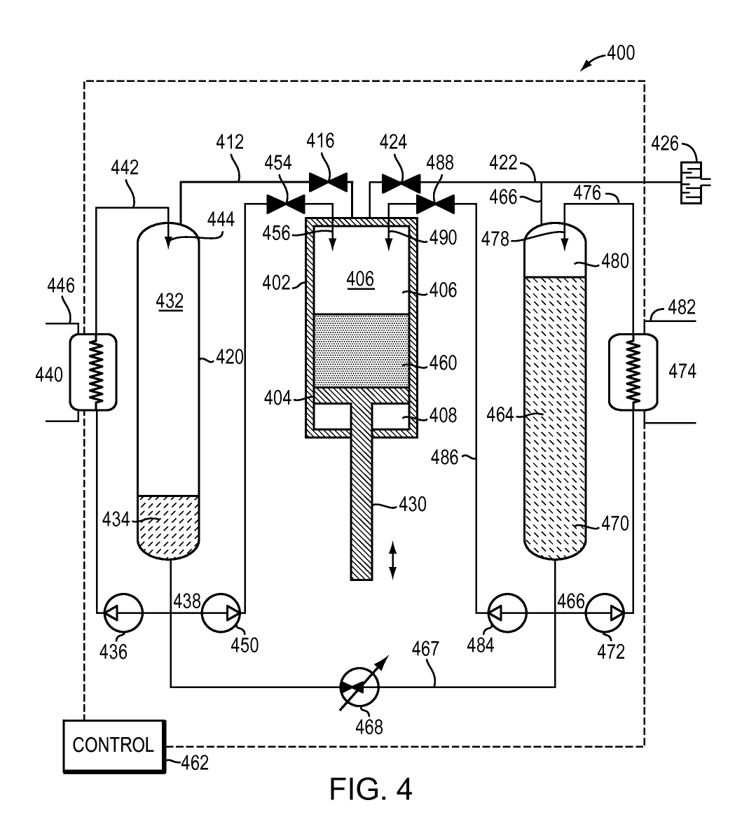

FIG. 4 is a schematic of the major components of an illustrative system 400 that employs a pneumatic cylinder 402 to efficiently convert (i.e., store) mechanical energy into the potential energy of compressed gas and, in another mode of operation, efficiently convert (i.e., recover) the potential energy of compressed gas into mechanical work. The pneumatic cylinder 402 may contain a slidably disposed piston 404 that divides the interior of the cylinder 402 into a distal chamber 406 and a proximal chamber 408. A port or ports (not shown) with associated pipes 412 and a bidirectional valve 416 enables gas from a high-pressure storage reservoir 420 (e.g., one or more pressure vessels, IPVs, and/or LURs) to be admitted to chamber 406 as desired. A port or ports (not shown) with associated pipes 422 and a bidirectional valve 424 enables gas from the chamber 406 to be exhausted through a vent 426 to the ambient atmosphere as desired. In alternate embodiments, vent 426 is replaced by additional lower-pressure pneumatic cylinders (or pneumatic chambers of cylinders). A port or ports (not shown) enables the interior of the chamber 408 to communicate freely at all times with the ambient atmosphere. In alternate embodiments, cylinder 402 is double-acting and chamber 408 is, like chamber 406, equipped to admit and exhaust fluids in various states of operation. The distal end of a rod 430 is coupled to the piston 404. The rod 430 may be connected to a crankshaft, hydraulic cylinder, or other mechanisms for converting linear mechanical motion to useful work as described in the '678 and '842 patents.

In the energy recovery or expansion mode of operation, storage reservoir 420 is filled with high-pressure air (or other gas) 432 and a quantity of heat-transfer fluid 434. The heat-transfer fluid 434 may be an aqueous foam or a liquid that tends to foam when sprayed or otherwise acted upon. The liquid component of the aqueous foam, or the liquid that tends to foam, may include or consist essentially of water with 2% to 5% of certain additives; these additives may also provide functions of anti-corrosion, anti-wear (lubricity), anti-biogrowth (biocide), freezing-point modification (anti-freeze), and/or surface-tension modification. Additives may include a micro-emulsion of a lubricating fluid such as mineral oil, a solution of agents such as glycols (e.g. propylene glycol), or soluble synthetics (e.g. ethanolamines). Such additives tend to reduce liquid surface tension and lead to substantial foaming when sprayed. Commercially available fluids may be used at an approximately 5% solution in water, such as Mecagreen 127 (available from the Condat Corporation of Michigan), which consists in part of a micro-emulsion of mineral oil, and Quintolubric 807-WP (available from the Quaker Chemical Corporation of Pennsylvania), which consists in part of a soluble ethanolamine. Other additives may be used at higher concentrations (such as at a 50% solution in water), including Cryo-tek 100/Al (available from the Hercules Chemical Company of New Jersey), which consists in part of a propylene glycol. These fluids may be further modified to enhance foaming while being sprayed and to speed defoaming when in a reservoir.

The heat-transfer fluid 434 may be circulated within the storage reservoir 420 via high-inlet-pressure, low-power-consumption pump 436 (such as described in the '731 patent). In various embodiments, the fluid 434 may be removed from the bottom of the storage reservoir 420 via piping 438, circulated via pump 436 through a heat exchanger 440, and introduced (e.g., sprayed) back into the top of storage reservoir 420 via piping 442 and spray head 444 (or other suitable mechanism). Any changes in pressure within reservoir 420 due to removal or addition of gas (e.g., via pipe 412) generally tend to result in changes in temperature of the gas 432 within reservoir 420. By spraying and/or foaming the fluid 434 throughout the storage reservoir gas 432, heat may be added to or removed from the gas 432 via heat exchange with the heat-transfer fluid 434. By circulating the heat-transfer fluid 434 through heat exchanger 440, the temperature of the fluid 434 and gas 432 may be kept substantially constant (i.e., isothermal). Counterflow heat-exchange fluid 446 at near-ambient pressure may be circulated from a near-ambient-temperature thermal well (not shown) or source (e.g., waste heat source) or sink (e.g., cold water source) of thermal energy, as described in more detail below.

In various embodiments of the invention, reservoir 420 contains an aqueous foam, either unseparated or partially separated into its gaseous and liquid components. In such embodiments, pump 436 may circulate either the foam itself, or the separated liquid component of the foam, or both, and recirculation of fluid into reservoir 420 may include regeneration of foam by apparatus not shown in FIG. 4.

In the energy recovery or expansion mode of operation, a quantity of gas may be introduced via valve 416 and pipe 412 into the upper chamber 406 of cylinder 402 when piston 404 is near or at the top of its stroke (i.e., “top dead center” of cylinder 402). The piston 404 and its rod 430 will then be moving downward (the cylinder 402 may be oriented arbitrarily but is shown vertically oriented in this illustrative embodiment). Heat-exchange fluid 434 may be introduced into chamber 406 concurrently via optional pump 450 (alternatively, a pressure drop may be introduced in line 412 such that pump 450 is not needed) through pipe 452 and directional valve 454. This heat-exchange fluid 434 may be sprayed into chamber 406 via one or more spray nozzles 456 in such a manner as to generate foam 460. (In some embodiments, foam 460 is introduced directly into chamber 406 in foam form.) The foam 460 may entirely fill the entire chamber 406, but is shown in FIG. 4, for illustrative purposes only, as only partially filling chamber 406. Herein, the term “foam” denotes either (a) foam only or (b) any of a variety of mixtures of foam and heat-exchange liquid in other, non-foaming states (e.g., droplets). Moreover, some non-foamed liquid (not shown) may accumulate at the bottom of chamber 406; any such liquid is generally included in references herein to the foam 460 within chamber 406.

System 400 is instrumented with pressure, piston position, and/or temperature sensors (not shown) and controlled via control system 462. At a predetermined position of piston 404, an amount of gas 432 and heat-transfer fluid 434 have been admitted into chamber 406 and valve 416 and valve 454 are closed. (Valves 416 and 454 may close at the same time or at different times, as each has a control value based on quantity of fluid desired.) The gas in chamber 406 then undergoes free expansion, continuing to drive piston 404 downward. During this expansion, in the absence of foam 460, the gas would tend to decrease substantially in temperature. With foam 460 largely or entirely filling the chamber, the temperature of the gas in chamber 406 and the temperature of the heat-transfer fluid 460 tend to approximate to each other via heat exchange. The heat capacity of the liquid component of the foam 460 (e.g., water with one or more additives) may be much higher than that of the gas (e.g., air) such that the temperature of the gas and liquid do not change substantially (i.e., are substantially isothermal) even over a many-times gas expansion (e.g., from 250 psig to near atmospheric pressure, or in other embodiments from 3,000 psig to 250 psig).

When the piston 404 reaches the end of its stroke (bottom dead center), the gas within chamber 406 will have expanded to a predetermined lower pressure (e.g., near atmospheric). Valve 424 will then be opened, allowing gas from chamber 406 to be vented, whether to atmosphere through pipe 422 and vent 426 (as illustrated here) or, in other embodiments, to a next stage in the expansion process (e.g., chamber in a separate cylinder), via pipe 422. Valve 424 remains open as the piston undergoes an upward (i.e., return) stroke, emptying chamber 406. Part or substantially all of foam 460 is also forced out of chamber 406 via pipe 422. A separator (not shown) or other means such as gravity separation is used to recover heat-transfer fluid, preferably de-foamed (i.e., as a simple liquid with or without additives), and to direct it into a storage reservoir 464 via pipe 466.

When piston 404 reaches top of stroke again, the process repeats with gas 432 and heat-transfer fluid 434 admitted from vessel 420 via valves 416 and 454. If additional heat-transfer fluid is needed in reservoir 420, it may be pumped back into reservoir 420 from reservoir 464 via piping 467 and optional pump/motor 468. In one mode of operation, pump 468 may be used to continuously refill reservoir 420 such that the pressure in reservoir 420 is held substantially constant. That is, as gas is removed from reservoir 420, heat-transfer fluid 434 is added to maintain constant pressure in reservoir 420. In other embodiments, pump 468 is not used or is used intermittently, the pressure in reservoir 420 continues to decrease during an energy-recovery process (i.e., involving removal of gas from reservoir 420), and the control system 462 changes the timing of valves 416 and 454 accordingly so as to reach approximately the same ending pressure when the piston 404 reaches the end of its stroke. An energy-recovery process may continue until the storage reservoir 420 is nearly empty of pressurized gas 432, at which time an energy-storage process may be used to recharge the storage reservoir 420 with pressurized gas 432. In other embodiments, the energy-recovery and energy-storage processes are alternated based on operator requirements.

In either the energy-storage or energy-compression mode of operation, storage reservoir 420 is typically at least partially depleted of high-pressure gas 432, as storage reservoir 420 also typically contains a quantity of heat-transfer fluid 434. Reservoir 464 is at low pressure (e.g., atmospheric or some other low pressure that serves as the intake pressure for the compression phase of cylinder 402) and contains a quantity of heat-transfer fluid 470.

The heat-transfer fluid 470 may be circulated within the reservoir 464 via low-power-consumption pump 472. In various embodiments, the fluid 470 may be removed from the bottom of the reservoir 464 via piping 467, circulated via pump 472 through a heat exchanger 474, and introduced (e.g., sprayed) back into the top of reservoir 464 via piping 476 and spray head 478 (or other suitable mechanism). By spraying the fluid 470 throughout the reservoir gas 480, heat may be added or removed from the gas via the heat-transfer fluid 470. By circulating the heat-transfer fluid 470 through heat exchanger 474, the temperature of the fluid 470 and gas 480 may be kept near constant (i.e., isothermal). Counterflow heat-exchange fluid 482 at near-ambient pressure may be circulated from a near-ambient-temperature thermal well (not shown) or source (e.g., waste heat source) or sink (e.g., cold water source) of thermal energy. In one embodiment, counterflow heat-exchange fluid 482 is at high temperature to increase energy recovery during expansion and/or counterflow heat-exchange fluid 482 is at low temperature to decrease energy usage during compression.

In the energy-storage or compression mode of operation, a quantity of low-pressure gas is introduced via valve 424 and pipe 422 into the upper chamber 406 of cylinder 402 starting when piston 404 is near top dead center of cylinder 402. The low-pressure gas may be from the ambient atmosphere (e.g., may be admitted through vent 426 as illustrated herein) or may be from a source of pressurized gas such as a previous compression stage. During the intake stroke, the piston 404 and its rod 430 will move downward, drawing in gas. Heat-exchange fluid 470 may be introduced into chamber 406 concurrently via optional pump 484 (alternatively, a pressure drop may be introduced in line 486 such that pump 484 is not needed) through pipe 486 and directional valve 488. This heat exchange fluid 470 may be introduced (e.g., sprayed) into chamber 406 via one or more spray nozzles 490 in such a manner as to generate foam 460. This foam 460 may fill the chamber 406 partially or entirely by the end of the intake stroke; for illustrative purposes only, foam 460 is shown in FIG. 4 as only partially filling chamber 406. At the end of the intake stroke, piston 404 reaches the end-of-stroke position (bottom dead center) and chamber 406 is filled with foam 460 generated from air at a low pressure (e.g., atmospheric) and heat-exchange liquid.

At the end of the stroke, with piston 404 at the end-of-stroke position, valve 424 is closed. Valve 488 is also closed, not necessarily at the same time as valve 424, but after a predetermined amount of heat-transfer fluid 470 has been admitted, creating foam 460. The amount of heat-transfer fluid 470 may be based upon the volume of air to be compressed, the ratio of compression, and/or the heat capacity of the heat-transfer fluid. Next, piston 404 and rod 430 are driven upwards via mechanical means (e.g., hydraulic fluid, hydraulic cylinder, mechanical crankshaft) to compress the gas within chamber 406.

During this compression, in the absence of foam 460, the gas in chamber 406 would tend to increase substantially in temperature. With foam 460 at least partially filling the chamber, the temperature of the gas in chamber 406 and the temperature of the liquid component of foam 460 will tend to equilibrate via heat exchange. The heat capacity of the fluid component of foam 460 (e.g., water with one or more additives) may be much higher than that of the gas (e.g., air) such that the temperature of the gas and fluid do not change substantially and are near-isothermal even over a many-times gas compression (e.g., from near atmospheric pressure to 250 psig, or in other embodiments from 250 psig to 3,000 psig).

The gas in chamber 406 (which includes, or consists essentially of, the gaseous component of foam 460) is compressed to a suitable pressure, e.g., a pressure approximately equal to the pressure within storage reservoir 420, at which time valve 416 is opened. The foam 460, including both its gaseous and liquid components, is then transferred into storage reservoir 420 through valve 416 and pipe 412 by continued upward movement of piston 404 and rod 430.

When piston 404 reaches top of stroke again, the process repeats, with low-pressure gas and heat-transfer fluid 470 admitted from vent 426 and reservoir 464 via valves 424 and 488. If additional heat-transfer fluid is needed in reservoir 464, it may be returned to reservoir 464 from reservoir 420 via piping 467 and optional pump/motor 468. Power recovered from motor 468 may be used to help drive the mechanical mechanism for driving piston 404 and rod 430 or may be converted to electrical power via an electric motor/generator (not shown). In one mode of operation, motor 468 may be run continuously, while reservoir 420 is being filled with gas, in such a manner that the pressure in reservoir 420 is held substantially constant. That is, as gas is added to reservoir 420, heat-transfer fluid 434 is removed from reservoir 420 to maintain substantially constant pressure within reservoir 420. In other embodiments, motor 468 is not used or is used intermittently; the pressure in reservoir 420 continues to increase during an energy-storage process and the control system 462 changes the timing of valves 416 and 488 accordingly so that the desired ending pressure (e.g., atmospheric) is attained within chamber 406 when the piston 404 reaches bottom of stroke. An energy-storage process may continue until the storage reservoir 420 is full of pressurized gas 432 at the maximum storage pressure (e.g., 3,000 psig), after which time the system is ready to perform an energy-recovery process. In various embodiments, the system may commence an energy-recovery process when the storage reservoir 420 is only partly full of pressurized gas 432, whether at the maximum storage pressure or at some storage pressure intermediate between atmospheric pressure and the maximum storage pressure. In other embodiments, the energy-recovery and energy-storage processes are alternated based on operator requirements.

FIG. 5 depicts an illustrative system 500 that features at least two cylinder assemblies 502, 506 (i.e., an embodiment of assembly 201 in FIG. 2; e.g., cylinder assembly 301 in FIG. 3) and a heat-transfer subsystem 504, 508 (e.g., subsystem 324 in FIG. 3 associated with each cylinder assembly 502, 506. Additionally, the system includes a thermal well 510 (e.g., thermal well 342 in FIG. 3) which may be associated with either or both of the heat-transfer subsystems 504, 508 as indicated by the dashed lines.

Assembly 502 is in selective fluid communication with a storage reservoir 512 (e.g., 212 in FIG. 2, 322 in FIG. 3) capable of holding fluid at relatively high pressure (e.g., approximately 3,000 psig). Assembly 506 is in selective fluid communication with assembly 502 and/or with optional additional cylinder assemblies between assemblies 502 and 506 as indicated by ellipsis marks 522. Assembly 506 is in selective fluid communication with an atmospheric vent 520 (e.g., 220 in FIG. 2, 323 in FIG. 3).

System 500 may compress air at atmospheric pressure (admitted to system 500 through the vent 520) stagewise through assemblies 506 and 502 to high pressure for storage in reservoir 512. System 500 may also expand air from high pressure in reservoir 512 stagewise through assemblies 502 and 506 to a low pressure (e.g., approximately 5 psig) for venting to the atmosphere through vent 520.

As described in U.S. Pat. No. 8,191,362, filed Apr. 6, 2011 (the '362 patent), the entire disclosure of which is incorporated by reference herein, in a group of N cylinder assemblies used for expansion or compression of gas between a high pressure (e.g., approximately 3,000 psig) and a low pressure (e.g., approximately 5 psig), the system will contain gas at N−1 pressures intermediate between the high-pressure extreme and the low pressure. Herein each such intermediate pressure is termed a “mid-pressure.” In illustrative system 500, N=2 and N−1=1, so there is one mid-pressure (e.g., approximately 250 psig during expansion) in the system 500. In various states of operation of the system, mid-pressures may occur in any of the chambers of a series-connected cylinder group (e.g., the cylinders of assemblies 502 and 506) and within any valves, piping, and other devices in fluid communication with those chambers. In illustrative system 500, the mid-pressure, herein denoted “mid-pressure P1,” occurs primarily in valves, piping, and other devices intermediate between assemblies 502 and 506.

Assembly 502 is a high-pressure assembly: i.e., assembly 502 may admit gas at high pressure from reservoir 512 to expand the gas to mid-pressure P1 for transfer to assembly 502, and/or may admit gas at mid-pressure P1 from assembly 506 to compress the gas to high pressure for transfer to reservoir 512. Assembly 506 is a low-pressure assembly: i.e., assembly 506 may admit gas at mid-pressure P1 from assembly 502 to expand the gas to low pressure for transfer to the vent 520, and/or may admit gas at low pressure from vent 520 to compress the gas to mid-pressure P1 for transfer to assembly 502.

In system 500, extended cylinder assembly 502 communicates with extended cylinder assembly 506 via a mid-pressure assembly 514. Herein, a “mid-pressure assembly” includes or consists essentially of a reservoir of gas that is placed in fluid communication with the valves, piping, chambers, and other components through or into which gas passes. The gas in the reservoir is at approximately at the mid-pressure which the particular mid-pressure assembly is intended to provide. The reservoir is large enough so that a volume of mid-pressure gas approximately equal to that within the valves, piping, chambers, and other components with which the reservoir is in fluid communication may enter or leave the reservoir without substantially changing its pressure. Additionally, the mid-pressure assembly may provide pulsation damping, additional heat-transfer capability, fluid separation, and/or house one or more heat-transfer sub-systems such as part or all of sub-systems 504 and/or 508. As described in the '362 patent, a mid-pressure assembly may substantially reduce the amount of dead space in various components of a system employing pneumatic cylinder assemblies, e.g., system 500 in FIG. 5. Reduction of dead space tends to increase overall system efficiency.

Alternatively or in conjunction, pipes and valves (not shown in FIG. 5) bypassing mid-pressure assembly 514 may enable fluid to pass directly between assembly 502 and assembly 506. Valves 516, 518, 524, and 526 control the passage of fluids between the assemblies 502, 506, 512, and 514.

A control system 528 (e.g., 222 in FIG. 2, 326 in FIG. 3, 462 in FIG. 4) may control operation of, e.g., all valves of system 500 based on various system inputs (e.g., pressure, temperature, piston position, and/or fluid state) from assemblies 502 and 506, mid-pressure assembly 514, storage reservoir 512, thermal well 510, heat transfer sub-systems 504, 508, and/or the environment surrounding system 520.

It will be clear to persons reasonably familiar with the art of pneumatic machines that a system similar to system 500 but differing by the incorporation of one, two or more mid-pressure extended cylinder assemblies may be devised without additional undue experimentation. It will also be clear that all remarks herein pertaining to system 500 may be applied to such an N-cylinder system without substantial revision, as indicated by elliptical marks 522. Such N-cylinder systems, though not discussed further herein, are contemplated and within the scope of the invention. As shown and described in the '678 patent, N appropriately sized cylinders, where N≧2, may reduce an original (single-cylinder) operating fluid pressure range R to R^{1/N} and correspondingly reduce the range of force acting on each cylinder in the N-cylinder system as compared to the range of force acting in a single-cylinder system. This and other advantages, as set forth in the '678 patent, may be realized in N-cylinder systems. Additionally, multiple identical cylinders may be added in parallel and attached to a common or separate drive mechanism (not shown) with the cylinder assemblies 502, 506 as indicated by ellipsis marks 532, 536, enabling higher power and air-flow rates.

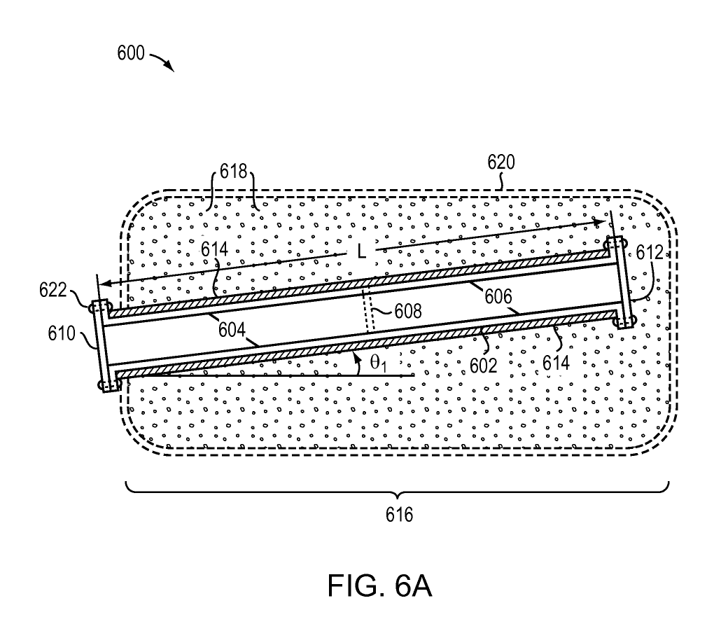

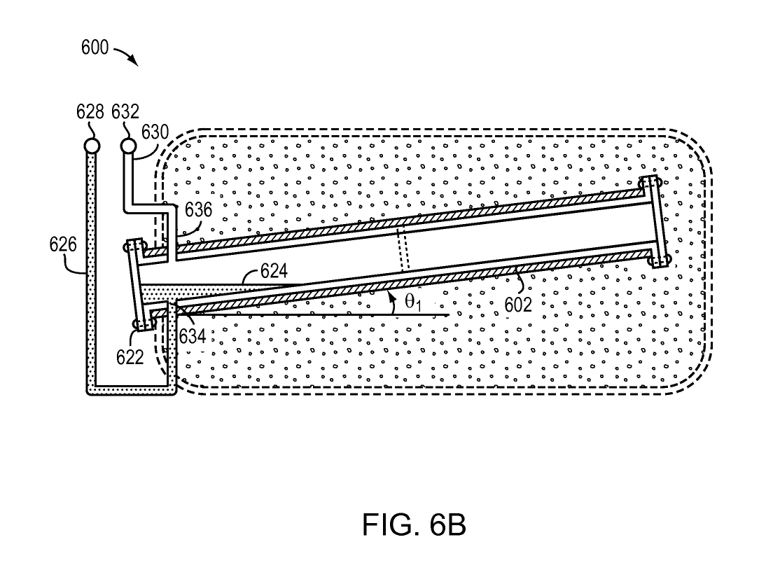

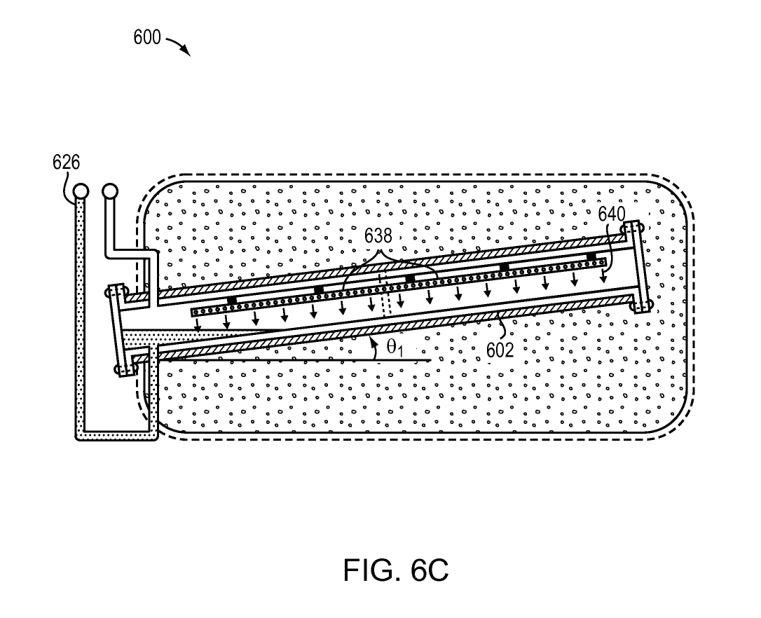

Pressurized fluids may also be stored in accordance with various embodiments of the present invention, alternatively or additionally to the use of LURs, in insulated pipeline vessels (IPVs). FIG. 6A is a cross-sectional schematic drawing of an illustrative insulated pipeline vessel (IPV) system 600 for the storage of fluid at pressures up to some relatively high value (e.g., 3,000 psig) and at temperatures up to some relatively elevated temperature (e.g., 100° C.). The drawing in FIG. 6A shows a side view. The IPV system 600, which may be part of the storage subsystem of an energy storage-and-recovery system (not shown), features a single length of pipeline 602, e.g., natural-gas pipeline, which in this illustrative case has length L (e.g., an interval of 40 or 80 foot sections) and an interior diameter of D (e.g., 32 inches). The cross-sectional shape of the pipeline 602 is circular in this illustrative system 600, but various other embodiments have other cross-sectional shapes. Additional components of illustrative system 600, some optional, are depicted in subsequent figures. All illustrative IPV systems depicted herein, including arrays of IPV pipeline sections, may be utilized in energy-storage-and-recovery systems whose other components are not depicted.

The single length of pipeline 602 may include or consist essentially of two or more shorter lengths of pipe (e.g., in this illustrative pipeline 602, the sub-lengths 604, 606), welded together or otherwise joined in fluid-proof manner at one or more joints 608. End caps 610, 612 seal the ends of the pipeline 602 to form an enclosed volume: in this illustrative case, end-caps 610, 612 are bolted to flanges on the ends of pipeline 602. Pipeline 602 is generally tilted at some angle θ₁ from the horizontal. A layer of insulation 614 covers the outer surface of the pipeline 602. Additional insulation or protective coatings (not shown) may be applied as layers to the interior of the pipeline 602. Pipeline 602 may be substantially or wholly buried within a berm or fill capsule 616 including or consisting essentially of fill 618 and a substantially impermeable envelope 620. The fill 618 may include or consist essentially of various forms of earth (e.g., sand, crushed rock), an artificial thermal insulation material, or a mixture of earth and insulating material. The fill 618 is preferably dry (i.e., contains no substantial fraction of liquid water), in order that the thermal insulating power of the fill capsule 616 may be maximal. The impermeable envelope 620 prevents circulation of liquid and possibly air into and through the fill capsule 616, increasing the thermal insulating power of the fill capsule 616. The thickness of the fill capsule 616 as measured from various points on the outer surface of the pipeline 612 to the impermeable envelope 620 may vary from point to point, but will preferably be chosen to meet structural requirements and produce an insulating effect on the pipeline 602 that justifies the cost of constructing the fill capsule 616 (e.g., justifies the cost of constructing the fill capsule 616 in terms of levelized cost of energy of the storage subsystem comprising IPV system 600).

The lower end 622 of the pipeline 602 in the illustrative IPV system 600 is allowed to protrude from the fill capsule 616. The system 600 may be partly or entirely buried in earth (e.g., the earth naturally present at a given installation site; not shown), in which case a trench, pit, or vault (not shown) may be constructed to allow maintenance access to the lower end 622 of the pipeline 602.

The first insulation layer 614 and the insulating fill capsule 616 serve jointly to slow to an acceptable rate the exchange of thermal energy between the fluid contents of pipeline 616 and the ambient environment of system 600.

FIG. 6B shows additional components of the illustrative IPV system 600 of FIG. 6A. An accumulation of liquid 624 may exist at the lower end 622 of the pipeline 602. The pipeline 602 may also contain gas and aqueous foam or droplets (not shown). A pipe 626 enables the withdrawal of liquid from (or the introduction of gas or liquid into) pipeline 602 through an access point 628. A pipe 630 enables the withdrawal of gas from (or the introduction of gas or liquid into) pipeline 602 through an access point 632. Alternatively or additionally, both pipes 626 and 630 may enable the exchange of two-phase fluids with the pipeline 602. System 600 may include valves (e.g., valves controlling flow through pipes 626 and 630), pumps, and other components not depicted in FIG. 6B. Preferably, the liquid accumulation 624 is not allowed to achieve a depth that blocks the point where pipe 630 is connected to the interior of pipeline 602. The points at which pipes 626 and 630 connect to the interior of pipeline 602 in system 600 (i.e., the insertion points 634, 636 of pipes 626 and 630) are not necessarily drawn to scale; e.g., the insertion point 636 of pipe 630 may be farther from end 622 than shown in FIG. 6B, allowing the liquid accumulation 624 to achieve a greater depth without blocking the insertion point 636 of pipe 630. In other embodiments, angle θ₁ is negative, and the insertion point 634 of pipe 626 is at the far end of the pipe 602 from end 622.

FIG. 6C shows optional components of the illustrative IPV system 600 of FIG. 6A. In particular, a spray rod 638 is positioned inside pipeline 602. In other embodiments, the spray rod 638 is external to the pipeline 602 with spaced nozzle holes penetrating the pipeline 602 at appropriate intervals (e.g., one nozzle penetration per meter). Liquid or a two-phase mixture (e.g., foam) 640 may be injected, indicated in FIG. 6C by a row of short arrows, into the interior of pipeline 602, where it may proceed to exchange heat with the fluid contents of pipeline 602 (e.g., stored, expanding, or compressing gas). In other embodiments, devices other than spray rods (e.g., spray heads) are employed (alone or in conjunction with spray rods) to inject the fluid 640. The fluid 640 may be fluid withdrawn from pipeline 602 via pipe 626 and circulated through a pump (not shown), heat exchanger (not shown), and/or other devices (not shown) before being injected through spray rod 638; or, the fluid 640 may be supplied to spray rod 638 from a reservoir (not shown) or other source or subsystem. By the injection of fluid 640 at an appropriate temperature and rate, the temperature of the fluid contents of pipeline 602 may be kept approximately constant as gas and liquid are added or removed from pipeline 602; or, the temperature of the fluid contents of pipeline 602 may be increased or decreased at any time, or may be kept approximately constant during the addition of fluid to pipeline 602 (which will tend to increase pressure and temperature of the fluid contents of pipeline 602) or during the withdrawal of fluid from pipeline 602 (which will tend to decrease pressure and temperature of the fluid contents of pipeline 602). Holding the temperature of the fluid contents of pipeline 602 approximately equal throughout the volume of pipeline 602 and/or approximately constant during the addition or removal of fluid (i.e., realizing a substantially isothermal process) will tend to increase the overall efficiency of the energy storage system of which system 600 is a part, and is therefore advantageous.

The preferable value of the angle θ₁, and of other angles of IPV tilt in other illustrative systems described herein, depends on the amounts of liquid found in each IPV in various states of system operation, the rates at which liquid is introduced into and removed from each IPV, and the inner dimensions of each IPV (e.g., diameter, length, locations of points of piping insertion). In accordance with various embodiments of the invention, the angle of IPV tilt may even be altered during operation via mechanical means, e.g., a tiltable stage.

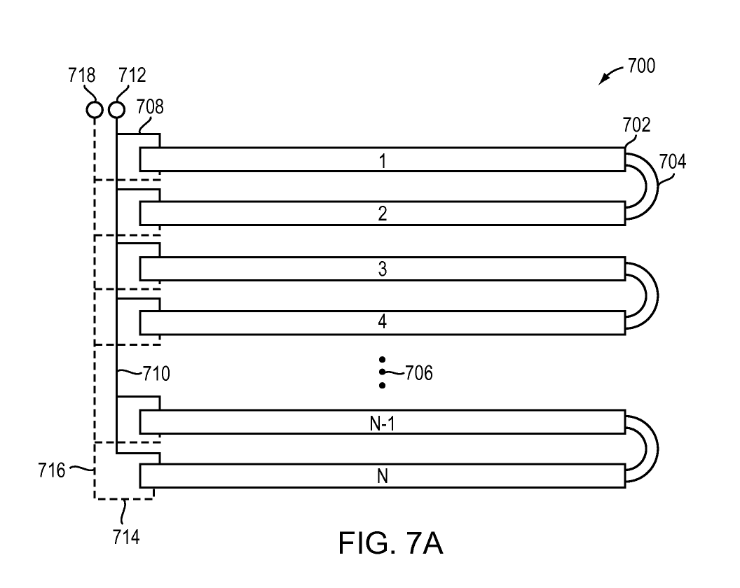

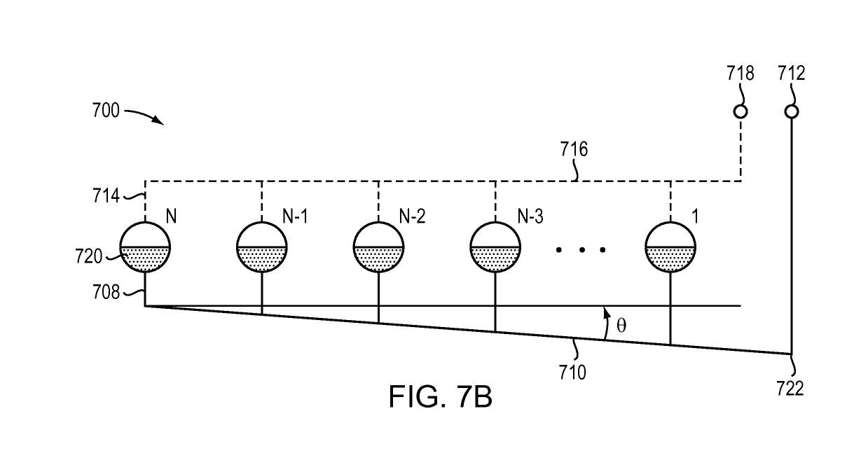

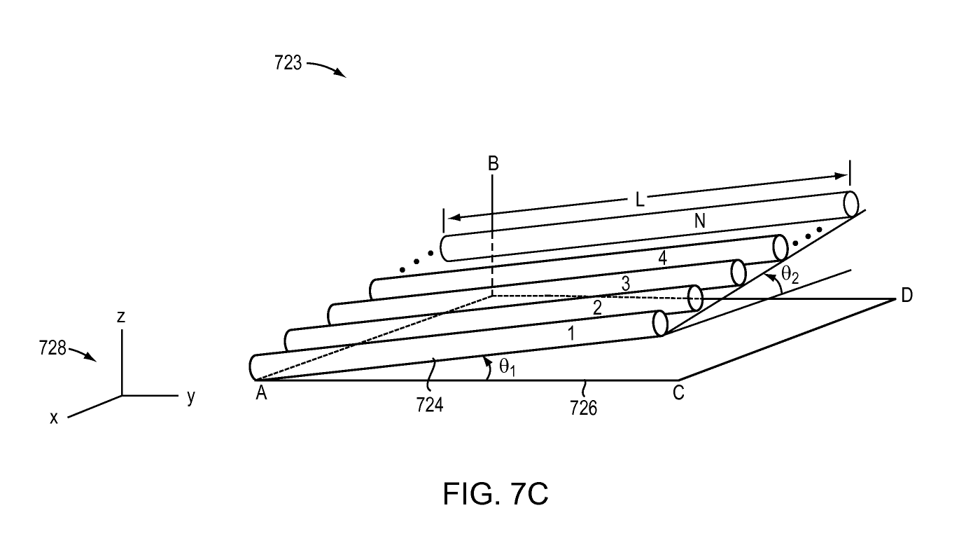

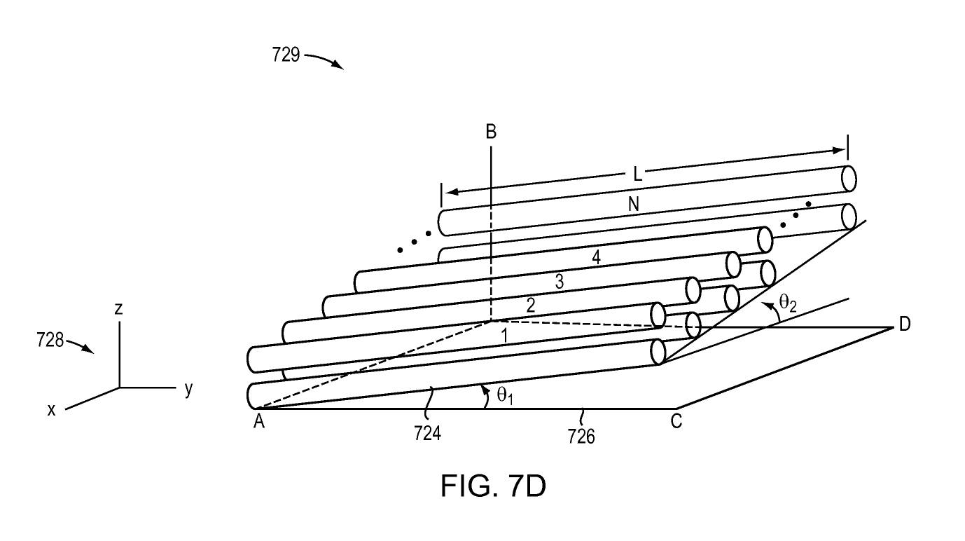

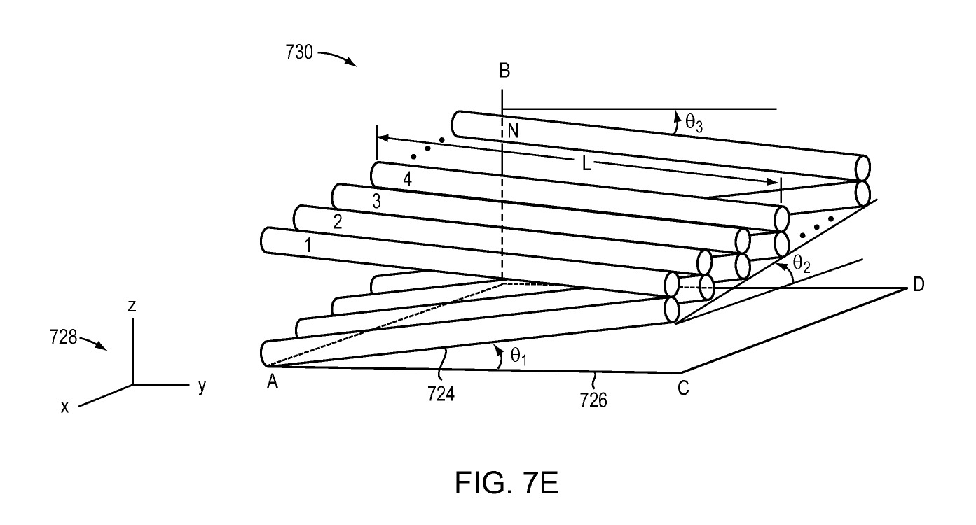

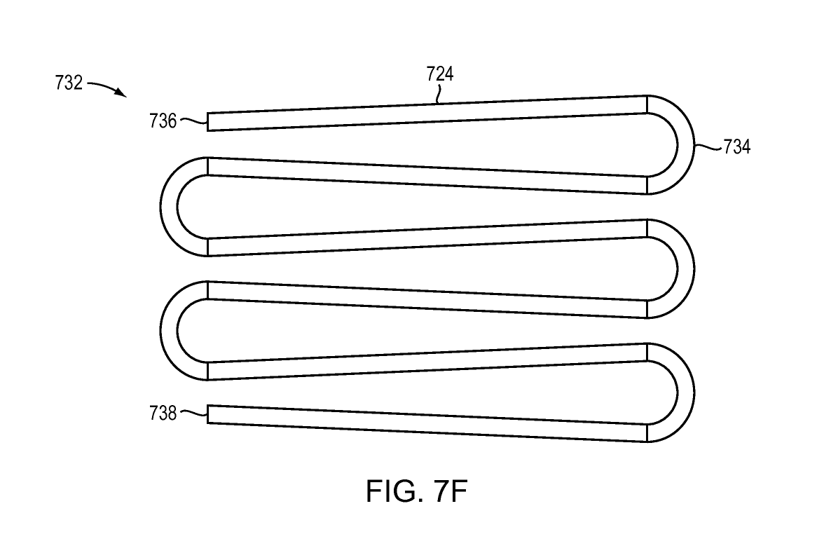

FIG. 7A is a schematic diagram of components of an illustrative IPV array 700 including or consisting essentially of an array of N IPV pipeline sections (only one IPV pipeline section 702 is explicitly labeled in FIG. 7A). Herein, the terms “IPV pipeline section” and “IPV” are synonymous. FIG. 7A shows the IPV array 700 from an overhead point of view. The N IPVs 702 are joined in pairs by N/2 U-shaped connector pipes (only one U-shaped connector pipe 704 is explicitly labeled in FIG. 7A). In various other embodiments, the U-shaped connectors 704 are omitted or their function is performed by other forms of piping. Vertical ellipses 706 indicate the presence of an indefinite number of additional pipeline sections in the array 700. Each IPV section in FIG. 7A (e.g., section 702) is similar to IPV system 600 in FIGS. 6A, 6B, 6C and may include any or all of the arrangements described or depicted for system 600, as well as additional arrangements. For example, array 700 may be enclosed by a fill capsule with an impermeable envelope to slow the exchange of thermal energy between the fluid contents of array 700 and the ambient environment, or a separate fill capsule may enclose each IPV section in the array 700. Although the number N of IPV pipeline sections in FIG. 7A is depicted as equal to or greater than 6, any N equal to or greater than 1 is contemplated and within the scope of the invention.

The pipeline sections 702 of the illustrative array 700 are parallel to each other and lie in a common plane; in various embodiments, the pipeline sections 702 may not be co-planar. The plane in which the pipeline sections 702 lie is tilted at some angle θ₁ from the horizontal, with the lower end of the plane at the left-hand side of FIG. 7A. By gravity, liquid and two-phase mixtures will tend to flow downhill to the downhill ends of the IPVs, i.e., the ends at the left-hand side of FIG. 7A. The angle θ₁ is preferably larger than but close to the minimum angle that will cause acceptably rapid flow of fluid to the downhill end of each IPV in the array 700 without causing fluid blockage of the insertion points of the pipes (e.g., 708) that permit exchange of gas with each IPV section.

At the downhill end of each IPV section in FIG. 7A (e.g., pipe section 702), piping 708 permits fluid (e.g., liquid) to be added to or withdrawn from the pipe section through a manifold pipe 710 and a surface access point 712. Also at the lower end of each IPV section in FIG. 7A (e.g., pipe section 702), piping 714 permits fluid (e.g., gas or foam) to be added to or withdrawn from the pipe section through a manifold pipe 716 and a surface access point 718.

Uniformly spaced, straight, parallel (at least in one plane) IPV pipeline sections of uniform diameter and identical length and diameter are depicted in FIG. 7A and in various depictions of illustrative IPV arrays herein, but in various other embodiments, arrayed IPV sections need not be straight, parallel, uniformly spaced, uniform in diameter, or identical in length and/or diameter. Alternative embodiments of all illustrative IPV arrays depicted herein may be readily devised in which the arrayed IPV pipeline sections are not straight, parallel, uniformly spaced, uniform in diameter, or identical in length and/or diameter in accordance with embodiments of the invention. In various embodiments, IPV arrays are interconnected with other forms of fluid storage, e.g., lined or unlined underground reservoirs and non-IPV storage vessels, to provide energy and fluid storage for one or more energy storage-and-recovery systems.

FIG. 7B is a schematic cross-section of portions of the IPV array 700 of FIG. 7A. The cross-section shows the downhill ends of the array 700, with a liquid accumulation 720 in each IPV. (Only one liquid accumulation 720, i.e., that in the Nth IPV, is explicitly labeled in FIG. 7B. Although similar liquid accumulations are shown in other IPVs in FIG. 7B, each IPV may contain a different amount of liquid accumulation.) At the downhill end of each IPV depicted in cross-section in FIG. 7B, piping 708 permits liquid to be added to or withdrawn from the IPV through a manifold pipe 710 and access point 712. Also at the downhill ends of the IPVs depicted in cross-section in FIG. 7B, piping 714 permits fluid (e.g., gas or foam) to be added to or withdrawn from the pipe section through manifold pipe 716 and surface access point 718. The plane in which the N IPVs of array 700 lie is tilted only along the lengthwise dimension of the IPVs themselves: i.e., any perpendicular cross-sectional view of array 700, such as FIG. 7B, will show a level row of pipeline cross-sections, although the altitude of that level row will be higher for cross-sections closer to the elevated edge of the array (the right-hand edge of the array in FIG. 7A).

In illustrative IPV array 700, the manifold pipe 710 is tilted at some angle θ with sufficient to guarantee downhill flow of liquid from all N IPV pipeline sections to the low point 722 of manifold 710. A sump or reservoir (not shown) located approximately at point 722 may allow an accumulation of liquid. A pump (not shown) may be employed to raise liquid from point 722 or from a sump located approximately at point 722 to the liquid access point 712. Gas pressure in the N IPV pipeline sections may contribute to or entirely cause the movement of liquid from the IPV s to the access point 712. In various other embodiments, angle θ is zero and pumping and/or gas pressure are entirely responsible for the movement of liquid from the N IPV pipeline sections to the access point 712.

FIG. 7C is a schematic diagram of components of an illustrative rectangular IPV array 723 including or consisting essentially of N similar, parallel IPV pipeline sections (only one IPV 724 is explicitly labeled in FIG. 7C). Each IPV section in FIG. 7C is similar to IPV system 600 in FIGS. 6A, 6B, 6C and may include any or all of the arrangements described or depicted for system 600, as well as additional arrangements. The IPV array 723 may also include any or all of the arrangements described or depicted for array 700 in FIGS. 7A and 7B, as well as additional arrangements. FIG. 7C indicates the level plane ABCD (726) and the orientation of three standard orthogonal axes x, y, and z (728). The N IPV pipeline sections of array 723 are parallel to one another and lie in a common plane that is tilted at angle θ₁ with respect to the y axis and at angle θ₂ with respect to the x axis. Herein, the edge of the IPV array 723 that lies along a straight line at angle θ₂ with respect to the x axis is termed the CD edge (because of its proximity to the line segment CD). By extension of this convention, the other three edges of the array 723 are herein termed the AB, AC, and BD edges. One or more manifolds or U-connector pipes (not shown) enable fluid communication between the interiors of the N IPV pipeline sections of array 723 and the delivery of gas to, or removal of gas from, the pipeline sections. Optional manifolds or U-connector pipes (not shown) may allow passive downhill liquid flow along the CD and/or AB edges of array 723. Manifolds or piping (not shown) may also allow fluid to pass between the N IPV pipeline sections at points located anywhere along the pipeline sections. The angles θ₁ and θ₂ may be selected, in combination with optional manifolds and piping, to provide acceptable gravity-assisted flow, pooling, and collection through manifolds of liquid or other flowing fluid (e.g., foam) within array 723 without interfering with access to the gaseous contents of array 723 (e.g., by liquid blockage of openings intended for the passage of gas or two-phase mixtures). Preferably, manifolds and piping of the array 723 are arranged so that gas and liquid (and/or two-phase mixtures of gas and liquid) may be delivered to or removed from the array 723 from a closely clustered set of surface access points (e.g., near the A corner of array 723 or at some point along the AB edge of array 723).

FIG. 7D is a schematic diagram of components of an illustrative rectangular IPV array 729 including or consisting essentially of 2N similar, parallel pipeline sections (only one IPV pipeline section 724 is explicitly labeled in FIG. 7D). Each IPV section in FIG. 7D is similar to IPV system 600 in FIGS. 6A, 6B, 6C and may include any or all of the arrangements described or depicted for system 600, as well as additional arrangements. The IPV array 729 may also include any or all of the arrangements described or depicted for arrays 700, 723 in FIGS. 7A, 7B, and 7C, as well as additional arrangements. FIG. 7D indicates the level plane ABCD (726) and the orientation of three standard orthogonal axes x, y, and z (728). The 2N IPV pipeline sections of array 729 are parallel to one another and lie in two parallel planes, each tilted at angle θ₁ with respect to the y axis and at angle θ₂ with respect to the x axis. Array 729 thus includes or consists essentially of two parallel, tilted layers or ranks of N IPV pipeline sections each. Piping or U-connectors may connect IPVs in the upper rank to pipes in the lower layer (e.g., each IPV in the upper rank may be connected to the IPV directly below it, or to some other IPV in the lower rank). Such piping may be arranged to allow for the delivery to or extraction from the array 729 of gas, liquid, or two-phase mixtures of gas and liquid. Such piping may be arranged in a wide variety of configurations to allow the passive drainage of liquid from IPVs in the upper rank to IPVs in the lower rank, or, in general, from any portion of any IPV where liquid may accumulate to any portion of any other IPV if that portion of the latter IPV is at lower elevation than the liquid accumulation in the former IPV. The angles θ₁ and θ₂ may be selected, in combination with optional manifolds and piping, to provide acceptable gravity-assisted flow, pooling, and collection through manifolds of liquid or other flowing fluid (e.g., foam) within array 729 without interfering with access to the gaseous contents of array 729 (e.g., by liquid blockage of openings intended for the passage of gas or two-phase mixtures). Preferably, manifolds and piping of the array 729 are arranged so that gas and liquid (and/or two-phase mixtures of gas and liquid) may be delivered to or removed from the array 729 from a closely clustered set of surface access points (e.g., near the A corner of array 729 or at some point along the AB edge of array 729). FIG. 7D depicts what is in effect a stack of two IPV arrays, each containing N IPV pipeline sections, but similar stacks of M IPV layers, where M is any integer number greater than or equal to 1 and where the M layers may contain varying numbers of IPV pipeline sections, are contemplated and within the scope of the invention.

FIG. 7E is a schematic diagram of components of an illustrative rectangular IPV array 730 including or consisting essentially of 2N similar, parallel pipeline sections (only one IPV pipeline section 724 is explicitly labeled in FIG. 7E). Each IPV section in FIG. 7E is similar to IPV system 600 in FIGS. 6A, 6B, 6C and may include any or all of the arrangements described or depicted for system 600, as well as additional arrangements. The IPV array 730 may also include any or all of the arrangements described or depicted for 700, 723, 729 in FIGS. 7A-7D, as well as additional arrangements. FIG. 7E indicates the level plane ABCD (726) and the orientation of three standard orthogonal axes x, y, and z (728). The N IPV pipeline sections of the lower layer of array 730 are parallel to one another and lie in a common plane that is tilted at angle θ₁ with respect to the y axis and at angle θ₂ with respect to the x axis. The N IPV pipeline sections of the upper layer of array 730 are parallel to one another and lie in a common plane that is tilted at angle θ₃ with respect to the y axis and at angle θ₂ with respect to the x axis. Array 730 thus includes or consists essentially of two layers or ranks of N IPV pipeline sections each. Piping or U-connectors may connect IPVs in the upper rank to pipes in the lower layer (e.g., each IPV in the upper rank may be connected to the IPV directly below it, or to some other IPV in the lower rank). Such piping may be arranged to allow for the separate delivery to, or extraction from, the array 730 of gas, liquid, or two-phase mixtures of gas and liquid. Such piping may be arranged in a wide variety of configurations to allow the passive drainage of liquid from IPVs in the upper rank to IPVs in the lower rank, or, in general, from any portion of any IPV where liquid may accumulate to any portion of any other IPV if that portion of the latter IPV is at lower elevation than the liquid accumulation in the former IPV. For example, connecting each IPV in the upper layer of array 730 to IPV in the lower rank at the CD edge (where the two layers of IPVs approximate), e.g., by a vertically oriented U-connector, would be advantageous because no further connections to the upper layer of IPVs would be necessary in order for gas to be exchanged freely between each IPV of the upper layer and the corresponding IPV of the lower layer, while liquid would flow by gravity from each IPV of the upper layer into the corresponding IPV of the lower layer, to be further directed and collected for removal from the array 730. The angles θ₁, θ₂, and θ₃ may be selected, in combination with optional manifolds and piping, to provide acceptable gravity-assisted flow, pooling, and manifold collection of liquid or other flowing fluid (e.g., foam) within array 730 without interfering with access to the gaseous contents of array 730 (e.g., by liquid blockage of openings intended for the passage of gas or two-phase mixtures). Preferably, manifolds and piping of the array 730 are arranged so that gas and liquid (and/or two-phase mixtures of gas and liquid) may be delivered to or removed from the array 730 from a closely clustered set of surface access points (e.g., near the A corner of array 730). Similar stacks of M IPV layers tipped at various angles, where M is any integer number greater than or equal to 2 and the M layers may contain varying numbers of IPVs, are contemplated and within the scope of the invention.

FIG. 7F is a schematic representation of portions of an illustrative embodiment of the invention. A system 732 includes or consists essentially of a field or series of pipeline segments 724 (only one of which is explicitly labeled in FIG. 7F) connected into a serpentine whole by a series of U-connectors 734 (only one of which is explicitly labeled in FIG. 7F). The pipeline segments 724 and U-connectors 734 are of preferably but not necessarily circular cross-section. Whatever cross-sectional shape is employed in a given embodiment, the pipeline segments 724 and U-connectors 734 are preferably of approximately the same cross-section, both in shape and size. That is, the interior of the system 732 has a continuous cross-section, that is, is approximately continuous in shape and dimensions. The continuous cross-section of system 732 is advantageous in that allows the passage of a “pig” (a device, for e.g., pipe inspection, inserted into a pipeline and traveling freely through it) that is large relative to the cross-section throughout the whole pipe field of system 732, e.g., from an entry point 736 to an exit point 738.

FIG. 7F depicts an illustrative system 732 featuring five pipeline segments 724 and four U-connectors 734, but various embodiments may contain any number of pipeline segments greater than two and any number of U-connectors greater than one. The pipeline segments 724 depicted in FIG. 7F are arranged in an accordion-like manner to minimize IPV total field width while still allowing for the required bend radius of the U connectors 734. In various other embodiments, two or more, or even all, of the pipeline segments may be substantially parallel to each other.

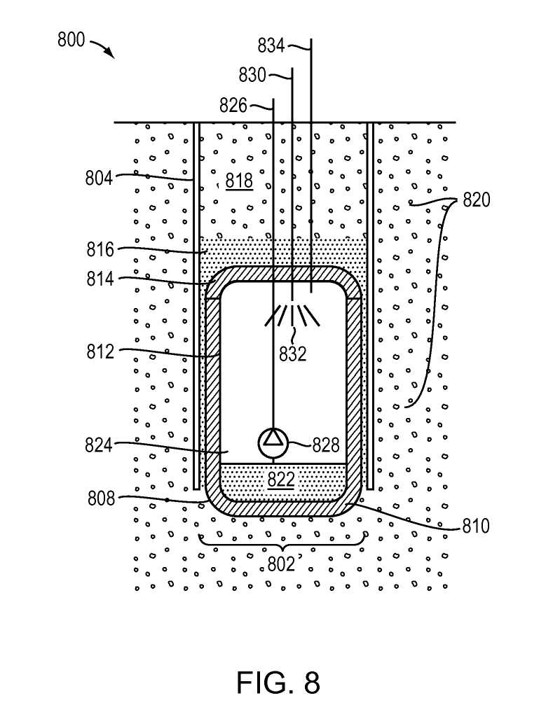

FIG. 8 is a schematic representation of portions of another illustrative embodiment of the invention. A recessed LUR compressed-gas storage system 800 is formed in a vertical, artificial cavern or shaft 802, typically but not necessarily circular in cross-section, and may be part of a larger system (not shown) for the storage and recovery of energy. Compressed air, natural gas, or other fuel or non-fuel liquids or gasses may be stored, either exclusively or in different states of operation, within system 800, as well as within various other LUR systems and IPVs described herein and within various embodiments not explicitly described but within the scope of the invention. As in FIGS. 1A, 1B, 1C, and 1D, one or more LUR systems (e.g., system 800) and/or IPV systems falling within the scope of the invention may be employed at a single site, or in a network of sites connected by piping, in order to store compressed air, natural gas, and/or other fluids simultaneously. Compressed air stored in individual, multiple, or networked storage systems may be utilized as an energy-storage medium by a system, e.g., an adiabatic compressed-air energy storage system or an isothermal compressed-air energy storage system, that employs no additional fuel; alternatively or additionally, compressed air so stored may be utilized in combination with natural gas or other fuels for the production of energy. For illustrative purposes, most of the energy storage and generation systems described and depicted herein are isothermal compressed-air energy systems, and the storage systems described and depicted herein are primarily lined underground reservoirs storing compressed air and heat-exchange liquid; however, this emphasis should not be taken as in any way restricting the contemplated scope of the invention.

In various embodiments, system 800 includes a storage reservoir recessed into a shaft 802 in the earth and containing fluid that may be pressurized and/or thermally conditioned (e.g., heated, cooled, or maintained at an approximately constant temperature). Pressurization of the fluid stored by system 800 enables the storage of elastic potential energy; heating or cooling of the fluid enables the storage of exergy (work available from a system in disequilibrium). Typically, although not necessarily, the fluid is thermally conditioned by heating or by maintenance at an approximately constant temperature rather than by cooling. A fluid may be both pressurized and thermally conditioned. Such pressurization and thermal conditioning may be controlled functions of time. Shaft 802 may be lined with a material that prevents leakage of fluids into or out of the shaft 802; the material may also act as a thermal insulator to assist in thermal conditioning or in mitigating the exchange of heat between the fluid and the surrounding earth. Alternatively or additionally, shaft 802 may be lined with a material that acts primarily as a thermal insulator.

In the illustrative embodiment depicted in FIG. 8, shaft 802 is vertical and circular in cross-section. Shaft 802 is sunk preferably in stable earth material, e.g., solid rock, and may be sunk by a technique and machine for sinking vertical shafts, e.g., as described in U.S. Patent Application Publication No. 2011/0139511, filed Jan. 19, 2011, and/or in U.S. Patent Application Publication No. 2012/0163919, filed Mar. 19, 2012, the entire disclosure of each of which is incorporated herein by reference. In one approach to the excavation of a shaft such as shaft 802 according to embodiments of the present invention, an excavating machine breaks up rock during boring into particles that are removed from the bore hydraulically. In other embodiments of the invention, the rock is removed mechanically (e.g., by scoops). Herein, the term “rock” signifies all earth material suitable for excavation for and fabrication of a pressurized underground fluid-storage reservoir.

As the shaft 802 is sunk, a shaft liner 804 (which includes or consists essentially of reinforced concrete and/or some other material) forming an interior wall of the shaft 802 may be installed in a series of rings, each ring being added below previous rings as the excavating machine increases the depth of the bore by a suitable amount. The inner and/or outer surface of the shaft liner 804 may be coated with one or more coatings or additional layers of material (not shown in FIG. 8): these additional layers may serve to prevent leakage of fluid into or out of the shaft 802, to preserve the shaft liner 804 from corrosion or degradation, to thermally insulate the shaft 802 from the surrounding earth 806, or more perform two or more of these functions.

In general, a lined underground reservoir constructed within a shaft 802 of larger depth and/or radius will be capable of storing more fluid and more thermal and elastic potential energy than a shaft 802 of relatively small depth and/or radius.

In various embodiments including the illustrative embodiment depicted in FIG. 8, a cavity liner 808 is constructed within the shaft 802 lined by the shaft liner 804. In this illustrative embodiment, the cavity liner 808 may include or consist essentially of multiple layers, not all of which are depicted in FIG. 8: one layer is a concrete or reinforced-concrete layer 810, and another layer is an inner lining 812, of an impermeable (e.g., to liquid and/or gas) material such as steel or a plastic. The cavity liner 808 includes a dome portion 814 that is surmounted and strengthened by a concrete or reinforced-concrete cap 816. This cap 816 may extend into the surrounding rock 820 and may serve as or separately consist of a plug to distribute upward pressure forces from the dome 814, in part or entirely, to the surrounding rock 820 as opposed to the infill 818. Above the concrete cap 816, the shaft 802 is filled to approximately surface level primarily with an infill 818 of one or more materials (e.g., rock particles removed during excavation of the shaft 802, concrete, earth, water). The cavity liner 808 may be coated with one or more coatings or additional layers of material not shown in FIG. 8, interiorly and/or exteriorly, that may serve to seal, protect, or insulate the cavity liner 808. The cavity liner 808 is in sufficient contact with the shaft liner 804 and with the concrete cap 816 in a manner that enables forces originating with pressurized fluids within the cavity liner 808 to be communicated to the surrounding rock 820 and to the infill 818. The strength and weight of the surrounding rock 820 and of the infill 818 bear most of the pressure load of the fluid within the cavity liner 808. Preferably, the mass and/or mechanical strength of the dome 814, cap 816, and infill 818 are collectively capable of bearing all pressure loads exerted by the fluid contents of the system 800, with a sufficient margin of safety beyond whatever plausible pressure to which the contents of system 800 may be intentionally or accidentally raised. Also, preferably, the mechanical strength of the dome 814, cap 86, and infill 818 are collectively capable of bearing the load of their own weight, and of any vehicles, floodwaters, or other surface loads that might be plausibly superadded above the shaft 802, when the fluid contents of the system 800 are at relatively low pressure (e.g., ambient atmospheric pressure). In short, the liner 808 is generally supported in such a manner that it neither swells unacceptably or bursts when filled with high-pressure fluid, nor sags unacceptably or collapses when filled with atmospheric-pressure fluid. An “acceptable” degree of swelling or sagging of liner 808, with accompanying displacement of surrounding rock 820, infill 818, and other materials or components of system 800, is any degree of swelling or sagging that does not cause breakage or degradation of the materials or components of system 800 (e.g., liner 808, inner liner 812, piping 826, 830, 834).

The cavity liner 808 (including its dome 814), the load-bearing cap 816, the infill 818, the shaft liner 804, and the surrounding rock 820 constitute a sealed recessed storage reservoir. The reservoir may include other components and materials in various other embodiments (e.g., an insulating layer within or around the cavity liner 808).

In various other embodiments, the invert (floor) and sides of the cavity liner 808 may be in direct contact with the surrounding rock 820; the dome 814 may not be a distinct structure from the concrete cap 816; and/or a system of piping may surround the cavity liner 808 in a manner that tends to drain water away from the cavity liner 808. Water so diverted from the cavity liner 808 may be conducted away through piping not depicted in FIG. 8. In embodiments where the system 800 is constructed by excavation through relatively small, primarily non-vertical access tunnels, rather than through vertical shaft excavation, the dome 814 may be in direct contact with the surrounding rock 820, infill 818 may be absent, and plugs (or “pressure barriers”) of concrete or other material may prevent loss of fluid from the recessed reservoir through the tunnels built to enable excavation of the reservoir.

In the illustrative embodiment depicted in FIG. 8, the recessed reservoir 800 contains an accumulation of a non-gaseous fluid (e.g., foam or liquid) 822 and of gas 824. The gas 824 occupies the portion of reservoir 800 not occupied by the non-gaseous fluid 822. The fluid contents of reservoir 800 may be at high pressure (e.g., 3,000 psig) and relatively high temperature (e.g., 60° C.).

Piping 826 passes from the surface, through the infill 818 (as shown in FIG. 8) or through the native rock 820 (in various other embodiments), through the dome portion 814 of liner 808 (or, in various other embodiments, some portion of the shaft liner 804 and/or through the side or invert of liner 808) and reaches to near the bottom of the shaft 802. A pump 828 is capable of drawing fluid 822 into piping 826 and expelling the fluid 822 from the shaft 802. The piping 826 may be enclosed by a conduit of sufficient width to enable the insertion and removal of the pump 828 from within the liner 808. Power, control, and data cables (not shown in FIG. 8) may also enter shaft 802 through piping 826 or through some other conduit, enabling the control and operation of pump 828 and communication with sensors (not shown) inside shaft 802 and/or vessel lining 808 that provide information to operators of reservoir 800 and/or to an automatic control system on various physical variables, e.g., pressure and temperature of the fluid contents of cavity liner 808, forces acting on the liner 808 or rock 820, depth of fluid 822, and the like.

Fluid expelled from shaft 802 by pump 828 may be directed via piping 826 to reservoirs, cylinders, or other components of an energy storage and recovery system (not shown). Fluid may be directed via piping 830 to a spray head or nozzle (not explicitly shown), or array of spray heads and/or nozzles, for the generation of a foam or droplet spray 832 within the gas-filled portion of liner 808. The foam or droplet spray 832 may exchange heat with the fluids inside liner 808. In various embodiments, fluid exiting the interior of the liner 808 through piping 826 is passed through pumps, valves, heat exchangers, and other devices (not shown) before being returned to the interior of liner 808 through piping 830. Additional piping 834 allows the addition to or removal from the interior of liner 808 of fluid (e.g., gas).

In another embodiment, not shown, multiple fluid liners 808 may be situated in a single shaft 802. The fluid liners 808 may be stacked one atop another, or arranged in a vertically-oriented bundle of tube-like liners, or otherwise arranged in order to enable convenient construction, spatially even distribution of forces, and/or other advantages. In some cases, multiple narrower-diameter fluid liners (e.g., capped pipes, such as one or more IPVs) may be less expensive than a single liner 808 of comparable capacity endowed with a single large, welded inner liner 812.

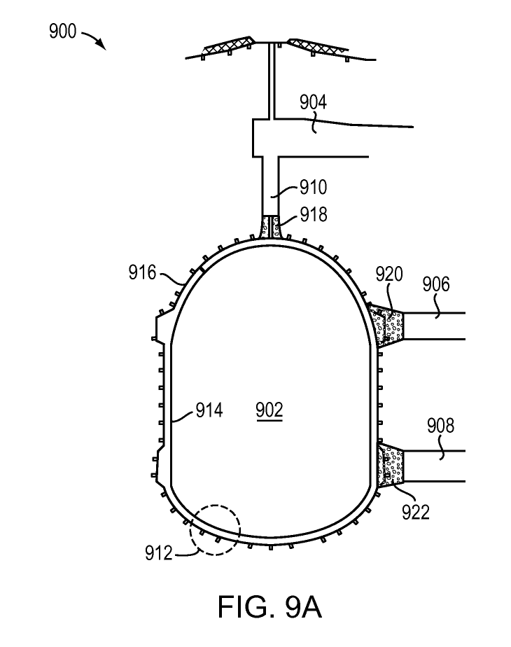

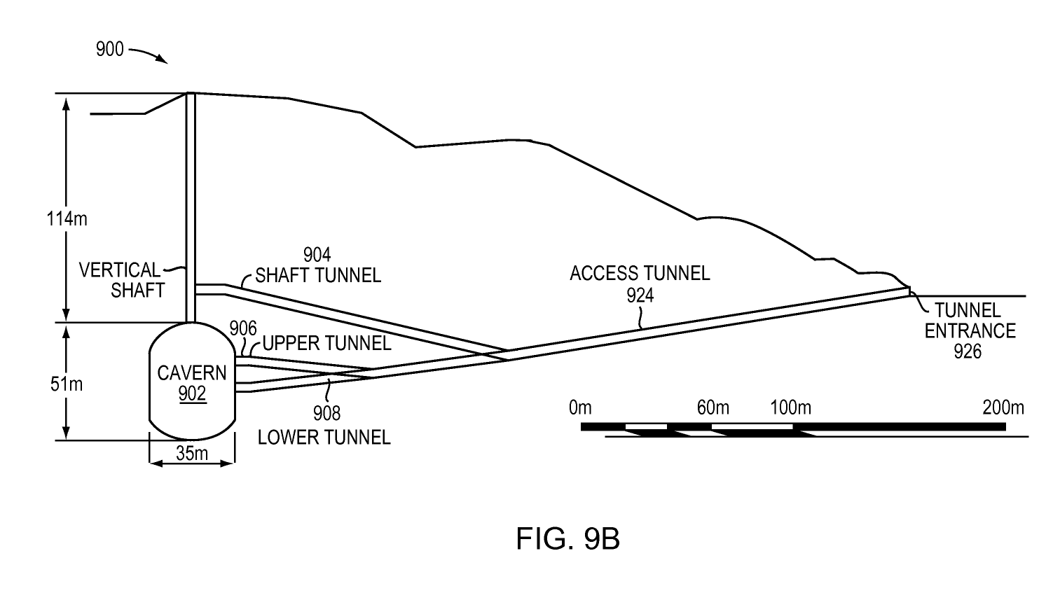

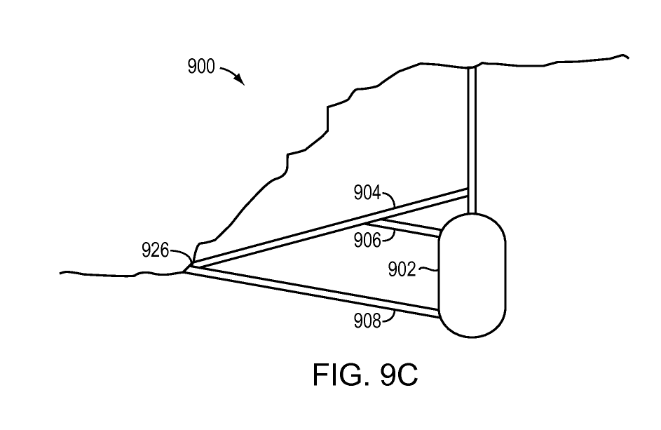

FIG. 9A is a schematic diagram of portions of another illustrative embodiment of the invention. A recessed LUR compressed-gas storage system 900 includes a cavity 902 surrounded by suitable (e.g., solid-rock) earth material. The materials that may be stored in the system 900, and the uses to which those materials may be put, include those described for system 800 in FIG. 8. The cavity 902 is typically but not necessarily circular in cross-section, and may be part of a larger system (not shown) for the storage and recovery of energy.

Although the storage capacity and functions of system 900 may be similar to those of system 800 in FIG. 8, the method of construction of system 900 differs. Rather than excavating a vertical shaft, as for system 800, sloping access tunnels 904, 906, 908 (only partly shown in FIG. 9A) are excavated to the location of cavity 902 from points on the surface that may be many meters away from a point on the surface directly above cavity 902. Exemplary arrangements of the access tunnels 904, 906, 908 are shown more fully in FIGS. 9B and 9C, FIG. 10, and FIG. 25. The tunnels 904, 906, 908 may be constructed by ordinary techniques for solid-rock excavation, i.e., drill, blast, and clear, and are of sufficient size to allow passage for excavating machines, workers, and rock debris. Excavation of the tunnels 904, 906, 908 begins at one or more surface points (not shown in FIG. 9A); when the tunnels 904, 906, 908 have reached the intended location of cavity 902, the cavity 902 is excavated. A vertical shaft 910 is also produced, leading from a surface point directly above cavity 902 to the cavity 902. The shaft 910 may be narrow relative to (i.e., have a cross-sectional area smaller than that of) the cavity 902 and produced by means of a conventional drill.

Once cavity 902 has been excavated, it is lined with a cavity liner 912. In this illustrative embodiment, the cavity liner 912 may include or consist essentially of multiple layers, not all of which are depicted in FIG. 9A: one layer is a concrete or reinforced-concrete layer 916 and another layer is an inner liner 914 of an impermeable material such as steel or a plastic. Moreover, after the construction of the cavity liner 912, the access tunnels 906, 908 which open upon the cavity 902, and the drilling 910, are sealed by plugs 918, 920, 922. The plugs may include or consist essentially of concrete or reinforced concrete and may be perforated in a manner that allows pipes, wires, and conduits (not shown) to pass into the interior of the cavity 902. In particular, the system 900 may be equipped with piping and other contrivances (not shown in FIG. 9A) similar to the piping 826, 830, 834, pump 828, and spray mechanisms shown and/or described for system 800.

System 800 and similar embodiments may have advantages over system 900 and similar embodiments. In particular, the access tunnels 904, 906, 908 and cavity 902 are, in general, excavated by workers working in situ, underground, and the lining 912 of the cavity 902 is typically excavated by workers working with in the cavity 902. Such work may be slow, expensive, and relatively dangerous. In contrast, the wide vertical shaft 802 of system 800 may be excavated, in some instances, mostly or entirely by a machine operated from the surface, and the cavity liner 808, with its inside liner 812, may be partly or entirely constructed at the surface and lowered into the shaft 802. Greater speed, lower cost, and higher safety for comparable capacity may thus, in some instances, be achieved in the construction of system 800. Additionally, system 800 does not need additional access areas and underground tunnel for access as may be required for system 900.

FIG. 9B is a schematic diagram of the illustrative system 900 of FIG. 9A shown in a larger geographical context. Four construction tunnels are shown in FIG. 9B, i.e., shaft tunnel 904, upper tunnel 906, lower tunnel 908, and access tunnel 924. The need to move construction machinery through the tunnels places a practical limit on the steepness of all tunnels (e.g., 8 degrees of slope). This steepness limit, in combination with an assumption of linear tunneling and with the topography of the landscape above and near the cavity 902, typically constrains how closely the surface entrance 926 to the access tunnel 924 may be to the site of the cavity 902. In the relatively flat illustrative geographical conditions sketched in FIG. 9B, the top of the cavity 902 is approximately 114 meters vertically below the surface, the cavity is approximately 51 meters high and has a diameter of approximately 35 meters, and the tunnel entrance 926 is approximately 600 meters away from the cavity 902.

In various embodiments it may be advantageous to locate the access tunnel entrance 926 at a point closer a point on the surface directly above the cavity 902. FIG. 9C is a schematic diagram of the illustrative system 900 of FIG. 9A shown in a larger geographical context that is alternative to the geographical context shown in FIG. 9B. In the context of FIG. 9C, the surface declines relatively steeply from a point on the surface directly above the cavity 902. Under these circumstances, a lower tunnel 908, upper tunnel 906, and shaft tunnel 904 may be cut from a tunnel entrance 926 that is closer to the cavity 902 than the tunnel entrance 926 in FIG. 9B. Construction of the system 900 may be less expensive in a geological context resembling that of FIG. 9C than in a geological context resembling that of FIG. 9B because fewer meters of tunnel are cut in order to construct a cavity 902 of comparable storage capacity. However, acquisition of legal rights to access the site of tunnel entrance 926, or to construction tunnels under the land between the tunnel entrance 926 and a point on the surface directly above the cavity 902, may still be expensive. It may therefore be advantageous to locate the tunnel entrance 926 at a point directly above, or near to directly above, the cavity 902.

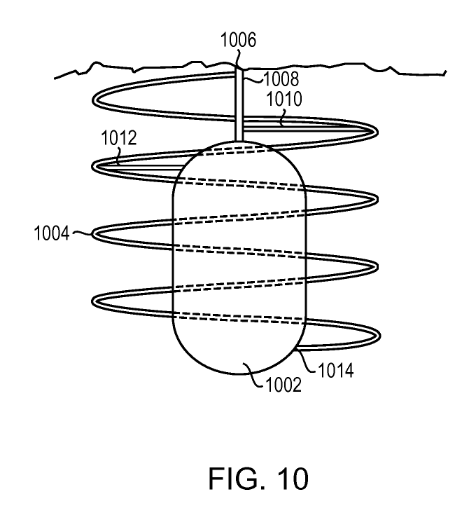

FIG. 10 is a schematic diagram of an illustrative LUR system 1000 similar to system 900 of FIG. 9A, 9B, 9C. A cavern 1002 is excavated in substantially solid rock by removal of pulverized rock through access tunnels. A main access tunnel 1004 begins at an access point 1006 that is directly above, or substantially directly above, the cavity 1002, and descends in a spiraling fashion through the rock. The steepness of the main access tunnel 1004 typically never exceeds the working steepness limit for such a tunnel (e.g., 8 degrees) mandated by the need to safely pass machinery and vehicles (e.g., cement trucks). A shaft 1008 is drilled from the point on the surface 1006 to the cavity 1002 to enable access to the cavity 1002 by piping, electrical cables, data cables, and the like, as described above for system 900. Access to the lower portion of the shaft 1008 from the main access tunnel is obtained by excavating a first approximately horizontal tunnel 1010; access to the upper portion of the cavity 1002 is obtained by excavating a second approximately horizontal access tunnel 1012; and access to the lower portion of the cavity 1002 is obtained by directing the lower portion of the spiraling main access tunnel 1004 to a point of contact 1014 with the cavity 1002. The construction of a spiraling main access tunnel may reduce difficulties associated with accessing land rights to linear access tunnels potentially located a distance away from the overhead access and surface facilities.

The cavity 902 in FIG. 9A, FIG. 9B, and FIG. 9C and cavity 1002 in FIG. 10 may be lined by a variety of methods, including as described above for system 800 and further illustratively described hereinbelow. Also, in various embodiments systems 800, 900, and/or 1000 may include one or more underground chambers or cavities—e.g., a chamber located directly above the main fluid storage cavity (e.g., cavity 902 or 1002) and accessed by the shaft tunnel 904 or first horizontal access tunnel 1010—in addition to the main fluid storage cavity. The one or more additional chambers may contain various components of a system for the storage and retrieval of energy not depicted in FIG. 9A, 9B, 9C, or 10, such as machinery, liquid, and/or pressurized gas. Examples of machinery that may be located within in the one or more additional chambers include systems for control (e.g., computers, control systems as detailed above), pumps, insulated pipeline vessels, and systems for the interconversion of electrical, thermal, and elastic-potential energy in compressed gas and other fluids, and/or for the combustion of fuels (e.g., natural gas). Liquid (e.g., water) located in the one or more additional chambers may constitute a storage reservoir of heat-exchange fluid to be circulated into and out of the main fluid-storage chamber for the purpose of thermally regulating the fluid stored within the main fluid-storage chamber. Alternatively or additionally, liquid located in the one or more additional chambers may constitute one or more lower or upper reservoirs enabling gravitational potential energy to be stored or released by virtue of an altitude difference between the one or more reservoirs and some other location (e.g., the earth's surface or another chamber at greater depth).

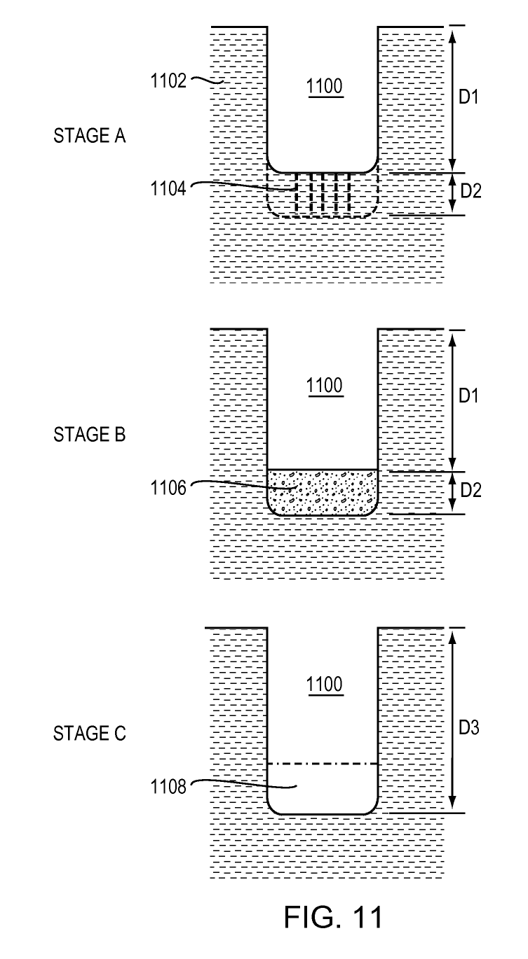

FIG. 11 is a schematic representation of three stages in one method of construction of a vertical shaft 1100, similar to shaft 802 in FIG. 8, sunk into stable earth material 1102 (preferably, solid rock). Within shaft 1100, a recessed storage reservoir such as that depicted in FIG. 8, FIG. 9A, FIG. 9B, FIG. 9C, or FIG. 10, may be constructed. Stage A (upper drawing in FIG. 11) is a stage at which an incipient shaft 1100 of depth D1 is already in progress. Drillings (narrow shafts) 1104 are sunk into the invert of the incipient shaft 1100 to a depth of approximately D2. The number of drillings 1104 shown in FIG. 11 is illustrative only. Explosives (e.g., dynamite) are inserted into the drillings 1104 and detonated, creating a pulverized mass of rock 1106. A single mass of pulverized rock 1106 is shown in Stage B in FIG. 11, but in practice only portions of the invert of shaft 1100 may be pulverized in any given blasting operation. The pulverized rock 1106 is removed (e.g., by buckets or as a slurry), creating a new vacancy 1108 that extends the shaft 1100 deeper into the rock 1102, as shown in Stage C in FIG. 11. As of Stage C, the shaft 1100 has attained a depth of D3=D2+D1. A shaft of any width may be sunk to any depth by these means, subject to the stability of the shaft 1100 thus created. The walls of the shaft 1100 may be segmentally covered (e.g., by rings or panels) and strengthened by a liner (not shown) as the shaft 1100 is incrementally deepened.

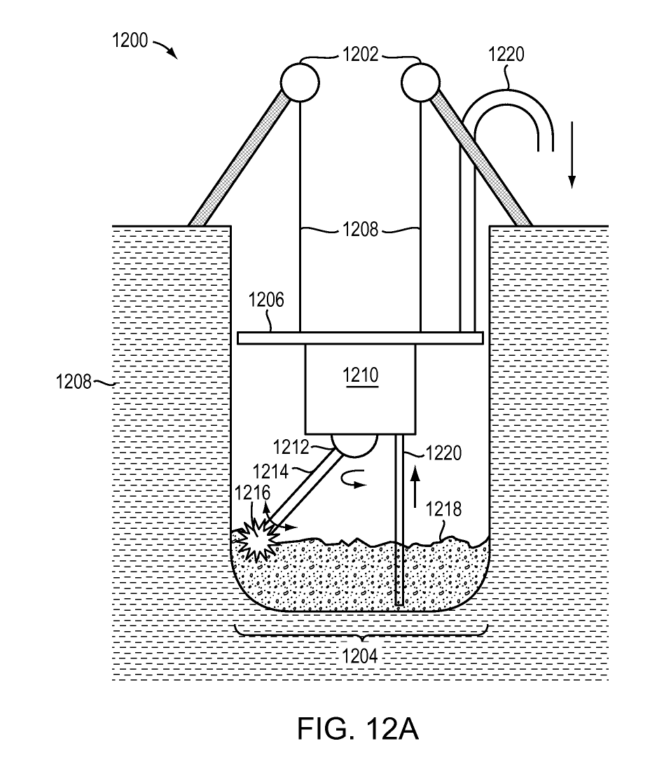

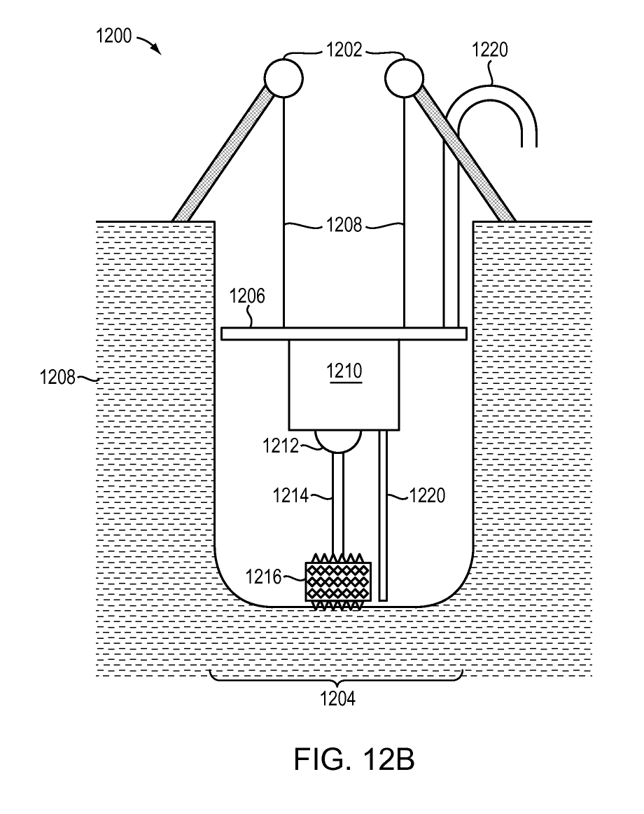

The method of shaft-sinking depicted in FIG. 11 may be time-consuming and expensive, since workers typically descend to the bottom of the shaft 1100 to operate machinery to produce the drillings 1104, insert explosives, and operate machinery that removes the debris 1106. Another method of shaft-sinking is depicted in FIG. 12A and FIG. 12B. This method of shaft-sinking may entail less time-consuming and possibly hazardous descent by workers into the developing shaft.

FIGS. 12A and 12B are schematic diagrams of a shaft-sinking system 1200 utilized in various embodiments of the present invention. Herein, such a system is termed a “roadheader shaft sinking system” or simply “roadheader system.” The system 1200 includes a support rig 1202 erected over the opening of a shaft 1204 (which may have a depth of zero when the process of excavation begins). A platform or stage 1206 descends by weight-bearing cables 1208 from the support rig 1202. The support rig 1202 is capable of raising or lowering the stage 1206 and all components attached thereto, e.g., by means of motor-driven cable drums (not depicted). To the bottom of the stage 1206 is attached a mechanical housing 1210, which typically contains motors, reservoirs of fluid, cameras, and/or other components. Adjustable-length cables and conduits for the conveyance of electrical power, control signals, fluids, and other services to and from the stage 1206 components attached thereto are not shown in FIG. 12A but may extend, like the weight-bearing cables 1208, from the support rig 1202 into the shaft 1204. To the bottom of the housing 1210 is attached a controllable joint 1212 which supports and moves a telescoping boom 1214. The joint 1212 is capable of directing the boom 1214 through the entire hemisphere of action not occluded by the housing 1210 (i.e., a solid angle of approximately 2π steradians). At the end of the telescoping boom 1214 is a rotating cutting head 1216. As used herein, the term “roadheader” includes any drilling system featuring a directable boom surmounted by a cutting head. The stage 1206 and all components attached thereto are herein termed the “roadheader rig.” The roadheader rig is raised and lowered by the support rig 1202.

The joint 1212 is capable of raising, lowering, and rotating the boom 1214; the boom 1214 may extend and retract. By appropriately combining (e.g., under the direction of a human operator, automatic control system, or both) the motions of the stage 1206, joint 1212, and boom 1214, the working surface of the cutting head 1216 may be brought into contact with any point on the walls or invert of the shaft 1204.

Rock fragments broken from the walls and/or invert of the shaft 1204 by the cutting head 1216 typically accumulate as debris 1218 upon the invert of the shaft 1204. Such debris may be removed by a variety of techniques. The illustrative system 1200 introduces water through piping (not shown) that mixes with the debris 1218 to form a slurry. Alternatively, the shaft 1204 may be wholly or partly filled with water during operation of the system 1200. The slurrified debris 1218, whether its water portion is introduced through piping or through filling of the shaft 1204 with water, is pumped through a pipe 1220 to the surface. (Two portions of pipe 1220 are depicted in FIGS. 12A and 12B.)

In FIG. 12B, the system 1200 is shown in a state of operation different from that depicted in FIG. 12A. In FIG. 12B, the debris 1218 is not depicted and the cutting head 1216 has been maneuvered into a position that displays the working face of the cutting head 1216 and is suitable for removing rock from the face of the invert.

It is clear that by lowering the roadheader rig, breaking up rock with the cutting head, and removing debris from the shaft 1204, the shaft 1204 may be sunk to any depth to which the support rig 1202 is capable of lowering the roadheader rig and at which the walls of the shaft 1204 remain stable. The walls of the shaft 1200 may be segmentally covered and strengthened by a liner (not shown) as the shaft 1200 is incrementally deepened. Within shaft 1200, a recessed storage reservoir such as that depicted in FIG. 8, FIG. 9A, FIG. 9B, FIG. 9C, or FIG. 10, may be constructed, constituting a lined underground reservoir.

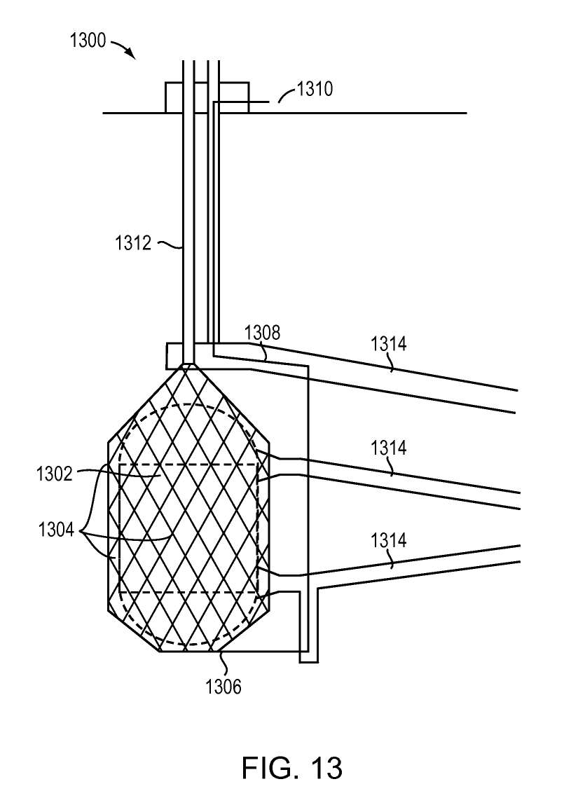

FIG. 13 is a schematic representation of an illustrative lined underground reservoir fluid-storage system 1300 that includes a lined cavity 1302 (dashed lines) similar to cavity 902 in FIG. 9. In general, it is desirable that water be controlled during excavation and construction of the lined cavity 1302. In other instances, it may be useful to reduce water collecting or impinging on the exterior of the lining (not shown) of the cavity 1302. In some instances, water may accelerate the corrosion or cracking of the various component layers of a lining; moreover, if a cold liquid (e.g., liquefied natural gas) is stored in the system 1300, or the gaseous pressure of the contents of the cavity 1302 is lowered rapidly to a sufficient degree without thermal conditioning of the contents, freezing temperatures may occur within and in the vicinity of the cavity 1302, and ice expansion may cause cracking of the lining and other damage. Therefore, system 1300 includes a network of pipes 1304 that surrounds the cavity 1302. The crisscrossing lines superimposed over the cavity 1302 in FIG. 13 are a two-dimensional representation of a three-dimensional network or basket of interconnecting pipes 1304 surrounding the cavity 1302. The pipes are tilted, perforated, and/or interconnected in a manner that permits water to enter the pipes and be drained downward to a collection point 1306. A collection pipe 1308 conducts water from the collection point 1306 to a disposal point 1310 on the surface. A pump or pumps (not shown) impel the water through the collection pipe 1308. Air from the surface is permitted to enter the drainage network 1304 through a shaft 1312 in order to equalize pressure within the drainage network 1304 as water is pumped out through the collection pipe 1308. In various other embodiments, the arrangement of pipes in the drainage network 1304 differs from that schematically represented in FIG. 13; water collected by the drainage network 1304 is directed to more than one collection point 1306; the collection pipe 1308 may be a part of, or located within, the drainage network 1304; and/or the collection pipe 1308 may reach the surface through the same shaft 1312 that admits air to the drainage network 1304 rather than through a separate shaft as depicted in FIG. 13. Also in various other embodiments, fluids for storage in and retrieval from the cavity 1302, fluids for thermal conditioning of the contents of cavity 1302, control cables (not shown), air entering the drainage network 1304, water leaving the drainage network 1304, and other fluids and components of system 1300 may pass through a multiplicity of conduits located within a single shaft 1312 and/or may pass through a multiplicity of shafts (not shown in FIG. 13). This drainage system may be applied to vertically-excavated LURs such as those described with reference to FIG. 8. This drainage network 1304, after initial usage during excavation and construction, may subsequently be repurposed and used to monitor and detect any incidents of gas leakage from the LUR. Especially in storage of potentially hazardous or explosive fluids, the repurposed drainage network 1304 may serve as a useful safety system for detection, collection, and evacuation of gas leakage. For example, the air and/or liquid (e.g., water) within the drainage network 1304 may be monitored (e.g., via a conventional gas monitor) for the presence of and/or elevated levels of the gas contained within the LUR (e.g., natural gas), which may signify leakage from the LUR. In the event of such leakage, the drainage network 1304 may be used as a conduit to remove (e.g., with a pump connected thereto) and potentially recover all or a fraction of the leaking gas from underground, thereby mitigating contamination and/or unsafe conditions.

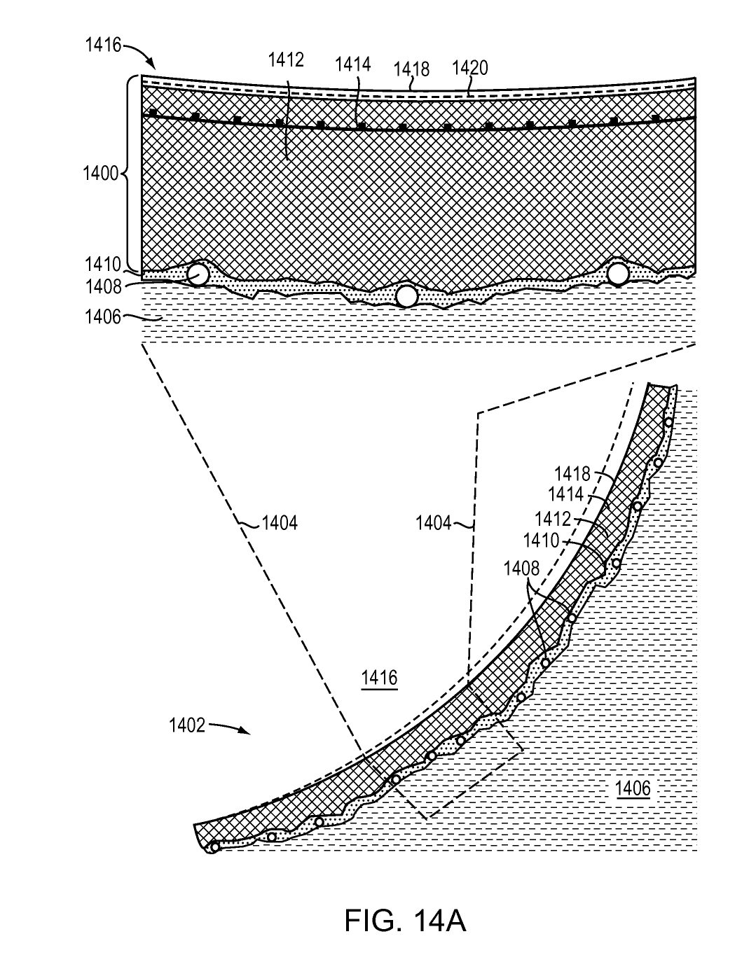

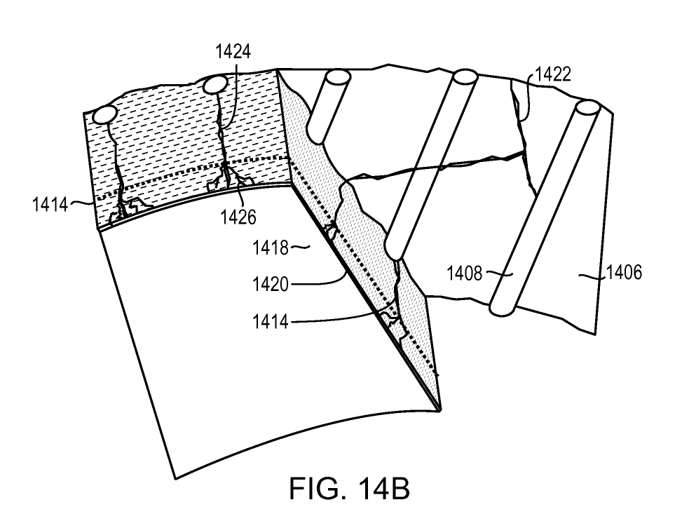

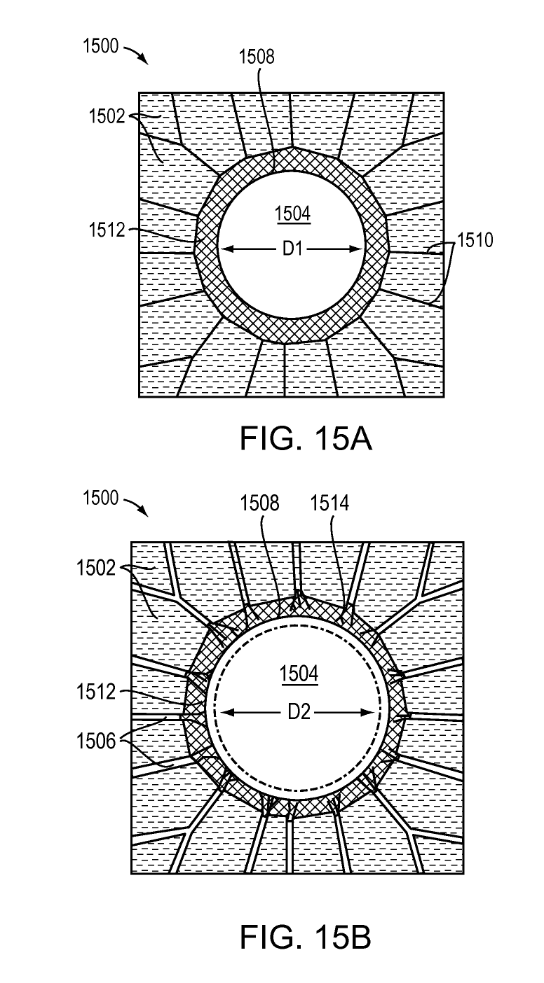

FIG. 14A is a cross-sectional schematic representation of portions of an illustrative lining 1400 of a lined underground reservoir 1402. The lower portion of FIG. 14A shows a portion of the lining 1400 of the lined underground reservoir 1402 in cross-section; the upper portion of FIG. 14A is a magnified and rotated view of a small portion of the lining 1400, as indicated by dashed lines 1404. Raw rock mass 1406 presents a relatively rough surface exposed by excavation. In one method of construction of the lining 1400, a network of water-drainage pipes 1408 similar to that depicted in FIG. 13 is placed against the surface of the rock mass 1406. The drainage pipes 1408 are covered with a layer of shotcrete 1410, i.e., spray-on concrete. The shotcrete 1410 may be porous to allow water to flow through it and into the drainage pipes. The shotcrete 1410 serves both to stabilize the drainage pipes 1408 and to protect them from displacement or damage during pouring and/or injection of the next most inward layer, namely, a concrete layer 1412. The concrete layer 1412 may be self-compacting and may be agitated during or after pouring in order to remove void spaces and promote uniform density. Within the concrete layer 1412 is embedded a metal (e.g., steel reinforcement) mesh 1414, one purpose of which shall be explained below with reference to FIGS. 15A and 15B. The inward surface of the concrete layer 1412 is comparatively smooth, and is shaped to form a cavity 1416. The cavity 1416 is lined with an impermeable liner 1418 (e.g., a liner including or consisting essentially of steel). Between the impermeable liner 1418 and the inward face of the concrete 1412 is a viscous or sliding layer 1420 (e.g., a layer of asphalt, a layer of plastic), herein termed “the viscous layer.” The viscous layer 1420 enables slippage between the impermeable liner 1418 and the concrete layer 1412, mitigating the buildup of forces (e.g., tensile forces) that could cause strain (e.g., stretching) in the material of impermeable liner 1418 and which could thus damage the impermeable liner 1418. The viscous layer 1420 may also serve to mitigate corrosion of the impermeable liner 1418.

FIG. 14B is a schematic cutaway drawing of a portion of the lining 1400 in FIG. 14A. The rock face 1406, drainage pipes 1408, concrete layer 1412, mesh 1414, viscous layer 1420, and impermeable liner 1418 are depicted. The shotcrete layer 1410 is not depicted in FIG. 14B for clarity. Primary (rock-mass) cracks 1422, secondary (concrete) cracks 1424, and tertiary (concrete) cracks 1426 are depicted in FIG. 14B. Rock-mass cracks 1422 tend to propagate outward (i.e., away from cavity 1416, FIG. 14A) from the face of the rock mass 1406. Secondary cracks 1424 tend to propagate inward into the concrete 1414 from the face of the rock mass 1406. Upon reaching the mesh 1414, the secondary cracks 1424 tend to propagate still further inward as smaller, more numerous tertiary cracks 1426. The effect of the mesh 1414 is thus to increase the number of, while decreasing the size of, the cracks that impinge upon the viscous layer 1420 and impermeable layer 1418. This pattern of cracking tends, for a given degree of expansion of the cavity 1416, to decrease the magnitude of forces (e.g., tensile forces) exerted upon various local portions of the impermeable lining 1418. Decreasing the forces (e.g., tensile forces) exerted locally within the impermeable lining 1418 (e.g., during repeated pressurizations of the cavity 1416) tends to preserve the lining 1418 from damage and to increase its longevity.

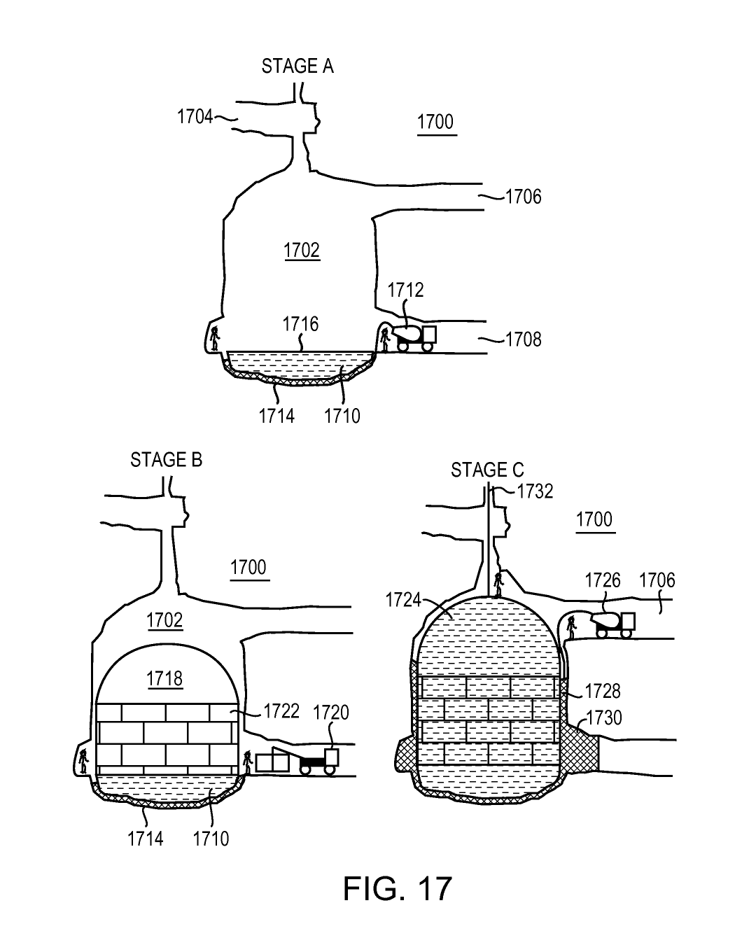

The network of drainage pipes within the lining 1400 may be used to pump water out of the shaft during construction. Various illustrative methods of construction of the lining 1400 are considered further in FIGS. 17-23.

FIGS. 15A and 15B are schematic representations of aspects of the behavior of cracks and other components of a lined underground reservoir 1500 having a lining similar to that portrayed in FIG. 14A and FIG. 14B when the contents of the lined underground reservoir 1500 are raised to a relatively high pressure (e.g., 3,000 psi). In general, a rock mass 1502 surrounding a cavity 1504 is not perfectly rigid. Rather, under the influence of pressure forces exerted by the fluid contents of the cavity 1504, the rock mass 1502 in the vicinity of the cavity 1504 will tend to be displaced outward slightly from its original, pre-pressurization position. As a result of this outward displacement, the rock mass 1502 tends to develop radiating cracks 1506 (primarily by opening existing cracks that are frequent in blocky crystalline bedrock), i.e., cracks that tend to (a) impinge edgewise upon the cavity 1504 (b) be widest at their point of impingement upon the cavity 1504, and (c) narrow as they proceed away from the cavity 1504.

FIG. 15A portrays a first state in which the cavity 1504 has hitherto contained fluid only at relatively low pressure (e.g., atmospheric) and has diameter D1. Lines 1510 in the upper portion of FIG. 15 show existing closed cracks in the rock mass 1502 when the contents of cavity 1504 are sufficiently pressurized. A concrete liner 1512 surrounds the cavity 1504 and is, in the unstressed initial condition portrayed in FIG. 15A, uncracked.

FIG. 15B portrays a second state in which the contents of cavity 1504 have been raised to relatively high pressure (e.g., 3,000 psi) and cavity 1504 has expanded to diameter D2. Cracks 1506 have opened up in the rock mass 1502. The rock-mass cracks 1506 give rise to secondary cracks 1514 that tend to propagate into the concrete layer 1512 from the face of the rock body 1502. In various embodiments where a mesh is embedded in the concrete layer 1512, as in the illustrative embodiment depicted in FIG. 14A and FIG. 14B, the secondary concrete cracks 1514, upon propagating inward to the mesh, will give rise to tertiary concrete cracks as depicted in FIG. 14B, distributing forces (e.g., tensile forces) less unevenly across the surface of the impermeable liner 1508.

The storage of relatively hot (e.g., 60° C. or higher) pressurized fluid within a lined underground reservoir (e.g., cavern 1402 in FIGS. 14A and 14B, or cavern 1500 in FIGS. 15A and 15B) as is contemplated in various embodiments of the present invention, tends to decrease forces (e.g., tensile forces) exerted locally within the impermeable lining (e.g., lining 1508 in FIGS. 15A and 15B) if the impermeable lining 1508 is constructed of a material (e.g., steel) that expands at higher temperatures. That is, as regards forces (e.g., tensile forces) exerted within the impermeable lining 1508, the effects of increasing the pressure of the fluid contents of lined underground reservoir 1500 tend to be counteracted by the effects of increasing the temperature of the fluid contents of lined underground reservoir 1500.

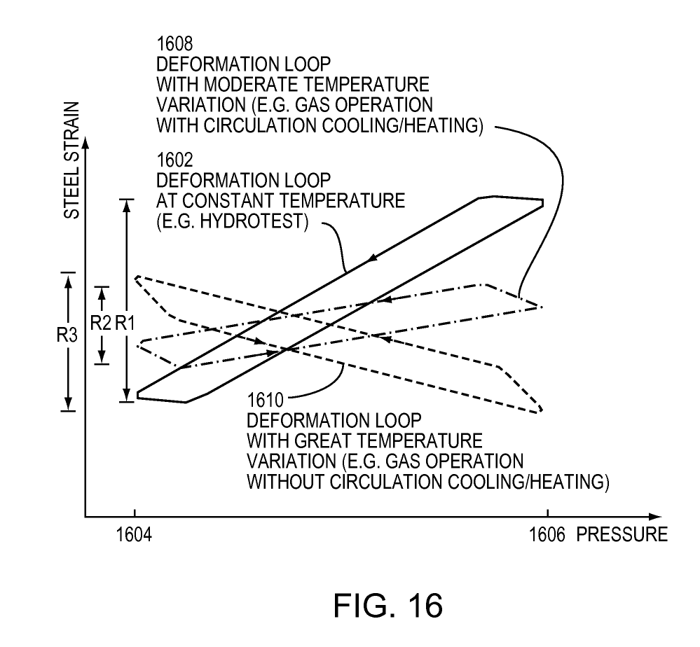

FIG. 16 is a plot of illustrative data showing the relationship between cyclic pressure within a lined underground reservoir (horizontal axis) and the strain or deformation in an illustrative steel liner of the lined underground reservoir (vertical axis), for three hypothetical cycles of temperature of the contents of the lined underground reservoir. In a first hypothetical temperature-pressure cycle 1602, the contents of the reservoir, and thus the lining, which is in contact with the contents, remain at a constant temperature as the pressure within the reservoir is raised from a low pressure 1604 to a high pressure 1606 and then lowered to the low pressure 1604 again. (The relationship between temperature and pressure of the contents is not depicted explicitly in FIG. 16.)

The strain undergone by the steel liner over the first cycle 1602 varies over a range R1. In a second hypothetical temperature-pressure cycle 1608, the contents of the reservoir, and thus the lining in contact with the contents, vary moderately in temperature as the pressure of the contents changes from a low pressure 1604 to a high pressure 1606 and then back to the low pressure 1604 again: i.e., the temperature increases with increasing pressure and decreases with decreasing pressure. The strain undergone by the steel liner over the second cycle 1608 varies over a range R2 that is significantly smaller than the stress range R1 of the first cycle 1602, and the peak strain undergone by the steel liner for cycle 1608 is less than that undergone for cycle 1602.

In a third hypothetical temperature-pressure cycle 1610, the contents of the reservoir, and thus the lining, vary more widely than in cycle 1608 as the pressure within the reservoir is raised from a low pressure 1604 to a high pressure 1606 and then lowered to the low pressure 1604 again: i.e., the temperature increases with increasing pressure and decreases with decreasing pressure. The strain undergone by the steel liner over the second cycle 1608 varies over a range R3 which is smaller than the range R1 and larger than the range R2; moreover, the sense or sign of the relationship between strain and pressure/temperature has been reversed from that of cycle 1602 and cycle 1608, that is, the liner experiences less strain at peak pressure 1606 and temperature than at lowest pressure 1604 and temperature. Different relationships between temperature, pressure, and strain than those shown in FIG. 16 may pertain for various steels, or for materials other than steel, or for multilayered liners. In general, a temperature-pressure-strain relationship that entails the lowest maximum strain on the liner—e.g., cycle 1608 in FIG. 16—is preferable.

Illustrative methods of constructing portions of a lined underground reservoir in various embodiments of the present invention are now considered. FIG. 17 is a schematic cross-sectional representation of three stages (Stage A, Stage B, and Stage C) in the construction of an illustrative lined underground reservoir 1700 similar to reservoir 900 in FIG. 9. Cavern 1700 is constructed by excavating a cavity 1702 primarily by removing rock fragments through access tunnels 1704, 1706, and 1708. In Stage A, a network of drainage pipes (not shown) similar to network 1408 in FIG. 14A has been placed against the interior rock mass and covered with a layer of shotcrete (not shown) similar to layer 1410 in FIG. 14A. In Stage A, a steel invert liner 1710 conforming in shape to the invert of the cavity 1702 has been constructed and is held above the rock face of the invert by spacers (not shown). Trucks (e.g., truck 1712) bring concrete to the worksite through the lower access tunnel 1708 and pour and/or inject concrete 1714 into the space between the invert liner 1700 and the rock face below. In order to prevent the concrete 1714 from deforming or floating the invert liner 1710, water 1716 may be added to the interior of invert liner 1710 through piping (not shown) as the concrete 1714 is poured. At Stage A, the invert liner 1710 is approximately filled with water and the concrete 1714 between the invert liner 1710 and the rock face is almost completely poured.

After the concrete 1714 hardens, firmly undergirding the invert liner 1700, the water 1716 is removed from the invert liner 1710. A steel liner dome 1718 is then constructed atop the invert liner 1710 (Stage B). The dome 1718 may be jacked up or otherwise raised incrementally as sections of wall-lining material 1720 are assembled (e.g., by welding) into rings 1722 beneath the dome 1718. In this manner, the steel liner dome 1718 is raised until it is close to the domed ceiling of the cavity 1702, at which point an approximately cylindrical set of rings 1722 has been fabricated thereunder.

At Stage C, a complete inner steel liner 1724 has been constructed within the cavity 1702. Trucks (e.g., truck 1726) bring concrete to the worksite through the middle access tunnel 1706 and pour and/or inject additional concrete 1728 into the space between the liner 1724 and the surrounding rock face. Some of the concrete 1728 forms a plug 1730 in the lower access tunnel. Water within the liner 1724 prevents the liner 1724 from being deformed by the weight of the concrete 1728.

After Stage C, in phases of construction not depicted in FIG. 17, concrete may be added through a top shaft 1732 to fill the space between the water-filled liner 1724 and the rock face at and above the level of the middle access tunnel 1706. Middle access tunnel 1706 is plugged with concrete during the addition of the concrete, and finally the top shaft 1732 is plugged with concrete. Other phases of construction, including the addition of pumps, piping, sensors, power cables, and other components, are not portrayed in FIG. 17 or discussed herein but are contemplated.

When the lined underground reservoir 1700 has been completed, the water within the liner 1724 may be used to pressure-test the liner 1724. After completed testing, the water is removed by injection of the stored product, e.g., compressed air. This procedure ensures the stability of the storage, as there is always an internal overpressure from the water and/or the stored product.

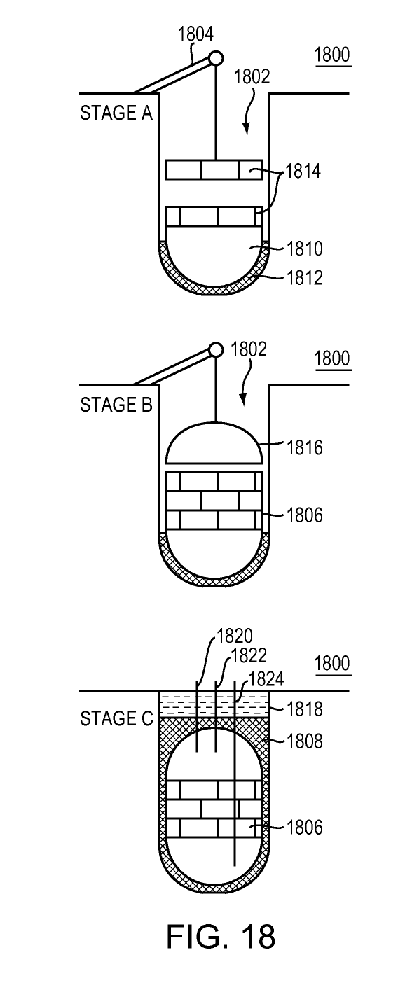

FIG. 18 is a schematic cross-sectional representation of three stages (Stage A, Stage B, and Stage C) in the construction of an illustrative lined underground reservoir 1800 similar to reservoir 800 in FIG. 8. Cavern 1800 is constructed partly by excavating an open shaft 1802 in suitable rock; a lined reservoir is produced in the shaft 1802 primarily by assembling portions of an impermeable (e.g., including or consisting essentially of steel) liner at or near the surface of the earth and lowering them down the shaft by means of a support rig 1804 and then surrounding the resulting liner 1806 with concrete 1808 (Stage C) and other materials. In Stage A, an invert liner 1810 has already been placed at the bottom of the shaft 1802. The invert liner 1810 may be undergirded by concrete 1812 by means similar to those depicted for undergirding of the invert liner 1710 in FIG. 17; alternatively, the undergirding concrete 1812 may be formed in situ, prior to the emplacement of the invert liner 1710, which may be lowered into the undergirding concrete 1812. In either case, after emplacement of the invert liner 1710, the cylindrical or wall-lining portion of the liner 1806 is constructed by constructing or staging rings, panels, or other segmental portions 1814 of the liner 1806 at or near the surface and then lowering them down the shaft 1802 by means of support rig 1804. The segments 1814 may be joined together (e.g., welded together) in situ upon being lowered into the shaft 1802. A network of drainage pipes (not shown in FIG. 18) and other lining layers similar to those depicted in FIG. 14A and FIG. 14B may be emplaced simultaneously with the segmental portions 1814 of the liner 1806.

In Stage B, the wall-lining portions of the liner 1806 have all been emplaced, and a dome liner 1816 is being lowered into the shaft 1802. Following emplacement of the dome liner 1816, a concrete liner or surround 1808 may be poured and/or injected into the space between the liner 1806 and the surrounding rock, as depicted in FIG. 17. This surround 1808 may additionally include a plug (not shown) that may extend into the surrounding rock and may serve as or separately consist of a plug to distribute upward pressure forces from the dome 1816, in part or entirely, to the surrounding rock as opposed to the overfill 1818.

In Stage C, the concrete liner 1808 has been emplaced, overfill 1818 (e.g., crushed rock; concrete; reinforced concrete) has been emplaced, and at least three conduits or pipes 1820, 1822, and 1824 have been emplaced to enable fluid communication (and, in various embodiments, electrical, informatic, and mechanical communication) between the interior of the lined underground reservoir 1800 and facilities (not shown) on the surface. Gas may be injected into or removed from the reservoir 1800 through pipe 1820, heat-exchange fluid (e.g., liquid, foam; not shown in FIG. 18) may be injected into the reservoir 1800 through pipe 1822 in order to thermal condition the contents of the reservoir 1800, and heat-exchange fluid may be removed from the reservoir 1800 through pipe 1824.

The method of construction depicted in FIG. 18 typically requires that most assembly (e.g., joining of segmental portions 1814 to the liner) 1806 is done by workers in situ, deep within the shaft 1802. It is in general desirable that as little work as possible be performed at depth, in order to increase worker safety and to decrease costs.

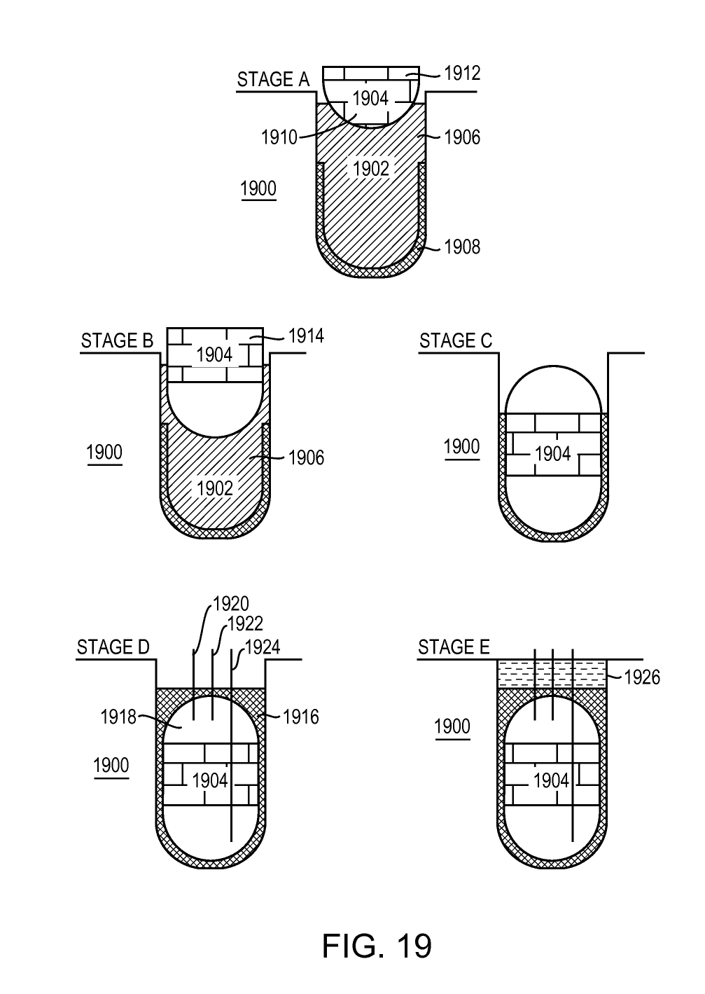

FIG. 19 is a schematic cross-sectional representation of five stages (Stage A, Stage B, Stage C, Stage D, and Stage E) in the construction of an illustrative lined underground reservoir 1900 similar to reservoir 800 in FIG. 8. Cavern 1900 is constructed partly by excavating an open shaft 1902 in suitable rock; a lined cavity may be produced in the shaft 1902 primarily by assembling portions of an impermeable (e.g., steel) liner 1904 at or near the surface of the earth and floating the liner 1904 upon a body of water 1904 (or other liquid) that may be raised or lowered by the addition or removal of water. The method of construction depicted in FIG. 19 typically requires the performance of less construction work within the open shaft 1902 than does the method of construction depicted in FIG. 18. In Stage A, a partial concrete lining with drainage system 1908 has been constructed within the shaft 1902 and a body of water 1906 mostly fills the shaft 1902. An invert liner 1910 and a segmental portion 1912 of the liner 1904 have been assembled proximate the surface and are floating upon the body of water 1906. As utilized herein, “proximate the surface” is defined as at or near the surface (i.e., within reach of a worker or work crew at the surface or on work surfaces (e.g., scaffolding) near the surface).

In Stage B, further segmental portions 1914 have been joined to the liner 1904. The depth of the body of water 1906 has been lowered in order to keep the level at which further segmental portions 1914 are added to the liner 1904 at or near the surface.

In Stage C, the liner 1904 has been completed and rests in the prefabricated undergirding concrete liner 1908.

In Stage D, additional concrete 1916 has been added to cover, protect, and strengthen a dome liner 1918, and at least three conduits or pipes 1920, 1922, and 1924 have been emplaced to enable fluid communication (and, in various embodiments, electrical, informatic, and mechanical communication) between the lined underground reservoir 1900 and facilities (not shown) on the surface. Gas may be injected into or removed from the reservoir 1900 through pipe 1920, heat-exchange fluid (e.g., liquid, foam; not shown in FIG. 19) may be injected into the reservoir 1900 through pipe 1922 in order to thermal condition the contents of the reservoir 1900, and heat-exchange fluid may be removed from the reservoir 1900 through pipe 1924. The additional concrete 1916 may additionally include a plug (not shown) that may extend into the surrounding rock and may serve as or separately consist of a plug to distribute upward pressure forces from the dome 1918, in part or entirely, to the surrounding rock as opposed to the overfill 1926.

In Stage E, overfill 1926 (e.g., crushed rock; concrete; reinforced concrete) has been added above the concrete 1916. The weight and/or mechanical strength of the overfill 1916 serve to restrain expansion of the lined underground reservoir 1900 when the reservoir 1900 is filled with fluid at high pressure.

The method of construction partly depicted in FIG. 19 dispenses with the support rig 1804 in FIG. 18 and allows a greater amount of construction work to be performed at or near the surface of the earth. In various other embodiments, a method of construction similar to that depicted in FIG. 19 is employed, but no prefabricated concrete undergirding 1908 is constructed. Rather, the liner 1904 is lowered into place as it is constructed, coming to rest upon spacers (e.g., beams, ribs, struts) that hold the liner a desired distance away from the surrounding rock face at all points. Concrete is then poured and/or injected into the space between the liner 1904 and the surrounding rock face, approximately as described for the emplacement of the concrete liner 1728 in FIG. 17, producing a result similar to Stage C in FIG. 18. Construction may then proceed as described for the method of construction partly depicted in FIG. 18.

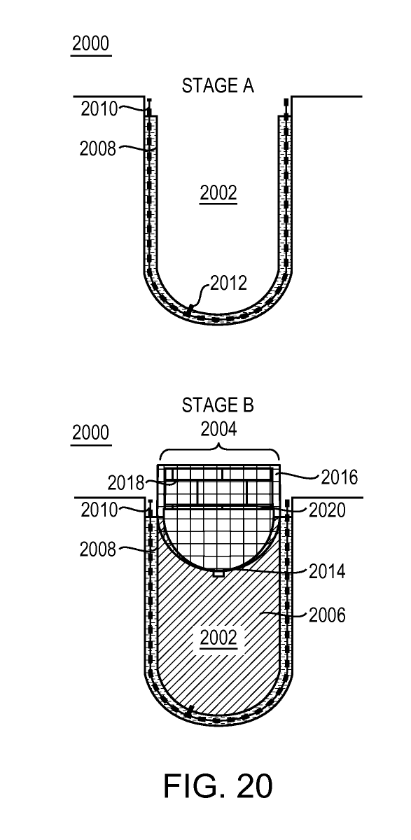

FIG. 20 is a cross-sectional schematic representation of two stages (Stage A and Stage B) of the first stages of construction of an illustrative lined underground reservoir 2000 similar to reservoir 800 in FIG. 8, in accordance with various embodiments of the present invention. Cavern 2000 is constructed partly by excavating an open shaft 2002 in suitable rock. Similar to FIG. 19, a lined cavity is produced in the shaft 2002 primarily by assembling portions of an impermeable (e.g., including or consisting essentially of steel) liner 2004 (see Stage B, FIG. 20) at or near the surface of the earth and floating the liner 2004 upon a body of water 2006 (see Stage B, FIG. 20) that may be raised or lowered by the addition or removal of water. In Stage A, a drainage layer 2008 has been constructed within the shaft 2002. The drainage layer 2008 includes a network of pipes 2010 similar to the network of pipes 1408 depicted in FIG. 14A and FIG. 14B. The pipe network 2010 is covered with a layer of shotcrete to stabilize and protect the pipe network 2010. One or more openings 2012 allow water to flow from the interior of the shaft 2002 into the pipe network 2010, or from the pipe network 2010 into the interior of the shaft 2002. One or more pipes and pumps (not shown) allow water to be pumped from and to the drainage network 2010. Openings 2012 may be closed (e.g., filled with concrete) or left open after or during Stage B.

In Stage B, a body of water 2006 mostly fills the shaft 2002. An invert liner (e.g., dome shaped liner) 2020 and a segmental portion 2018 of the liner 2004 have been assembled at or near the surface and are floating upon the body of water 2006. One or more spacers 2014 (e.g., beams, ribs, struts) that can hold the liner 2004 a desired distance away from the surrounding rock face at all points are attached to the outside of the liner 2004. Also, a network or basket of rebar 2016 has been constructed around and attached to the portion of the liner 2004 constructed as of Stage B. As further segmental portions of steel liner 2018 and rebar network 2016 of the liner 2004 are added to the liner 2004, water may be removed from the shaft 2002 through the pipe network 2010, lowering the level of the body of water 2006 and thus permitting the joining of further segmental portions 2018 and portions of network 2016 to the liner 2004 to proceed at or near the surface of the earth. When the liner 2004 is completed, it may be lowered to the bottom of the shaft 2002 by the removal of all water from the shaft 2002. Concrete is then poured and/or injected into the space between the liner 2004 and the surrounding rock face, approximately as described for the emplacement of the concrete liner 1728 in FIG. 17, producing a result similar to Stage C in FIG. 18. This concrete may also fill any openings 2012. Construction may then proceed as described for the method of construction partly depicted in FIG. 18. In other embodiments, water (or other liquid) is not utilized, and the weight of the liner is supported in part or entirely by other means, such as via hydraulic jack or crane. In yet other embodiments, at least a portion of the liner 2004 is assembled directly on the drainage layer 2008 after lower portion(s) of the liner 2004 (if any) have been assembled and/or lowered down to the bottom of the shaft 2002.

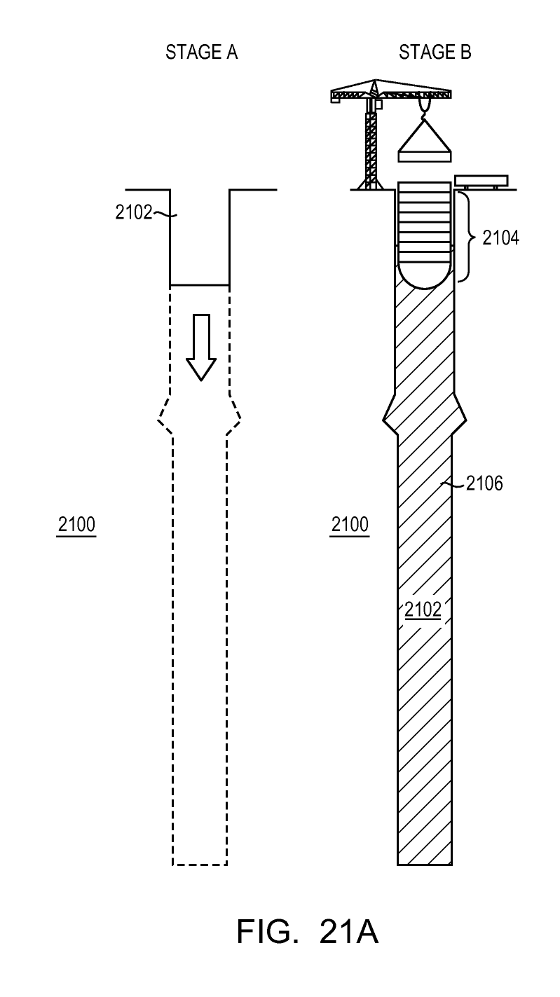

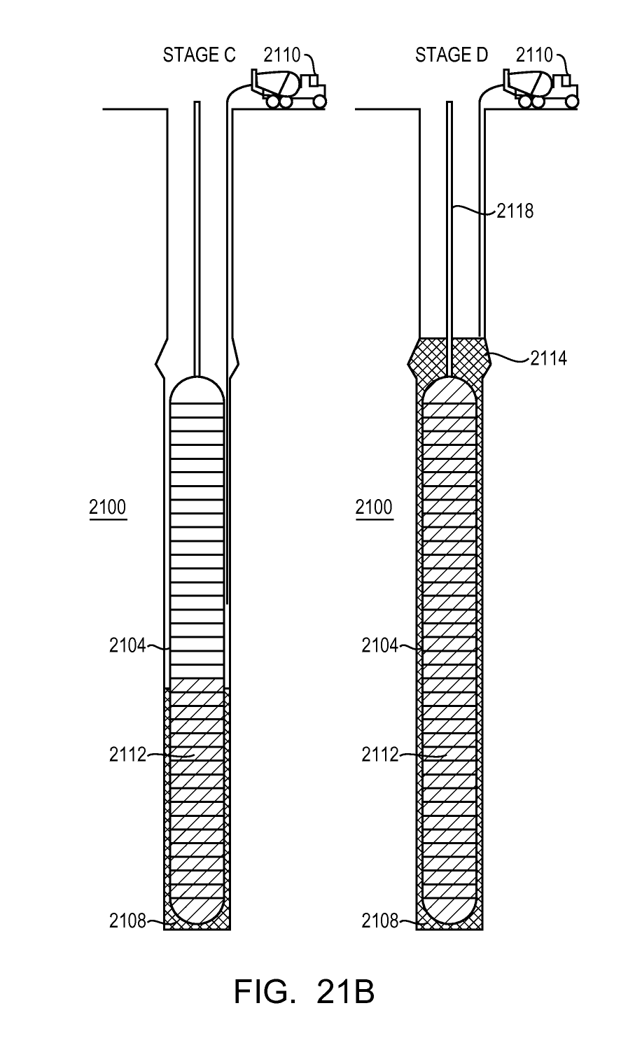

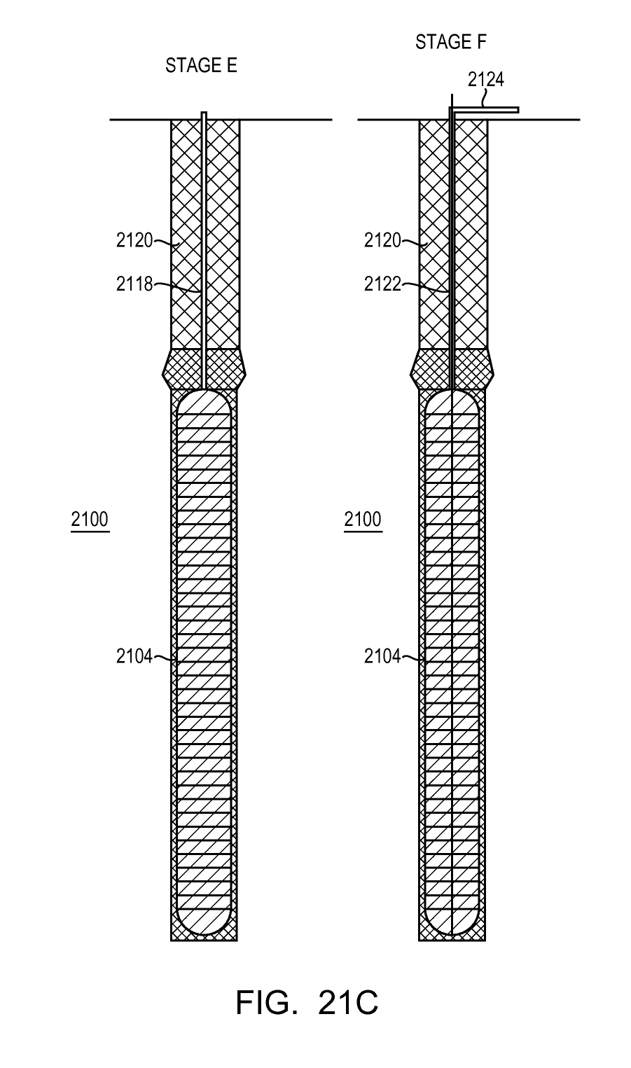

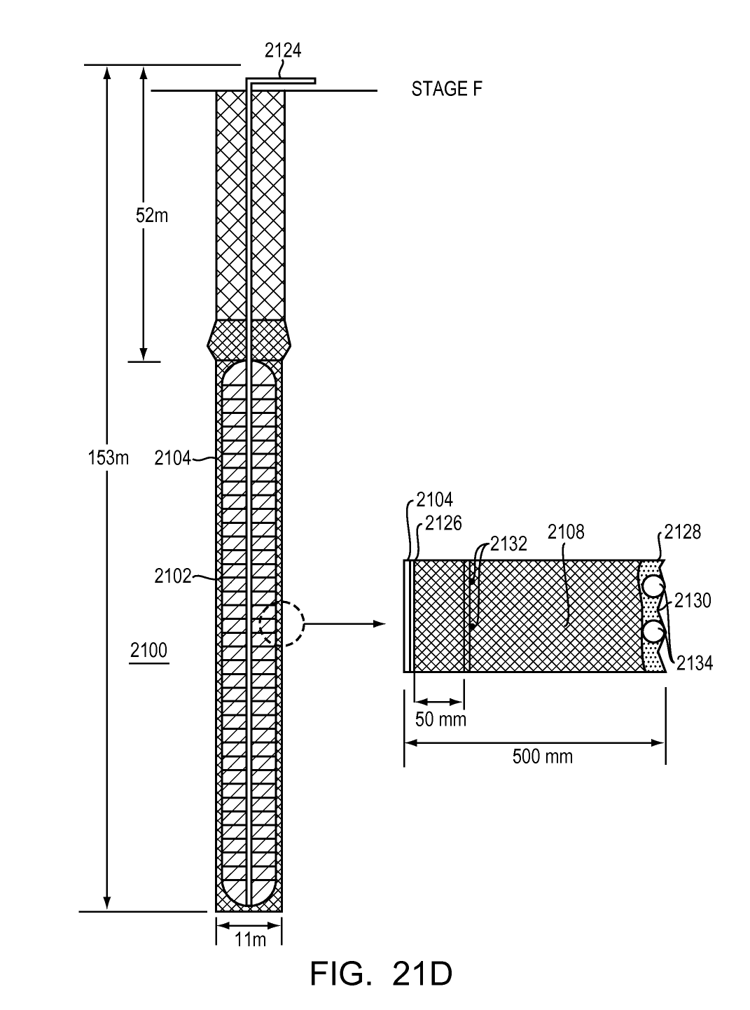

FIG. 21A is a cross-sectional schematic representation in two stages (Stage A and Stage B) of yet another exemplary method of construction of an illustrative lined underground reservoir 2000 similar to reservoir 800 in FIG. 8. Cavern 2100 is constructed partly by excavating an open shaft 2102 in suitable rock; a lined cavity is produced in the shaft 2102 primarily by assembling segments of an impermeable (e.g., including or consisting essentially of steel) liner 2104 (see Stage B, FIG. 20) proximate (at or near) the surface of the earth and floating the liner 2104 upon a body of water 2106 (see Stage B, FIG. 21A) that may be raised or lowered by the addition or removal of water as the liner 2004 grows. In Stage A, the shaft 2102 is partially sunk. In Stage B, the liner 2104 has been partially constructed in a segmented manner and is being lowered into the shaft 2102 by removal of water from the shaft 2102.

FIG. 21B is a cross-sectional schematic representation of two further stages (Stage C and Stage D) of the method of construction of the illustrative lined underground reservoir 2100 represented in FIG. 21A. In Stage C, the steel liner 2104 has been completely constructed and lowered to near the bottom of the shaft 2012. Spacers (not shown) preserve a desired amount of space between the liner 2104 and the surrounding rock face. In Stage C, concrete 2108 from a surface source 2110 is being poured and/or injected into the space between the liner 2104 and the surrounding rock face while water 2112 is added to the interior of the liner 2104 to balance the pressure of the rising concrete 2108, thus preventing excessive deformation of the liner 2104. In Stage D, the liner 2104 has been completely surrounded by a concrete layer 2108, is filled with water 2112, and is being surmounted by a concrete plug 2114 that is shaped to contain upward-acting forces generated by the pressurized fluid contents of reservoir 2100 in various states of operation. The plug 2114 is shaped in such a manner as to resist relative movement with respect to the surrounding rock when exposed to low- or high-pressure forces. The plug 2114 is typically disc shaped (e.g., a shallow cylinder) to fill the shaft 2102 with one or more extensions (e.g., a rim) extending into a cutout in the surrounding rock. The plug 2114 will typically extend into a cutout region of surrounding rock face, where the cutout region of rock serves in part as a lip against which the pressure and other (e.g., gravity) forces may be transmitted to the bulk surrounding rock. The cutout may be a triangular, curved, or otherwise shaped to allow a similarly shaped plug 2114 to be constructed within or inserted. The plug 2114 may include a manhole (not shown) or other small access apparatus to allow access to the lower cavity and liner 2104. In other embodiments, the plug 2114 is solid and permanent when installed, except holes for access pipes and thus no easy access to the lower cavity or liner 2104 remains after construction of the plug 2114. The plug may include or consist essentially of reinforced concrete or other materials such as steel. One or more conduits 2118 permits communication (e.g., fluid, mechanical, informatic, electrical) between the interior of the lining 2104 and installations (not shown) on the surface.

FIG. 21C is a cross-sectional schematic representation of two further stages (Stage E and Stage F) of the method of construction of the illustrative lined underground reservoir 2100 represented in FIG. 21A. In Stage E, infill material 2120 (e.g., crushed rock, concrete, reinforced concrete) has placed above the plug 2114. In various embodiments, at least a portion of the space occupied by infill material 2120 in FIG. 21C may be utilized for storage of water (or other heat-transfer liquid) or equipment utilized in the construction, maintenance, and/or operation of LUR 2100. In Stage F, piping 2122 has been inserted through the conduit 2118 into the interior of the steel liner 2104 and a wellhead 2124 has been installed for connection to surface facilities (not shown). Piping 2122 reaches approximately to the bottom of vessel 2104, enabling the extraction of approximately all settled fluid (e.g., liquid) from the interior of the liner 2104. In other stages of construction of the lined underground reservoir 2100, other components, not shown, may be added, including piping for the introduction and extraction of fluids, pumps, wiring for power and telemetry, spray heads, and other components.

FIG. 21D is a cross-sectional schematic representation of Stage F (also represented in FIG. 21C) of the method of construction of the illustrative lined underground reservoir 2100 represented in FIG. 21A. In FIG. 21D, illustrative dimensions are indicated for some of the components of lined underground reservoir 2100. The shaft 2102, from the top of the wellhead 2124 to the bottom, is 11 meters in diameter and 153 meters deep. The inner liner 2104 (steel-lined portion of the reservoir 2100) is 100 meters high and 10 meters in diameter, with a volume of approximately 7,592 m³. FIG. 21D also provides a magnified view of a portion of the layers of the lined underground reservoir 2100, with illustrative approximate dimensions for these layers: i.e., from the inmost layer to the outermost, (1) steel liner 2104 (8 mm thick), viscous or sliding layer 2126 (6 mm thick), concrete layer 2108 (455 mm thick), shotcrete layer 2128 (30 mm thick), and rock face 2130 (500 mm distant from inner surface of steel liner 2104: thickness of rock, indefinite). Embedded within the concrete layer 2108 is a metal mesh layer 2132. Embedded within the shotcrete layer 2128 is a drainage pipe network 2134. The layers depicted in FIG. 21D, and their functions, are similar to those depicted in FIGS. 14A and 14B. Other sets of layers, which may include layers not depicted herein (e.g., an insulation layer), and/or the omission of layers depicted herein, are contemplated in various other embodiments of the invention.

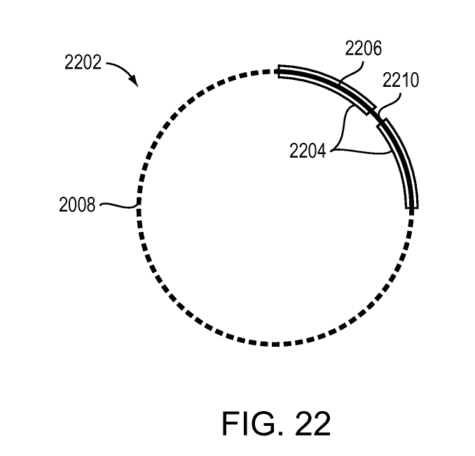

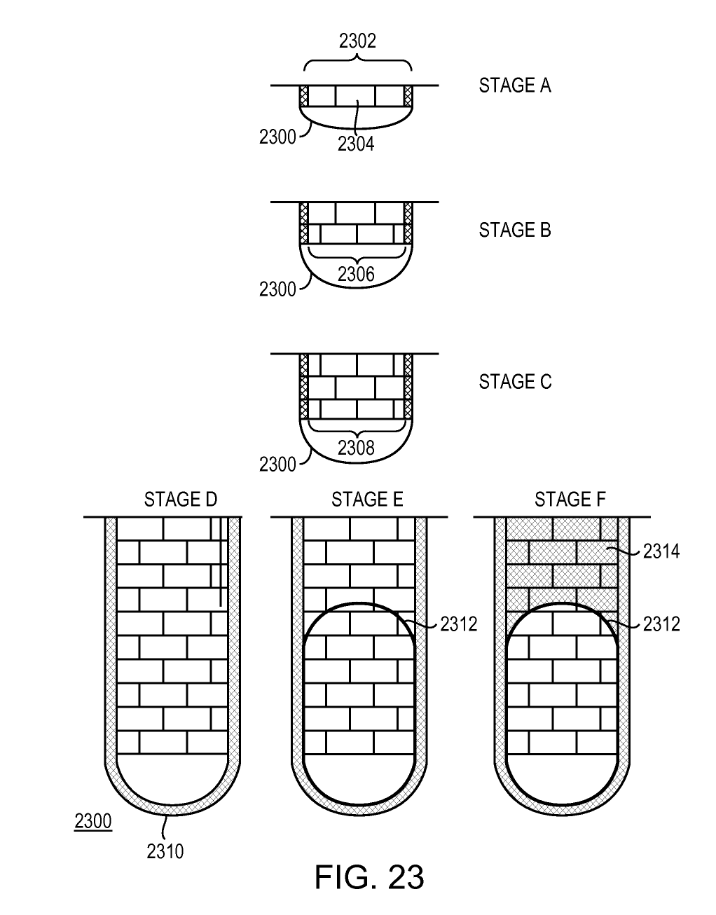

The construction of cavity liners for lined underground reservoirs—e.g., the multi-layered liner depicted in FIG. 14A, FIG. 14B, and FIG. 21D—may proceed by a variety of means. Aspects of one illustrative technique of liner construction are depicted in FIG. 22 and FIG. 23.

FIG. 22 is a cross-sectional schematic representation of the assembly of a ring-shaped segmental portion 2202 (e.g., segmental portion 1814 in FIG. 18) of a cavity liner. Preformed panels 2204, possibly manufactured at a distant location, include or consist essentially of concrete; embedded in the concrete is a metal-mesh or rebar frame 2206. The rebar frame 2206 typically protrudes beyond the edge-surfaces of each panel 2204. By arranging the panels 2204 in a circle 2208 and welding the rebar frames 2206 together, panels 2204 may be joined into a ring-shaped segmental portion 2202. The gaps between panels 2210 may be filled with concrete or otherwise grouted. The panels may be installed within an open shaft iteratively during shaft construction or installed after shaft construction. Alternatively, a fully completely ring-shaped segmental portion 2202 may be lowered into an open shaft such as shaft 1100 in FIG. 11. Adjacent ring-shaped segmental portions 2202 may be joined by rebar welding and gap grouting, just as the panels 2204 are joined to make each ring-shaped segment 2202.

In other embodiments, not shown, a cavity liner (e.g., a reinforced concrete base lining) may be constructed by using slip-form casting, in which concrete is poured into a continuously moving form. This may be very efficient for a long vertical shaft and produces a very smooth surface on which may be installed the impermeable lining.

FIG. 23 is a cross-sectional schematic representation of stages of an illustrative method of emplacing segmental portions of a cavity liner in an open shaft. In Stage A, excavation of a shaft 2300 has been commenced in a setting where it is desirable to stabilize the walls of the shaft 2300 as it is deepened. When the shaft 2300 is deep enough to accommodate a ring-shaped segmental portion (“segment”) 2302 of lining, panels 2304 similar to panel 2204 in FIG. 22 are lowered into the shaft 2300 and assembled into a segment 2302. In Stage B, the shaft 2300 has been deepened sufficiently to allow the emplacement of a second segment 2306. In Stage C, the shaft 2300 has been deepened sufficiently to allow the emplacement of a third segment 2308. In Stage D, shaft 2300 has reached its desired final depth and an invert liner 2310 has been constructed (e.g., by conventional concrete forming or by segmented assembly). In Stage E, an impermeable liner 2312 (e.g. one including or consisting essentially of metal and/or plastic) has been emplaced in the shaft 2300. The impermeable liner 2312 may be emplaced by the method of segmental assembly depicted in FIG. 18 or by other methods such as direct attachment to the cavity liner 2304, 2306, 2308, 2310. Because the impermeable liner 2312 may be attached to the cavity liner, it does not need to support its own weight as in FIG. 14 and FIG. 18, thus the liner may consist of a thin steel sheet (e.g. stainless steel sheet metal) or of a plastic (e.g., one or more polymeric materials) liner connected (e.g., welded and/or bonded) together to be impermeable to gas. In fact, the liner 2312 may not be “self-supporting,” i.e., the liner, being supported by other materials (e.g., the cavity liner) during assembly, may be of insufficient thickness and/or strength to support itself in the absence of such support material(s). Thus, in the absence of such materials, the assembled liner would, at least to some extent, lose structural stability due to the force of its own weight.

Plastic liners may include or consist essentially of pre-manufactured sheets or plates of polymer material (e.g., approximately 10 mm thick) that are welded or melted together in situ to form a liner, or of liners constructed in situ by spraying or painting, or by other means (e.g., in situ inflation and emplacement of a liner manufactured elsewhere). Pre-manufactured sheet-type polymer liners may include or consist essentially of thermoplastics such as polypropylene and high-density polyethylene. Spray-on liners may include or consist essentially of thermosetting plastics such as epoxy and polyurethane. Liners may also consist of sandwich or composite materials, e.g., a combination of polyurethane for flexibility and glass-fiber reinforced epoxy for high strength and chemical resistance.

In Stage F, additional material 2314 such as a reinforced concrete plug (not shown), additional concrete, and overfill has been emplaced over the liner 2312. The additional material 2314 may additionally include a plug (not shown) that may extend into the surrounding rock and may serve as or separately consist of a plug to distribute upward pressure forces from the dome of the liner 2312, in part or entirely. In other stages of the illustrative construction process depicted in FIG. 23, other components, not shown, may be added, including piping for the introduction and extraction of fluids, pumps, wiring for power and telemetry, spray heads, and other components.

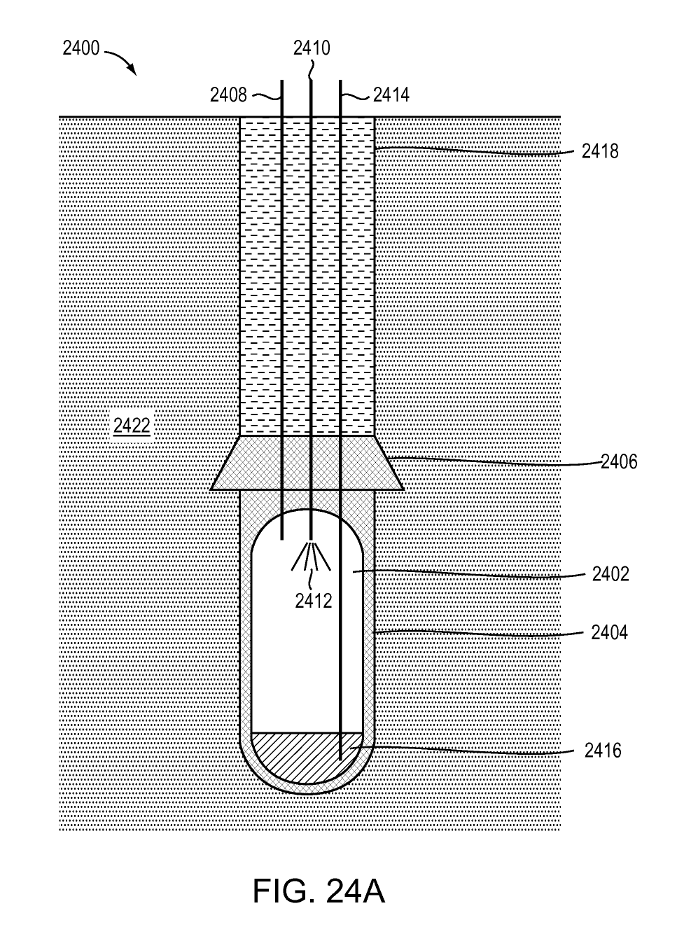

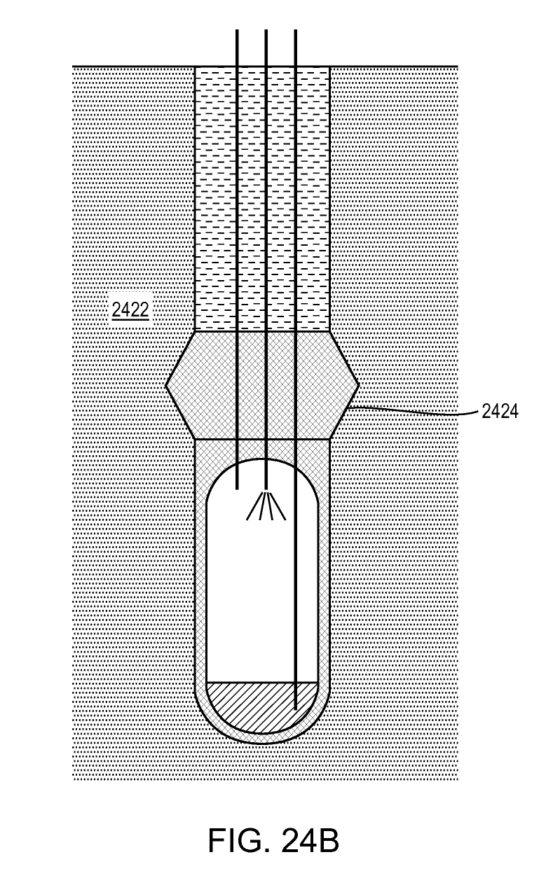

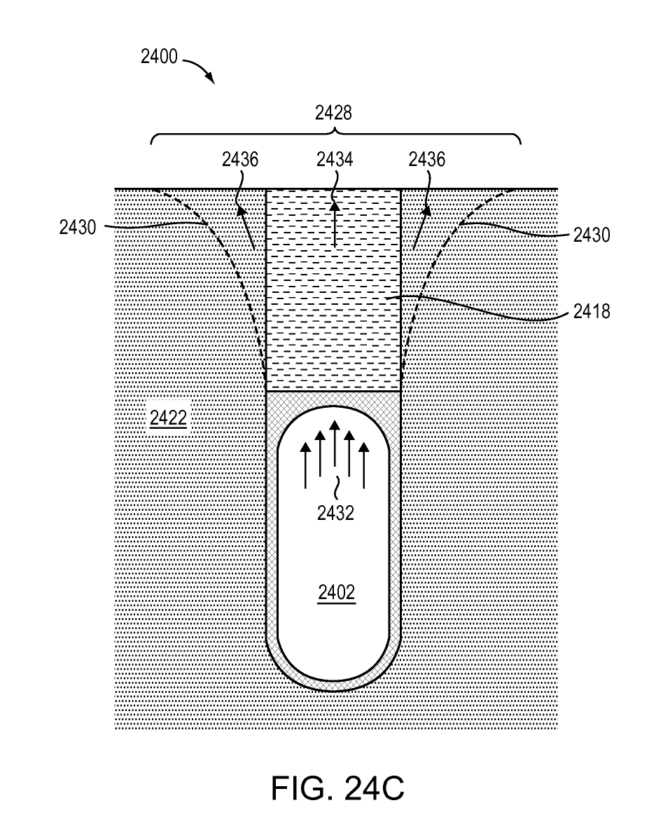

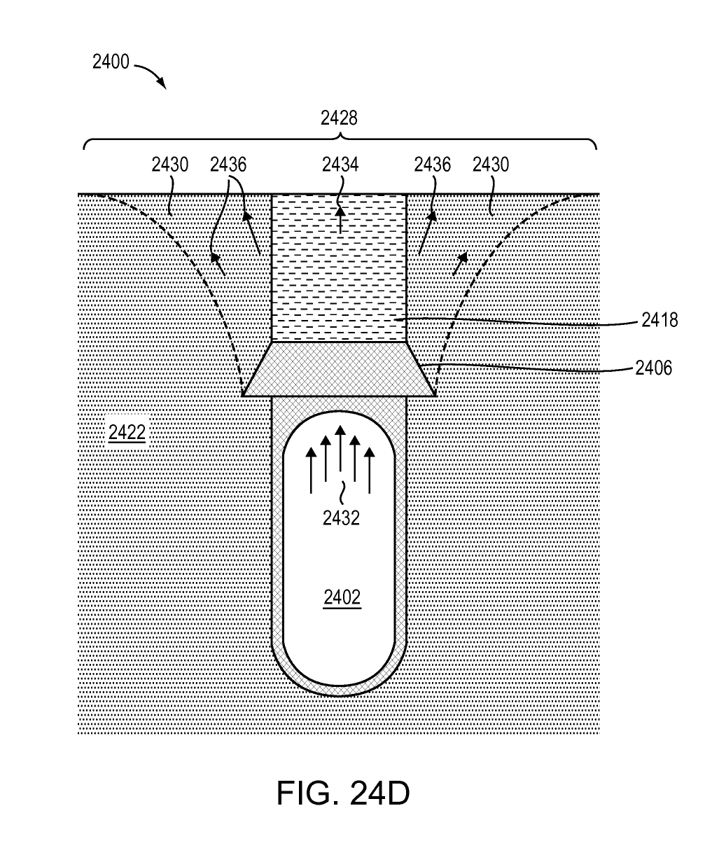

FIG. 24A is a cross-sectional schematic representation of portions of a lined underground reservoir system 2400. System 2400 includes a lined cavity 2402, a lining 2404 including or consisting essentially of concrete and possibly other materials (e.g., metal mesh and/or rebar, shotcrete, piping), a plug or pressure barrier 2406 that resists expansive forces exerted by pressurized fluids within cavity 2402, a first piping 2408 for injecting gas into and removing gas from cavity 2402, a second piping 2410 for injecting a heat-exchange fluid 2412 (e.g., liquid, foam) into cavity 2402 in order to thermally condition fluids within cavity 2402, a third piping 2414 through which settled fluid 2416 may be extracted from the cavity 2402, and an infill barrier zone 2418. It is desirable that the large forces produced by high-pressure fluids within the cavity 2402 be distributed widely through the rock mass 2422 as well as potentially through the infill barrier 2418. For example, for a cylindrical cavity 2402 with a diameter of 10 meters, filled with gas at 3,000 psi, a total outward-acting force of 6.9×10⁸ pounds is exerted on the upper domed portion of the cavity 2402 alone. The uplift and distortion of rock 2422 caused by such forces preferably remains within acceptable limits. In some designs, the infill barrier zone 2418 may be used for other purposes, such as storage of water or equipment. In others, the infill barrier zone 2418 may be filled with various materials to aid in resistance of the force from the pressurized cylindrical cavity 2402. The weight and/or mechanical strength of the infill barrier 2418 contributes to the resistance of expansive forces exerted by pressurized fluid within cavity 2402. Also, the mechanical strength of the infill barrier 2418 and the mechanical strength of the plug 2406 support the weight of the barrier 2418 and plug 2406 during operating conditions when the cavity 2402 contains fluid at relatively low pressure (e.g., atmospheric pressure), and thus prevent the cavity 2402 from collapsing. In various embodiments, the plug 2406 includes or consists essentially of concrete or reinforced concrete. In the illustrative embodiment depicted in FIG. 24A, the plug 2406 is approximately circular in transverse cross section (not depicted) and trapezoidal in the longitudinal cross section depicted in FIG. 24A. When the cavity 2402 is filled, the wider, upper side of the trapezoidal cross-section tends to transmit forces into the body of the surrounding rock mass 2422. Transmission of forces from the cavity 2402 into the rock mass 2422, and the influence of an illustrative plug 2406 on such transmission, will be depicted in FIG. 24C and FIG. 24D.

FIG. 24B is a cross-sectional schematic representation of portions of the illustrative lined underground reservoir system 2400 in FIG. 24A, with the distinction that the plug 2424 has a hexagonal longitudinal cross-section rather than a trapezoidal cross section like that of the plug 2406 in FIG. 24A. Depending on the mechanical properties of the rock mass 2422 and on the dimensions of the plugs 2406, 2424, the plug design of FIG. 24B may distribute forces through a larger volume of the rock mass 2422 than the plug design of FIG. 24A.

A range of materials may be used for the infill barrier 2418: e.g., the infill barrier 2418 may include or consist essentially of rock tailings produced during the excavation of the shaft holding system 2400, or of such rock tailings mixed or grouted with a binding agent (e.g., cement), or of concrete, or of reinforced concrete. Although infill barrier 2418 is represented in FIG. 24A and FIG. 24B as a uniform mass of material, in various embodiments (not depicted) infill barrier 2418 may be a heterogeneous mass of materials (e.g., crushed rock; metal; concrete; reinforced concrete; other) structured in a manner that supports the weight of the infill 2418 itself, resists deformation by expansive forces from the cavity 2402, and/or partially transmits forces of weight and/or fluid pressure to the surrounding rock mass 2422. For example, the infill barrier may include or consist essentially of a series of layers or cylindrical plugs of grouted rock fragments alternating with trapezoidal or hexagonal plugs peripherally embedded in the rock mass 2422 in a manner similar to that of the plugs 2406 and 2424. Force-transmitting extensions of metal, concrete, and other materials may be extended from the mass of any plug or portion of the infill barrier 2418 to the surrounding rock mass. In general, a more-even distribution of forces over the widest feasible bulk of material overlying the cavity 2402 will allow for acceptable mitigation of pressure-induced deformations at the lowest possible total shaft depth; this in turn will reduce system costs. The infill barrier 2418 may extend to the ground surface or some distance below it. The space above the infill barrier may be filled with liquid or used to house equipment, including compressor/expanders or other gas processing facilities.

The depth at which cavity 2402 is located beneath the earth's surface, the temperatures of the fluids stored within the cavity 2402 at various times, and the nature of the layering materials with which the cavity 2402 is surrounded (e.g., insulating, non-insulating), are among the factors that may influence the exchange of thermal energy between the contents of cavity 2402 and the surrounding rock 2422. Since the mass of the Earth is effectively infinite compared to the mass of the contents of cavity 2402, the temperature-depth gradient of rock mass 2422 will tend to retain its undisturbed, natural value away from the immediate vicinity of the lined underground reservoir 2400. Therefore, if the cavity 2402 is not lined with an effective insulator, exchange of heat between the contents of cavity 2402 and the rock 2422 may constitute either (a) a path of net energy loss for system 2400, i.e., if the contents of the cavity 2402 are warmer on average than surrounding rock 2422, or (b) a path of net energy gain for system 2400, if the contents of the cavity 2402 are cooler on average than the rock 2422. For example, an adiabatic compressed-air energy storage system with stored air cycled (stored and released) daily with a maximum storage pressure of 5 MPa (725 psi) and a constant air injection temperature of 21.5° C. may experience approximately 3.3% thermal energy loss. For a relatively deep cavity 2402, and/or relatively cool fluid contents of cavity 2402, and/or a locally steep temperature/depth gradient, this relationship may be reversed: i.e., the system 2400 may function not only as a system for storing energy, but also as a harvester of geothermal energy. The ability of any particular embodiment to function partly as a harvester of geothermal energy may depend on depth, construction materials, fluid operating temperatures, operational cycling, and/or local geothermal conditions, among other factors. The concrete used in the lined underground reservoir walls may be of an insulating type having a the thermal conductivity less than a standard concrete mixture, decreasing the rate of exchange between the surrounding rock 2422 and the fluid within the cavity 2402. The insulating concrete may be located throughout or only at certain layers such as closest to the surrounding rock 2422. Examples of insulating concrete include cellular concretes (e.g., where air voids are incorporated into concrete) and aggregate concretes (e.g., concrete made with insulating aggregates such as expanded perlite, vermiculate, and/or polystyrene pellets). Physical properties of insulating concrete vary according to mix designs, with lower density typically corresponding to higher insulating value. Insulating concretes may have thermal conductivities on the order of 2 to 10 times lower than a non-insulating concrete (where heavyweight non-insulating concrete may have a thermal conductivity exceeding 1 W/m-K). Thus, the thermal conductivity of insulating concrete utilized in various embodiments of the invention may be between approximately 0.1 W/m-K and approximately 0.5 W/m-K. Insulating layers (not shown) of other materials (e.g., polyurethane foam) may also be applied interior or exterior to the cavity 2402, decreasing the rate of exchange between the surrounding rock 2422 and the fluid with the cavity 2402.

FIG. 24C is a cross-sectional schematic representation of portions of an illustrative lined underground reservoir system 2400 like that of FIG. 24A, with the distinction that the plug 2406 depicted in FIG. 24A is absent. In FIG. 24C, illustrative forces acting on select points in the material above the cavity 2402 are indicated by arrows. In the state of operation depicted in FIG. 24C, the cavity 2402 is filled with a pressurized gas and a potential failure mode of the system 2400 is uplift of the material overlying the cavity 2402. Also, the rock 2422 surrounding the cavity 2402 is presumed, for this illustrative system, to be so rigid and so horizontally extensive that any purely lateral shifting of the rock 2422 by the pressurized contents of cavity 2402 is insignificant. Any displacement of rock 2422 and infill 2418 is, therefore, presumed to occur within a volume centered above the cavity 2402 and taking, roughly, the form of an inverted truncated cone with curving sides 2430 indicated by dashed lines. This volume is herein also termed “the cone.” The upper base of the cone is an area 2428 on the surface and centered above the cavity 2402. The lower base (not indicated in FIG. 24C) of the inverted cone is a horizontal surface area directly above the cavity 2402. Shearing (slippage between two portions of a body of material) will typically tend to occur in the rock 2422 along the surface 2430 if sufficient upward force is exerted by the pressurized contents of cavity 2402.

Given the finite flexibility of real (i.e., not idealized) earth material, some degree of uplift or doming of the area 2428—though preferably no shearing along surface 2430—may occur in any real-world setting. Such doming is deemed acceptable if it does not damage components of the system 2400, either immediately or over repeated fill-and-empty cycles; such doming is deemed unacceptable if it destroys components of the system 2400 or shortens their working lifespan significantly. The system 2400 is preferably designed, therefore, to contain the upward-acting forces 2432 generated by the pressurized contents of cavity 2402 not only to the extent that catastrophic failure of the cavity 2402 (i.e., breakthrough of gas to the surface, or explosion of part or all of the overlying area 2428) is practically impossible, but, further, to the extent that the longevity of system 2400 is not compromised.

In the absence of an advantageously shaped top-plug, as depicted in FIG. 24C, forces 2432 exerted by the contents of cavity 2402 act vertically and laterally throughout the volume of the cone having curved lateral surface 2430. Directly above the cavity 2402, a substantially vertical force 2434 is exerted upon the infill 2418. Elsewhere within the cone, angled forces 2436 (i.e., forces having both horizontal and vertical components) are exerted within the infill 2418 and rock 2422. At a given depth above the cavity 2402, the magnitude of both the vertical force 2434 and the angled forces 2436 depends primarily on the magnitude of the force 2432 exerted by the contents of cavity 2402 and on the width, at the given depth, of the cone.

FIG. 24D is a cross-sectional schematic representation of portions of the illustrative lined underground reservoir system 2400 in FIG. 24A, including the plug 2406 having a trapezoidal cross section. The primary effect of the plug 2406, with respect to the transmission of forces throughout the rock 2422 and infill 2418, is to broaden both the lower and upper bases of the inverted, truncated cone described above with regard to FIG. 24C Likewise, the plug 2406 may transmit nearly all the uplift force to the rock 2422 with little force transmitted to the infill 2418. As a result, at any given depth the vertical force 2434 is much smaller in magnitude and the angled forces are widely distributed throughout the rock 2422. In general, the upward forces 2432 originated at the top of the cavity 2402 are spread over a larger area, at any given depth, than for the plugless system depicted in FIG. 24C. This relative transmission and dissipation of force at a given depth is indicated by the greater number of the force arrows (2434, 2436) in FIG. 24D, compared to those in FIG. 24C. Doming of area 2428 is lessened, shearing along surface 2430 is rendered less likely, and, in general, damage to or failure of components of system 2400 as a result of material displacement within or above the cone is rendered less likely. The force-spreading effect of the plug 2406, or, in various other embodiments, a plug of some other form (e.g., plug 2424 of FIG. 24B), may thus be used to (a) increase the safety factor of the system 2400, (b) enable a cavity 2402 at a certain depth to store fluid at a higher peak pressure than would be feasible without the plug 2424, (c) enable a cavity 2402 storing fluid at a given peak pressure to be constructed at a lesser depth (and therefore more economically) than would be feasible without the plug 2424, or (d) some combination of two or more of (a), (b), and (c).

Plugs (pressure barriers) of orientations or cross-sectional forms different from those illustratively depicted in FIG. 24A, FIG. 24B, and FIG. 24D are also contemplated and in some cases may be more effective than those depicted. For example, the pressure barrier 2406 of FIG. 24A might be constructed, in various embodiments, with a smoothly curved surface (e.g., a surface protruding into the surrounding rock at one or more points).

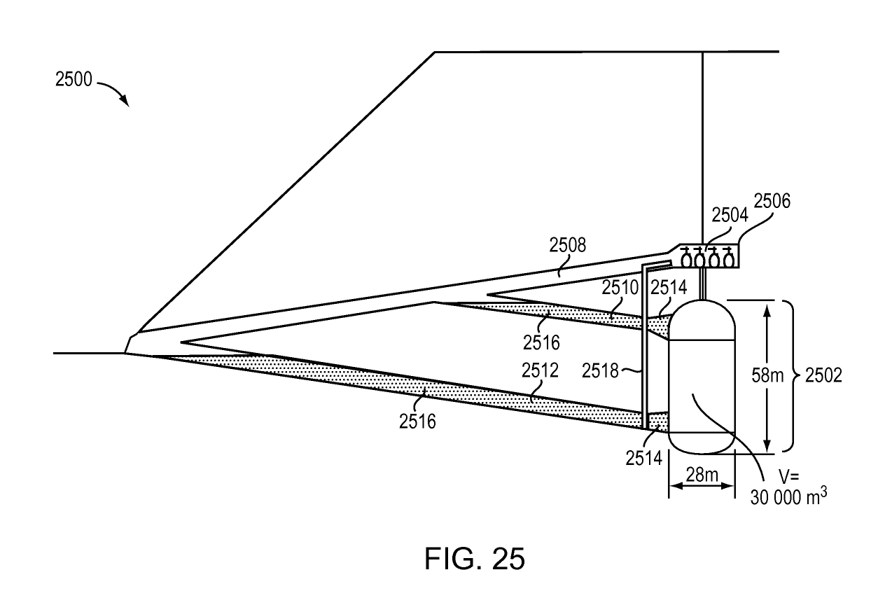

FIG. 25 is a cross-sectional schematic representation of portions of an illustrative energy storage and generation system 2500 that includes a lined underground reservoir 2502. The lined underground reservoir 2502 is similar to that depicted in FIG. 9C, albeit with certain differences. The system 2500 includes a power system 2504, which may resemble systems shown and described in the '207 patent and the '155 patent, for the interconversion of electrical, thermal, and elastic potential energy. Primarily, the power system 2504 (a) interconverts electricity with the elastic potential energy of gas expanded and/or compressed at approximately constant temperature (i.e., isothermally) and (b) interconverts the thermal energy of gas and/or a heat-exchange liquid with the elastic potential energy of gas to be expanded and/or compressed. Herein, the system 2504 is termed an “isothermal power system.” Bodies of heat-exchange liquid (or liquids) may be employed both for the exchange of heat with gas stored in the reservoir 2502 and as thermal reservoirs (i.e., thermal wells); in various other embodiments, they may be employed additionally or alternatively as reservoirs of gravitational potential energy. It may be desirable, in various circumstances (e.g., installation in an urban area) to minimize the surface area occupied by facilities associated with system 2500; in such circumstances, the isothermal power system 2504 may be located, as in system 2500, in a chamber 2506 beneath the surface of the ground. Chamber 2506 may be excavated during the excavation of reservoir 2502 through upper, middle, and lower access tunnels 2508, 2510, and 2512, and access to the isothermal power system 2504 may be maintained through upper access tunnel 2508. Since the lower ends of sloping access tunnels 2510 and 1512 are sealed by plugs 2514 to prevent fluids from escaping reservoir 2502, heat-exchange liquid 2516 may be stored in the portions of the lower access tunnel 2512 and middle access tunnel 2510. The isothermal power system 2504 may add liquid to or extract liquid from the tunnels 2510, 2512 through piping 2518. In the system 2500, all major components—power system, liquid storage, and gas storage—are located underground, out of sight. Moreover, an energy storage and retrieval system thus located would be to a large extent safeguarded from natural forces, accidents, and deliberate attack. The power system 2504 may also be a gas processing facility or other energy storage power unit.

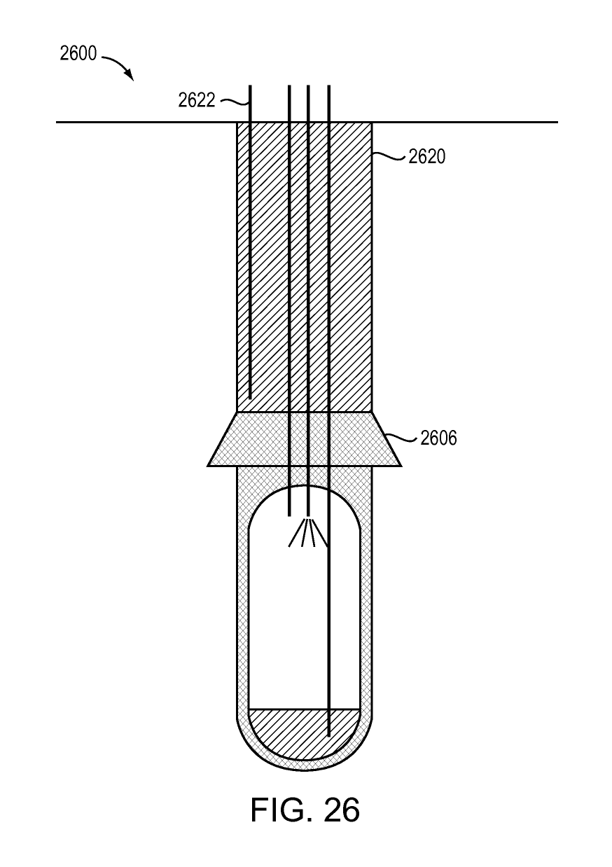

Storage of a volume of heat-exchange liquid may also be achieved in various other embodiments without use of surface vessels for liquid storage. FIG. 26 is a cross-sectional schematic representation of portions of a lined underground reservoir system 2600 that is similar in most respects to lined underground reservoir system 2400 of FIG. 24A, with the distinction that instead of a solid infill barrier 2418 (FIG. 24A), the shaft of system 2600 is infilled with a reservoir 2620 of heat-exchange liquid on top of the plug 2606. Also, system 2600 is equipped with piping 2622 for the addition of liquid to and subtraction of liquid from the reservoir 2620.

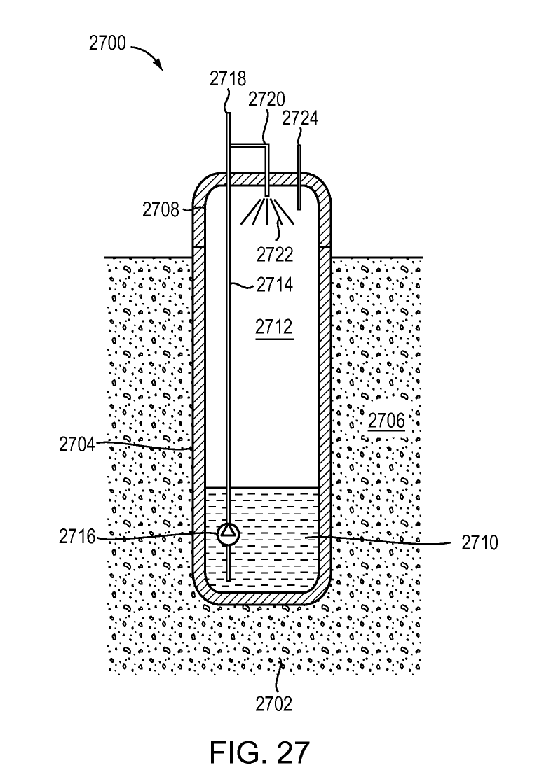

If the lining surrounding the inner cavity of a lined underground reservoir storage system is of sufficient strength, infilling may be dispensed with, and the lined portion of the storage system may protrude above the surface of the ground. FIG. 27 is a schematic representation of portions of an illustrative embodiment of the invention in which the lined portion of the storage system protrudes above the surface of the ground. LUR system 2700 is disposed at least partially within a vertical, artificial cavern or shaft 2702, typically but not necessarily circular in cross-section, which may be part of a larger system (not shown) for the storage and recovery of energy.

In various embodiments, system 2700 is a recessed LUR containing fluid that may be pressurized and/or heated. Pressurization of the fluid enables the storage of elastic potential energy; heating of the fluid enables the storage of thermal energy; and a stored fluid may be both pressurized and heated. Shaft 2702 may be lined with an impermeable material that prevents leakage of fluids into or out of the shaft 2702; the material may also act as a thermal insulator. Alternatively or additionally, shaft 2702 may be lined with a distinct layer that acts primarily as a thermal insulator.

In the illustrative embodiment depicted in FIG. 27, shaft 2702 is vertical and circular in cross-section. As the shaft 2702 is sunk, a liner 2704 (which includes or consists essentially of reinforced concrete such as in a pre-stressed concrete storage vessel and/or some other material) for the interior wall of the shaft 2702 may be installed in a series of rings, each ring being added below previous rings as the excavating machine increases the depth of the bore by a suitable amount. The inner and/or outer surface of the liner 2704 may be coated with one or more coatings or additional layers of material (not shown in FIG. 27), which may serve to prevent leakage of fluid into or out of the shaft 2702, to preserve the liner 2704 from corrosion or degradation, to thermally insulate the shaft 2702 from the surrounding earth 2706, or more perform two or more of these functions. In general, a shaft 2702 of greater depth and/or radius will be capable of storing more thermal and elastic potential energy than a shaft 2702 of smaller depth and/or radius.

Additionally, a cap or dome 2708 is connected to the top of the shaft 2702 and liner 2704 in order to produce a sealed recessed storage reservoir. Cap 2708 may include or consist essentially of reinforced concrete and/or one or more other durable materials and, like the liner 2704 of shaft 2702, may be coated with one or more coatings or additional layers of material (not shown in FIG. 27), interiorly and/or exteriorly, that may serve to seal, protect, or insulate the cap 2708.

In the illustrative embodiment depicted in FIG. 27, reservoir 2700 contains an accumulation of fluid (e.g., foam or liquid) 2710 and gas 2712. The gas 2712 occupies the portion of shaft 2702 not occupied by non-gaseous fluid 2710. The contents of reservoir 2700 may be at high pressure (e.g., 3,000 psig) and relatively high temperature (e.g., 60° C.).

Piping 2714 passes through cap 2708 (or, in various other embodiments, some portion of the liner 2704 of reservoir 2700) and extends to near the bottom of the shaft 2702. A pump 2716 is capable of drawing fluid 2710 into piping 2714 and expelling the fluid from the shaft 2702. Power, control, and data cables (not shown) may also enter reservoir 2700, enabling the control and operation of pump 2716 and communication with sensors (not shown) inside shaft 2702 that provide information to operators of reservoir 2700 on various physical variables, e.g., pressure and temperature of the fluid contents of reservoir 2700 and depth of fluid 2710.

Fluid expelled from reservoir 2700 by pump 2716 may be directed via piping 2718 to reservoirs, cylinders, or other components of an energy storage and recovery system (not shown), or may be directed via piping 2720 to a spray head or nozzle (not explicitly shown) for the generation of a foam or droplet spray 2722 within the gas-filled portion of reservoir 2700. The foam or droplet spray 2722 may exchange heat with the fluids inside reservoir 2700. In various embodiments, fluid passing through piping 2720 is additionally passed through pumps, valves, heat exchangers, and other devices (not shown) before being returned to the interior of reservoir 2700. Additional piping 2724 allows the addition to or removal from reservoir 2700 of gas 2712.

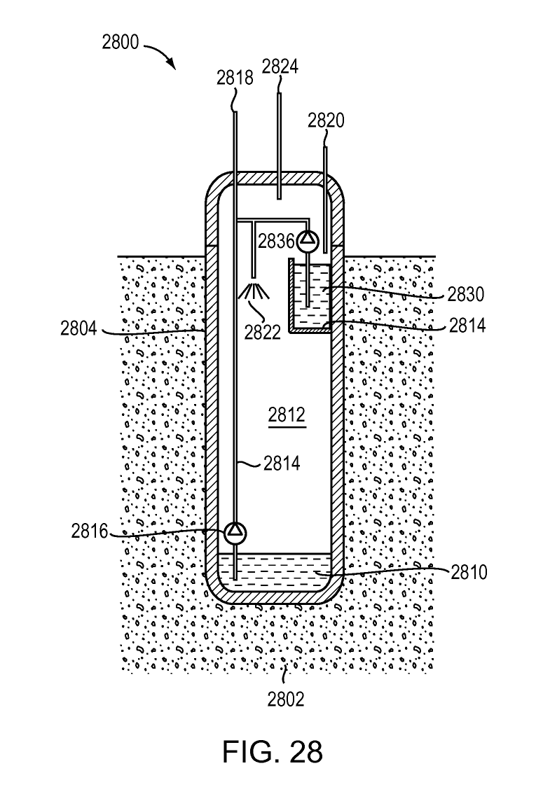

FIG. 28 is a schematic representation of portions of another illustrative embodiment of the invention. Recessed reservoir 2800 is at least partially disposed within a vertical, artificial cavern or shaft 2802, typically but not necessarily circular in cross-section, and may be part of a larger system (not shown) for the storage and recovery of energy. Shaft 2802 may be constructed by means similar to shaft 2702 in FIG. 27, and may be lined in a manner similar to shaft 2702 in FIG. 27.

A liner 2804 (which may include or consist essentially of, e.g., reinforced concrete and steel and/or other durable materials) within the interior wall of the shaft 2802 may be installed to construct a recessed reservoir capable of holding fluids at high pressure and/or at elevated temperature, as described with respect to FIG. 27. Liquid may be separated from the gaseous component prior to storage by a separator (e.g., a gravity separator), not shown, prior to delivery at elevated pressure into shaft 2802. Liquid at high pressure and/or elevated temperature may be delivered via a pipe 2820 to a secondary containment unit 2814 as illustrated in FIG. 28. This secondary containment unit 2814 may be at higher elevation than the bottom of the vertical shaft 2802. The secondary containment unit may be an open container within the liner 2804 as illustrated in FIG. 28, or may be a separate pressure vessel or vertical shaft at a higher elevation or above ground level. By keeping the liquid portion of the storage at higher elevation (closer to the elevation of the ground level), lower power (and energy) may be required to pump the liquid into and out of reservoir 2800. (That is, the vertical distance (head) is less between the ground level and secondary reservoir 2814 than between the ground level and the bottom of the vertical shaft 2802).

The separated high pressure and/or elevated temperature gas may be delivered to shaft 2802 via a pipe 2824. Liquid 2810 and 2830 may be removed from shaft 2802 via pumps 2816 and 2836. Pump 2836 will generally consume less power to pump the liquid 2830 (at least as a function of volume of liquid pumped) than will pump 2816 to pump liquid 2810, as the vertical distance from liquid 2830 to the ground surface is much less. Thus, in preferred embodiments of the invention, most or substantially all of the liquid in shaft 2802 is directed to secondary containment 2814, with only a fraction of the liquid being at the bottom of shaft 2802.

Fluid expelled from shaft 2802 by pump 2816 and from secondary containment 2814 by pump 2836 may be directed via piping 2818 to reservoirs, cylinders, or other components of an energy storage and recovery system (not shown), or may be directed via to a spray head or nozzle for the generation of a foam or droplet spray 2822 within the gas-filled portion of shaft 2802 and/or secondary containment 2814 (spray or foam in containment 2814 is not shown). The foam or droplet spray 2822 may exchange heat with the fluids inside shaft 2802 and/or secondary containment 2814. In various embodiments, fluid passing through piping 2818 is additionally passed through pumps, valves, heat exchangers, and other devices (not shown) before being returned to the interior of shaft 2802. Additional piping 2824 allows the addition to or removal from shaft 2802 of gas 2812.

Generally, the systems described herein featuring IPVs, LURs and/or recessed reservoirs may be operated in both an expansion mode and in compression mode as part of a full-cycle energy storage system with high efficiency. For example, the systems described herein may be operated so as to efficiently (e.g., substantially isothermally) store pressure and thermal potential energy delivered from an energy storage system and possibly from other sources as well, or so as to efficiently deliver to the energy storage system pressure and thermal potential energy stored within the systems described herein.

Heat-exchange liquid may be caused to exchange heat with pressurized gas in a lined underground reservoir or IPV by several methods, e.g., bringing the heat-exchanged fluid and pressurized gas into direct contact with each other or by employing a non-mixing heat exchanger that permits the liquid and gas to exchange heat through impermeable, heat-conductive barriers. If heat-exchange liquid is brought into contact with pressurized gas for the purpose of exchanging heat, it is in general preferable that the heat-exchange liquid be divided into droplets or mixed with the gas in the form of a foam in order to increase surface area over which the gas and liquid may exchange heat; or, if the volume of liquid is large relative to the volume of gas, the gas may be bubbled through the liquid to increase the surface area of contact. Lower cost for a given rate of heat exchange between bodies of liquid and gas is generally achieved by bringing the liquid and gas into direct contact with each other.

Gas stored in lined underground reservoirs or IPVs may be thermally conditioned either in situ, that is, within the reservoir or IPV, or in external devices (e.g., sprayers, bubblers, or heat exchangers located in a facility on the surface of the earth). It is generally preferable, for in situ thermal conditioning, that the heat-exchange liquid and stored gas be brought into direct contact with each other by spraying or foaming the heat-exchange liquid into the stored gas. Alternatively or additionally, heat-exchange fluid may be mixed with stored gas in order to maintain the gas at an approximately constant temperature as it is expanded in, e.g., cylinder. That is, approximately isothermal expansion of the gas may be achieved by mixing of heat-exchange liquid at an appropriate rate and temperature, as droplets or the liquid component of a foam, with the gas. Thermal conditioning of a gas may occur during compression of the gas, storage of the gas, or expansion of the gas.

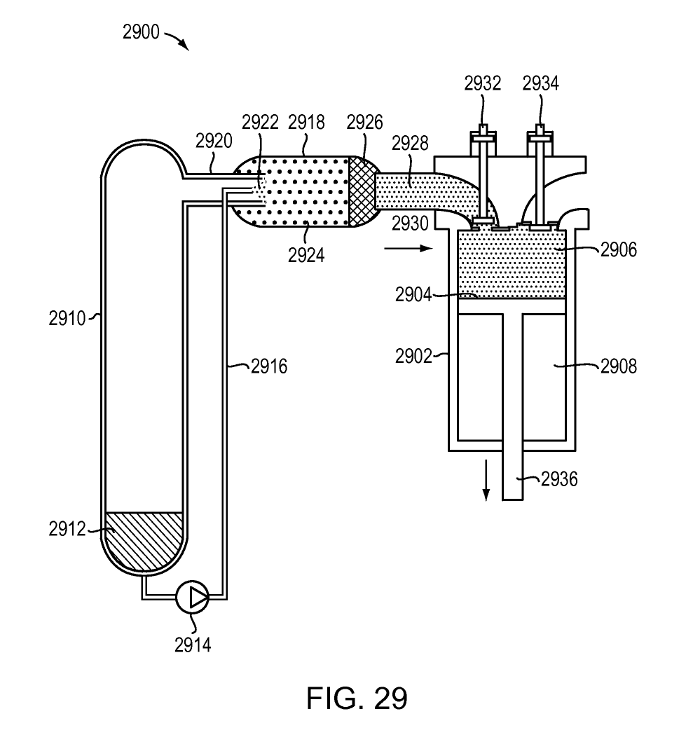

FIGS. 29-32 schematically depict several illustrative methods for thermally conditioning gas released from a lined underground reservoir, IPV, or other reservoir as or before the gas is expanded in a cylinder.

FIG. 29 is a schematic diagram showing components of a system 2900 for achieving approximately isothermal compression and expansion of a gas for energy storage and recovery using a pneumatic cylinder 2902 (shown in partial cross-section) according to embodiments of the invention. The cylinder 2902 typically contains a slidably disposed piston 2904 that divides the cylinder 2902 into two chambers 2906, 2908. A reservoir 2910, which may consist essentially of one or more pressure vessels and/or one or more IPVs, and/or one or more LURs, contains gas at high pressure (e.g., 3,000 psi); the reservoir 2910 may also contain a quantity of heat-exchange liquid 2912. The heat-exchange liquid 2912 may contain an additive that increases the liquid's tendency to foam (e.g., by lowering the surface tension of the liquid 2912). Additives may include surfactants (e.g., sulfonates), a micro-emulsion of a lubricating fluid such as mineral oil, a solution of agents such as glycols (e.g., propylene glycol), or soluble synthetics (e.g., ethanolamines). Foaming agents such as sulfonates (e.g., linear alkyl benzene sulfonate such as Bio-Soft D-40 available from Stepan Company of Illinois) may be added, or commercially available foaming concentrates such as firefighting foam concentrates (e.g., fluorosurfactant products such as those available from ChemGuard of Texas) may be used. Such additives tend to reduce liquid surface tension of water and lead to substantial foaming when sprayed. Commercially available fluids may be used at an approximately 5% solution in water, such as Mecagreen 127 (available from the Condat Corporation of Michigan), which consists in part of a micro-emulsion of mineral oil, and Quintolubric 807-WP (available from the Quaker Chemical Corporation of Pennsylvania), which consists in part of a soluble ethanolamine. Other additives may be used at higher concentrations (such as at a 50% solution in water), including Cryo-tek 100/Al (available from the Hercules Chemical Company of New Jersey), which consists in part of a propylene glycol. These fluids may be further modified to enhance foaming while being sprayed and to speed defoaming when in a reservoir.

A pump 2914 and piping 2916 may convey the heat-exchange liquid to a device herein termed a “mixing chamber” 2918. Gas from the reservoir 2910 may also be conveyed (via piping 2920) to the mixing chamber 2918. Within the mixing chamber 2918, a foam-generating mechanism 2922 combines the gas from the reservoir 2910 and the liquid conveyed by piping 2916 to create foam 2924 of a certain grade (i.e., bubble size variance, average bubble size, void fraction), herein termed Foam A, inside the mixing chamber 2918.

The mixing chamber 2918 may contain a screen 2926 or other mechanism (e.g., source of ultrasound) to vary or homogenize foam structure. Screen 2926 may be located, e.g., at or near the exit of mixing chamber 2918. Foam that has passed through the screen 2926 may have a different bubble size and other characteristics from Foam A and is herein termed Foam B (2928). In other embodiments, the screen 2926 is omitted, so that Foam A is transferred without deliberate alteration to chamber 2906.

The exit of the mixing chamber 2918 is connected by piping 2930 to a port in the cylinder 2902 that is gated by a valve 2932 (e.g., a poppet-style valve) that permits fluid from piping 2930 to enter the upper chamber (air chamber) 2906 of the cylinder 2902. Valves (not shown) may control the flow of gas from the reservoir 2910 through piping 2920 to the mixing chamber 2918, and from the mixing chamber 2918 through piping 2928 to the upper chamber 2906 of the cylinder 2902. Another valve 2934 (e.g., a poppet-style valve) permits the upper chamber 2906 to communicate with other components of the system 2900, e.g., an additional separator device (not shown), the upper chamber of another cylinder (not shown), or a vent to the ambient atmosphere (not shown).

The volume of reservoir 2910 may be large (e.g., at least approximately four times larger) relative to the volume of the mixing chamber 2918 and cylinder 2902. Foam A and Foam B are preferably statically stable foams over a portion or all of the time-scale of typical cyclic operation of system 2900: e.g., for a 120 RPM system (i.e., 0.5 seconds per revolution), the foam may remain substantially unchanged (e.g., less than 10% drainage) after 5.5 seconds or a time approximately five times greater than the revolution time.

In an initial state of operation of a procedure whereby gas stored in the reservoir 2910 is expanded to release energy, the valve 2932 is open, the valve 2934 is closed, and the piston 2904 is near top dead center of cylinder 2902 (i.e., toward the top of the cylinder 2902). Gas from the reservoir 2910 is allowed to flow through piping 2920 to the mixing chamber 2918 while liquid from the reservoir 2910 is pumped by pump 2914 to the mixing chamber 2918. The gas and liquid thus conveyed to the mixing chamber 2918 are combined by the foam-generating mechanism 2922 to form Foam A (2924), which partly or substantially fills the main chamber of the mixing chamber 2918. Exiting the mixing chamber 2918, Foam A passes through the screen 2926, being altered thereby to Foam B. Foam B, which is at approximately the same pressure as the gas stored in reservoir 2910, passes through valve 2932 into chamber 2906. In chamber 2906, Foam B exerts a force on the piston 2904 that may be communicated to a mechanism (e.g., an electric generator, not shown) external to the cylinder 2902 by a rod 2936 that is connected to piston 2904 and that passes slideably through the lower end cap of the cylinder 2902.

The gas component of the foam in chamber 2906 expands as the piston 2904 and rod 2936 move downward. At some point in the downward motion of piston 2904, the flow of gas from reservoir 2910 into the mixing chamber 2918 and thence (as the gas component of Foam B) into chamber 2906 may be ended by appropriate operation of valves (not shown). As the gas component of the foam in chamber 2906 expands, it will tend, unless heat is transferred to it, to decrease in temperature according to the Ideal Gas Law; however, if the liquid component of the foam in chamber 2906 is at a higher temperature than the gas component of the foam in chamber 2906, heat will tend to be transferred from the liquid component to the gas component. Therefore, the temperature of the gas component of the foam within chamber 2906 will tend to remain constant (approximately isothermal) as the gas component expands.

When the piston 2904 approaches bottom dead center of cylinder 2902 (i.e., has moved down to approximately its limit of motion), valve 2932 may be closed and valve 2934 may be opened, allowing the expanded gas in chamber 2906 to pass from cylinder 2902 to some other component of the system 2900, e.g., a vent or a chamber of another cylinder for further expansion.

In some embodiments, pump 2914 is a variable-speed pump, i.e., may be operated so as to transfer liquid 2912 at a slower or faster rate from the reservoir 2910 to the foam-generating mechanism 2922 and may be responsive to signals from the control system (not shown). If the rate at which liquid 2912 is transferred by the pump 2914 to the foam-mechanism 2922 is increased relative to the rate at which gas is conveyed from reservoir 2910 through piping 2920 to the mechanism 2922, the void fraction of the foam produced by the mechanism 2922 may be decreased. If the foam generated by the mechanism 2922 (Foam A) has a relatively low void fraction, the foam conveyed to chamber 2906 (Foam B) will generally also tend to have a relatively low void fraction. When the void fraction of a foam is lower, more of the foam consists of liquid, so more thermal energy may be exchanged between the gas component of the foam and the liquid component of the foam before the gas and liquid components come into thermal equilibrium with each other (i.e., cease to change in relative temperature). When gas at relatively high density (e.g., ambient temperature, high pressure) is being transferred from the reservoir 2910 to chamber 2906, it may be advantageous to generate foam having a lower void fraction, enabling the liquid fraction of the foam to exchange a correspondingly larger quantity of thermal energy with the gas fraction of the foam.

All pumps shown in subsequent figures herein may also be variable-speed pumps and may be controlled based on signals from the control system. Signals from the control system may be based on system-performance (e.g., gas temperature and/or pressure, cycle time, etc.) measurements from one or more previous cycles of compression and/or expansion.

Embodiments of the invention increase the efficiency of a system 2900 for the storage and retrieval of energy using compressed gas by enabling the surface area of a given quantity of heat-exchange liquid 2912 to be greatly increased (with correspondingly accelerated heat transfer between liquid 2912 and gas undergoing expansion or compression within cylinder 2902) with less investment of energy than would be required by alternative methods of increasing the surface of area of the liquid, e.g., the conversion of the liquid 2912 to a spray.

In other embodiments, the reservoir 2910 is a separator rather than a high-pressure storage reservoir as depicted in FIG. 29. In such embodiments, piping, valves, and other components not shown in FIG. 29 are supplied that allow the separator to be placed in fluid communication with a high-pressure gas storage reservoir as well as with the mixing chamber 2918, as shown and described in the '128 application.

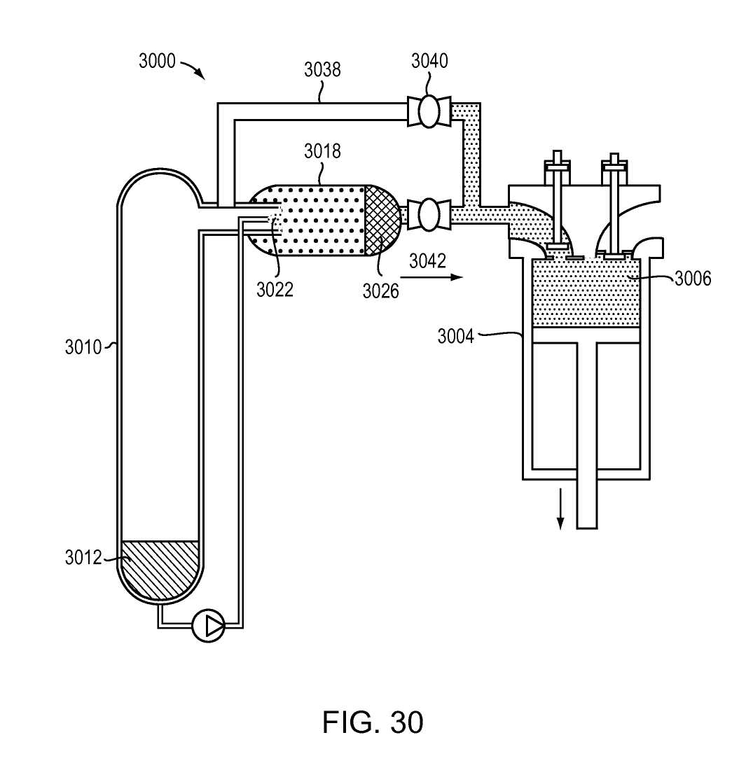

FIG. 30 is a schematic diagram showing components of a system 3000 for achieving approximately isothermal compression and expansion of a gas for energy storage and recovery using a pneumatic cylinder 3004 (shown in partial cross-section) according to embodiments of the invention. System 3000 is similar to system 2900 in FIG. 29, except that system 3000 includes a bypass pipe 3038. Moreover, two valves 3040, 3042 are explicitly depicted in FIG. 30. Bypass pipe 3038 may be employed as follows: (1) when gas is being released from the storage reservoir 3010, mixed with heat-exchange liquid 3012 in the mixing chamber 3018, and conveyed to chamber 3006 of cylinder 3004 to be expanded therein, valve 3040 will be closed and valve 3042 open; (2) when gas has been compressed in chamber 3006 of cylinder 3004 and is to be conveyed to the reservoir 3010 for storage, valve 3040 will be open and valve 3042 closed. Less friction will tend to be encountered by fluids passing through valve 3040 and bypass pipe 3038 than by fluids passing through valve 3042 and screen 3026 and around the foam-generating mechanism 3022. In other embodiments, valve 3042 is omitted, allowing fluid to be routed through the bypass pipe 3038 by the higher resistance presented by the mixing chamber 3018, and valve 3040 is a check valve preventing fluid flow when gas is being released in expansion mode. The direction of fluid flow from chamber 3006 to the reservoir 3010 via a lower-resistance pathway (i.e., the bypass pipe 3038) will tend to result in lower frictional losses during such flow and therefore higher efficiency for system 3000.

In various other embodiments, the reservoir 3010 is a separator rather than a high-pressure storage reservoir as depicted in FIG. 30. In such embodiments, piping, valves, and other components not shown in FIG. 30 are supplied that allow the separator to be placed in fluid communication with a high-pressure gas storage reservoir as well as with the mixing chamber 3018 and bypass pipe 3038.

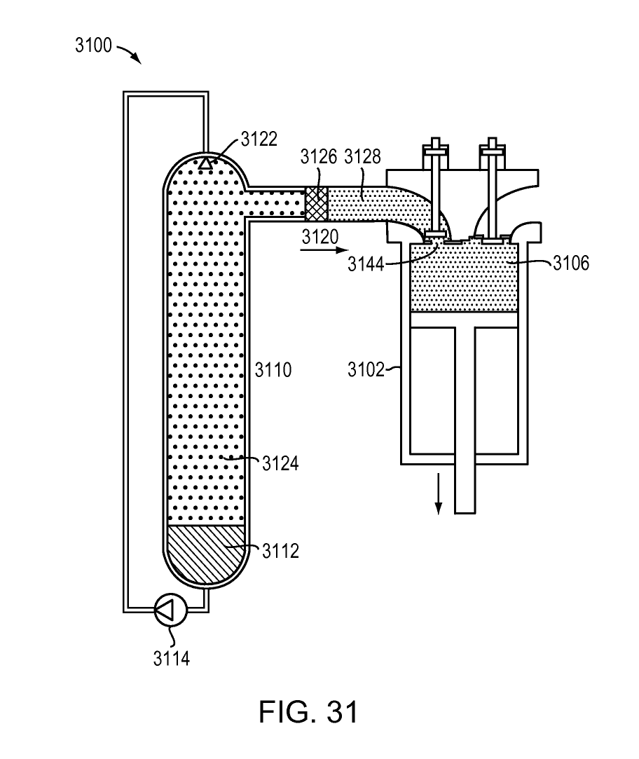

FIG. 31 is a schematic diagram showing components of a system 3100 for achieving approximately isothermal compression and expansion of a gas for energy storage and recovery using a pneumatic cylinder 3102 (shown in partial cross-section) according to embodiments of the invention. System 3100 is similar to system 2900 in FIG. 29 except that system 3100 omits the mixing chamber 2918 and instead generates foam inside the storage reservoir 3110. In system 3100, a pump 3114 circulates heat-exchange liquid 3112 to a foam-generating mechanism 3122 (e.g., one or more spray nozzles) inside the reservoir 3110. The reservoir 3110 may, by means of the pump 3114 and mechanism 3122, be filled partly or entirely by foam of an initial or original character, Foam A (3124). The reservoir 3110 may be placed in fluid communication via pipe 3120 with a valve-gated port 3144 in cylinder 3102. Valves (not shown) may govern the flow of fluid through pipe 3120. An optional screen 3126 (or other suitable mechanism such as an ultrasound source), shown in FIG. 31 inside pipe 3120 but locatable anywhere in the path of fluid flow between reservoir 3110 and chamber 3106 of the cylinder 3102, serves to alter Foam A (3124) to Foam B (3128), regulating characteristics such as bubble-size variance and average bubble size.

In other embodiments, the reservoir 3110 is a separator rather than a high-pressure storage reservoir as depicted in FIG. 31. In such embodiments, piping, valves, and other components not shown in FIG. 31 will be supplied that allow the separator to be placed in fluid communication with a high-pressure gas storage reservoir as well as with the cylinder 3102. In other embodiments, a bypass pipe similar to that depicted in FIG. 30 is added to system 3100 in order to allow fluid to pass from cylinder 3102 to reservoir 3110 without passing through the screen 3126.

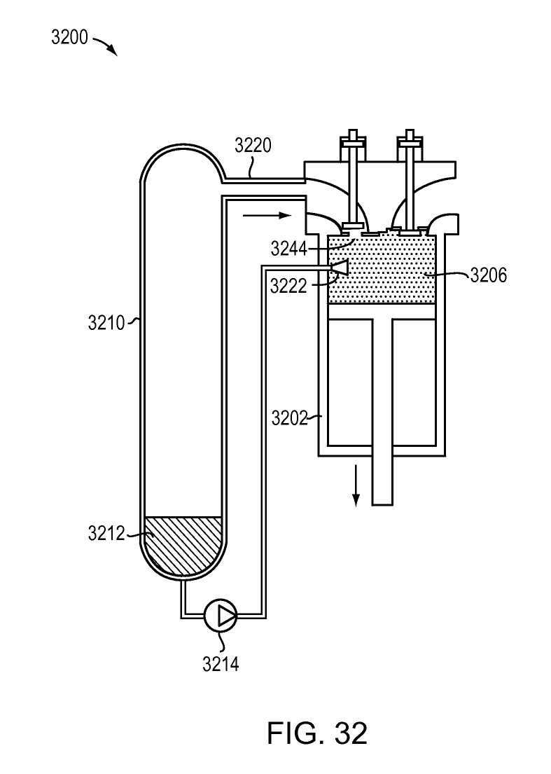

FIG. 32 is a schematic diagram showing components of a system 3200 for achieving approximately isothermal compression and expansion of a gas for energy storage and recovery using a pneumatic cylinder 3202 (shown in partial cross-section) according to embodiments of the invention. System 3200 is similar to system 2900 in FIG. 29, except that system 3200 omits the mixing chamber 2918 and instead generates foam inside the air chamber 3206 of the cylinder 3202. In system 3200, a pump 3214 circulates heat-exchange liquid 3212 to a foam-generating mechanism 3222 (e.g., one or more spray nozzles injecting into cylinder and/or onto a screen through which admitted air passes) either located within, or communicating with (e.g., through a port), chamber 3206. The chamber 3206 may, by means of the pump 3214 and mechanism 3222 (and by means of gas supplied from reservoir 3210 via pipe 3220 through a port 3244), be filled partly or substantially entirely by foam. The reservoir 3210 may be placed in fluid communication via pipe 3220 with valve-gated port 3244 in cylinder 3202. Valves (not shown) may govern the flow of fluid through pipe 3220.

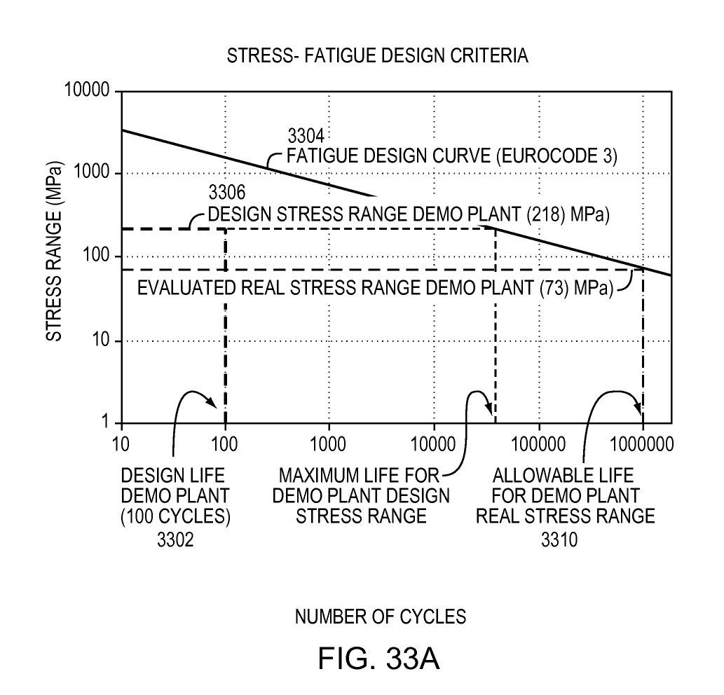

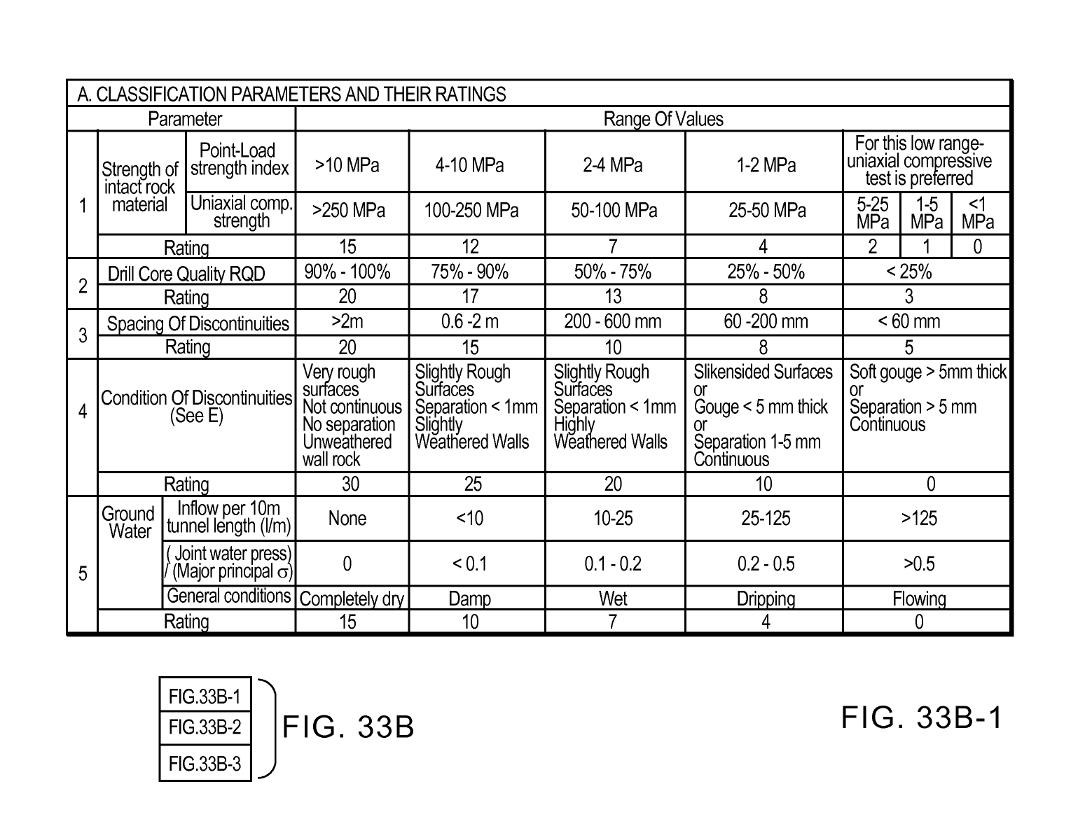

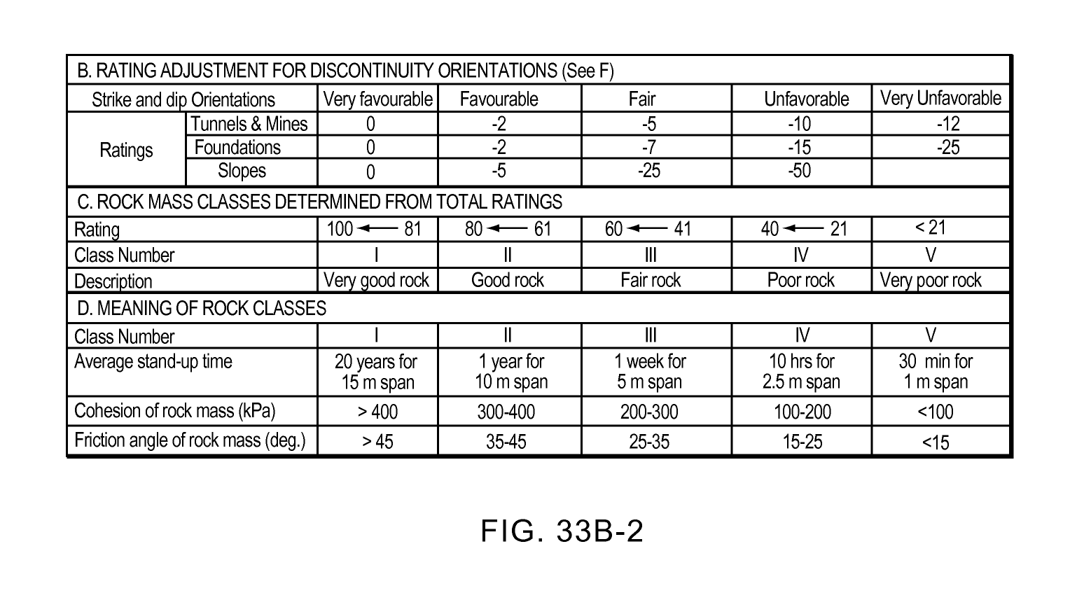

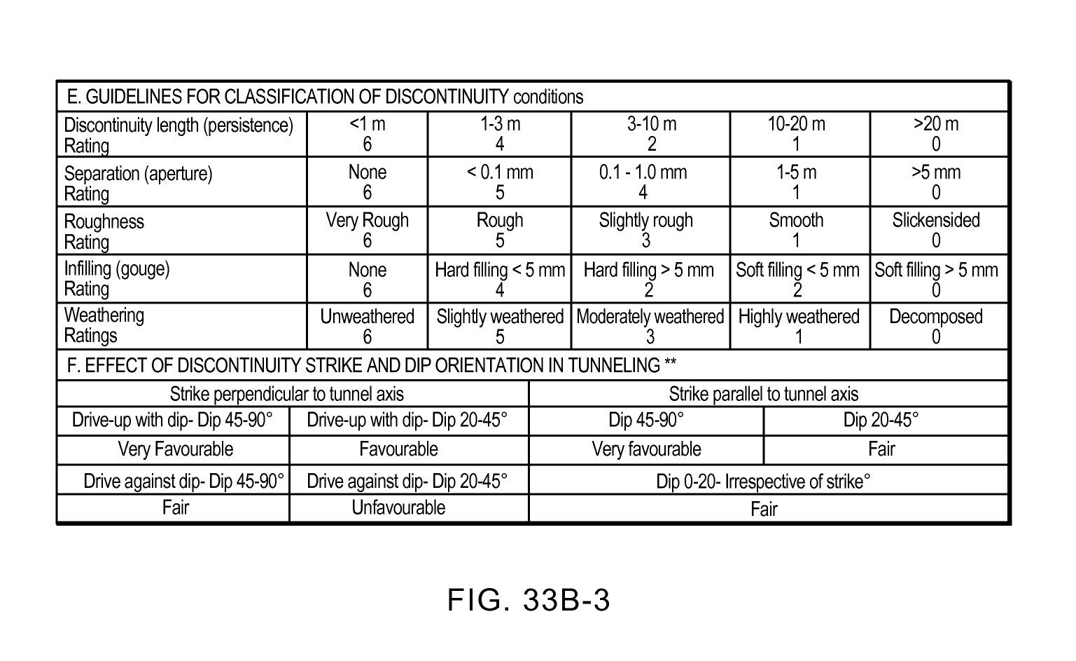

FIG. 33A is a plot of relationships between stress range (in this case, referring to fluid storage pressure) and lifespan cycle number for an illustrative LUR system utilized as a facility for storage of compressed air, herein referred to as the “Demo Plant.” The Demo Plant resembles system 900 in FIGS. 9A and 9B and has a volume of 40,000 m³. Herein, a “cycle” is complete filling of an empty storage vessel to a specified storage pressure (e.g., 3,000 psi) followed by emptying of the vessel to a lower pressure (e.g., 500 psi). The Demo Plant employs a cavity lining resembling those shown in FIG. 14A, FIG. 14B, and FIG. 21D, and a design cycle demand 3302 for the Demo Plant is to withstand 100 full operating pressure cycles. In FIG. 33A, a [Steel] Fatigue Design Curve 3304 is based on the Eurocode 3 standard (i.e., “EN 1993—Eurocode 3: Design of Steel Structures,” European Committee for Standardization, 2004, the entire disclosure of which is incorporated by reference herein). The Design Stress Range 3306 (i.e., value of the maximum stress range sustainable by the steel lining) is approximately 218 MPa. As FIG. 33A shows, the design values of 218 MPa and 100 cycles were well below the Fatigue Design Curve 3304. In fact, with a design stress range of 218 MPa, and given the lifespan limitation imposed by the Fatigue Design Curve 3304, the Demo Plant operating life is estimated at nearly 40,000 cycles. In fact, the actual stress range (based on measured rock-mass deformations) is estimated to be only approximately 73 MPa. With a stress range of 73 MPa, an Allowable Life 3310 would be about one million cycles (2,700 years of operation, at the rate of one full cycle per day). Thus, the longevity of lined underground reservoirs employed as storage vessels for rapid-cycling, large-scale storage of pressurized gasses (e.g., compressed air) is likely, in practice, very long.

The geophysical properties of a given site may affect the feasibility of constructing a lined underground reservoir at the site. To rate the geological suitability of proposed lined underground reservoir sites, a rock mass rating may be assigned to the rock mass in which construction of a lined underground reservoir is being considered. The rock mass rating system is a geological classification system developed by Z. T. Bieniawski in 1973 and revised in 1989, and is tabulated in FIG. 33B.

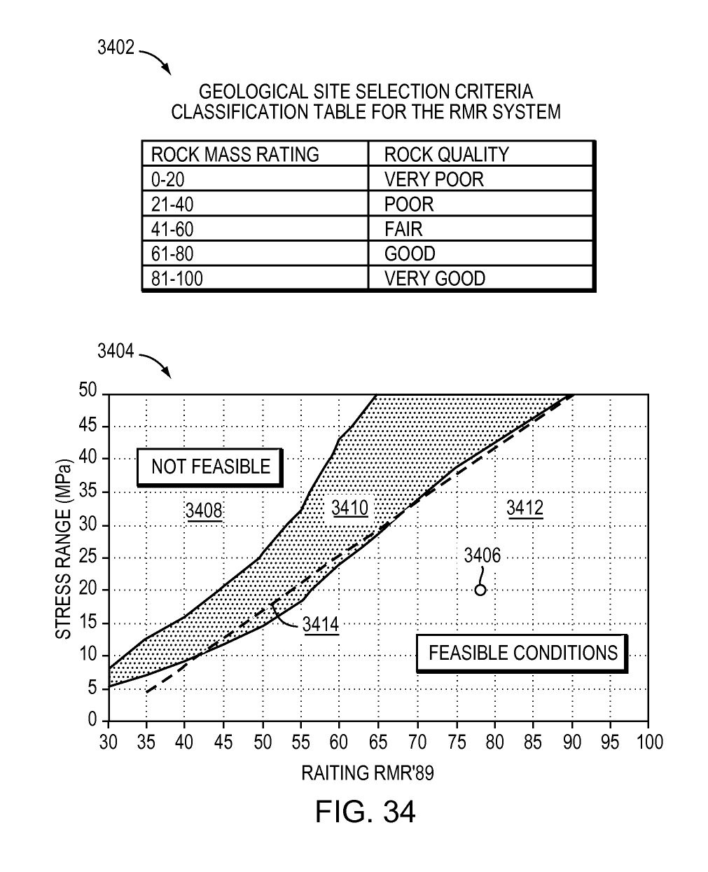

FIG. 34 shows illustrative geological criteria for use in early stages in site selection of a viable lined underground reservoir for storage of pressurized fluids (e.g., air, natural gas). A table 3402 shows a classification table for the Rock Mass Rating (RMR) system shown in FIG. 33B, matching numerical RMR values to rock quality. A plot 3404 shows the relationship between RMR rating for a rock mass (horizontal axis) and maximum storage pressure (vertical axis) of a lined underground reservoir storage pressure constructed within the rock mass. The point 3406 shows the rock-mass quality and storage pressure of the Demo Plant described with reference to FIG. 33A. In the plot 3404, a first region 3408 of generally low rock quality and pressure above approximately 7 MPa generally does not permit the construction of a viable lined underground reservoir; a second region 3410 of low-to-moderate rock quality and low-to-high pressure may permit the construction of a viable lined underground reservoir, but this is not certain; and a third region 3412 of low-to-high rock quality and low-to-high pressure does permit the construction of a viable lined underground reservoir.

In FIG. 34, a dashed line 3414 indicates a substantially linear boundary that approximately divides the region of possibly or definitely nonfeasible RMR-pressure space from the region of definitely feasible RMR-pressure space. The region of possibly or definitely nonfeasible RMR-pressure space is to the left of the dashed line 3412. The feasible region, to the right of dashed line 3412, is defined by the equation P≦(RMR×0.83)−25, where P is storage pressure in MPa (vertical axis) and RMR is the horizontal axis.

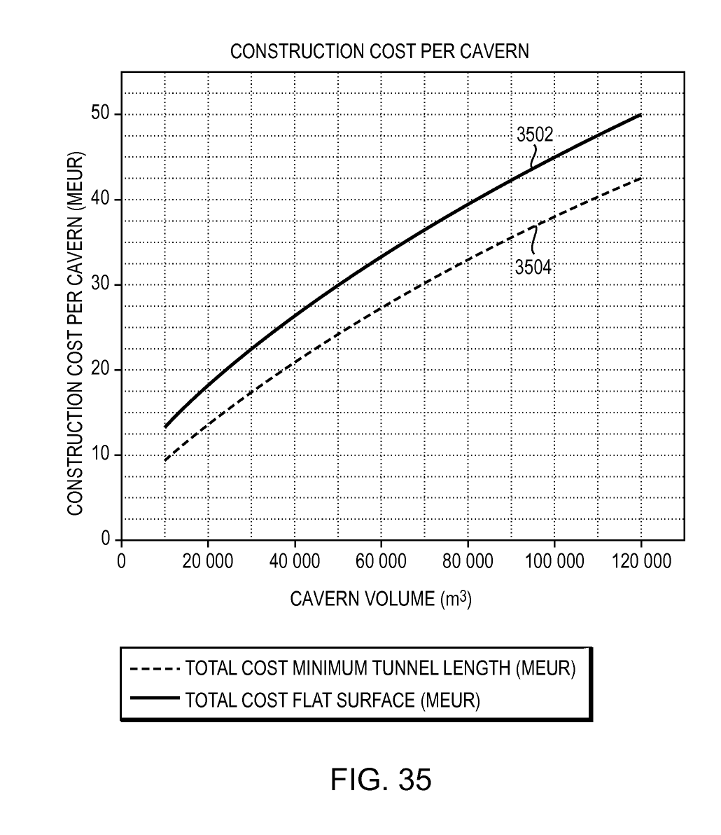

FIG. 35 shows an illustrative plot of estimated construction cost per lined underground reservoir (in units of MEUR, millions of Euros, 2012 value) as a function of reservoir volume (in units of m³) under two different conditions of local (overlying) topography. Curve 3502 shows construction cost as a function of reservoir volume for flat overlying topography (e.g., similar to that depicted in FIG. 9B). Curve 3504 shows construction cost as a function of reservoir volume for some high-relief overlying topographies (e.g., similar to that depicted in FIG. 9C) that permit minimal access-tunnel length. Flat topography requires, in general, longer access tunnels (which cannot be made excessively steep while still enabling access by standard construction vehicles, e.g., cement trucks and drilling rigs) and therefore longer construction time; high-relief topography may allow shorter access tunnels and therefore shorter construction time (and thus may enable lower construction cost). The data represented in FIG. 35 are based on utilization of the access-tunnel approach of, e.g., FIG. 9B, rather than the open-shaft approach of, e.g., FIGS. 21A-21D. The cost level reflects the approximately present European market at time of filing; the accuracy of the estimates is believed to be within ±20%.

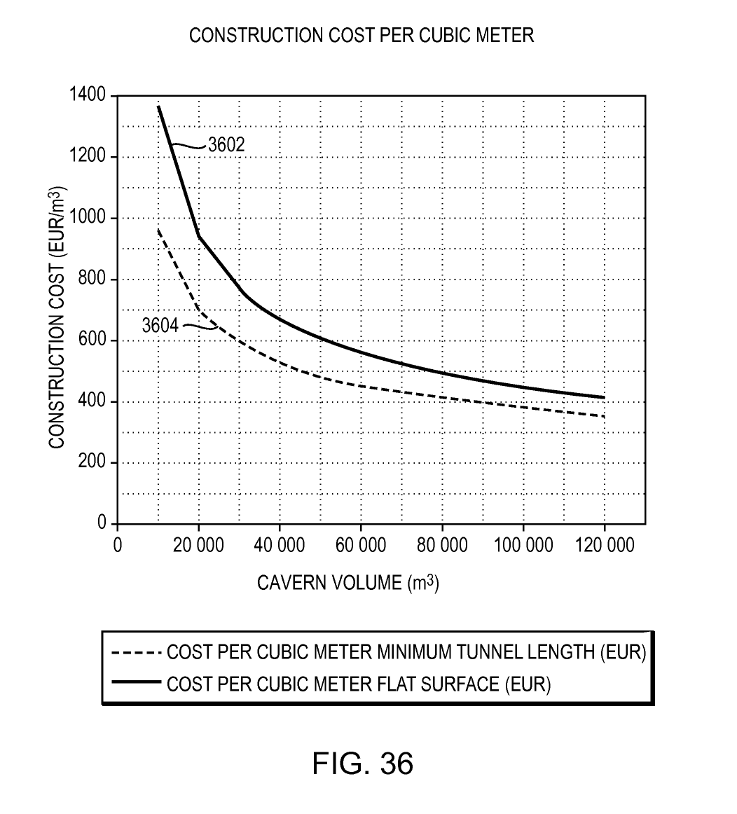

FIG. 36 shows an illustrative plot of estimated construction cost (in units of Euros, 2012 value) per cubic meter for lined underground reservoirs of the same types referred to by FIG. 35. Curve 3602 shows construction cost as a function of reservoir volume for flat overlying topography (e.g., similar to that depicted in FIG. 9B). Curve 3604 shows construction cost as a function of reservoir volume for some high-relief overlying topographies (e.g., similar to that depicted in FIG. 9C) that permit minimal access-tunnel length.

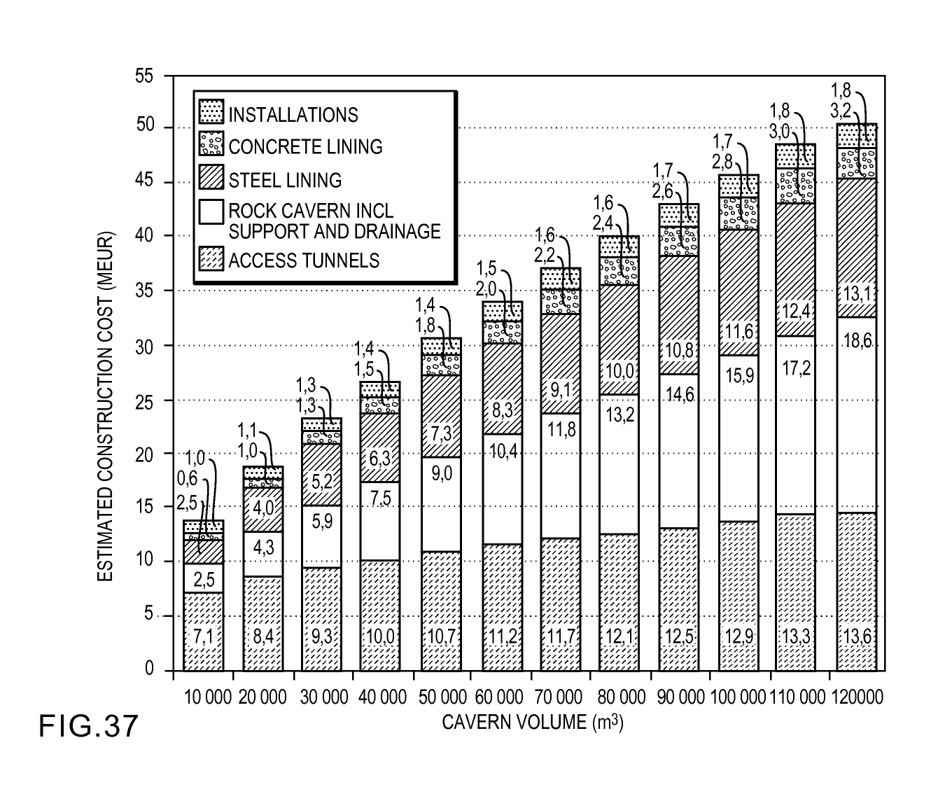

FIG. 37 shows an illustrative plot of estimated construction cost (in units of MEUR, millions of Euros, 2012 value) for a lined underground reservoir of the same type referred to by FIG. 35 and FIG. 36 as a function of reservoir volume (in units of m³), broken out by cost for (a) installations, (b) concrete lining, (c) steel lining, (d) underground reservoir construction, including support and drainage, and (e) access tunnels.

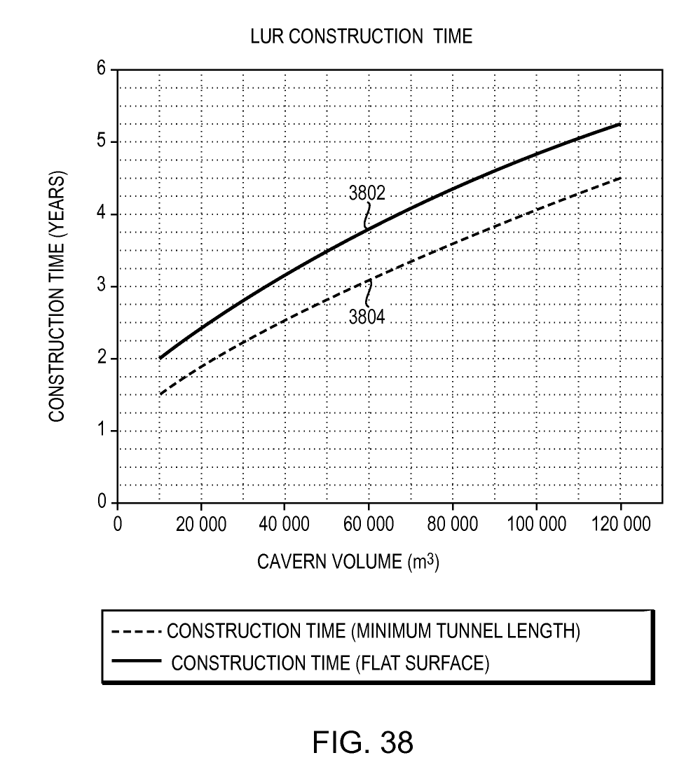

FIG. 38 shows an illustrative plot of estimated construction time (units of years) for a lined underground reservoir of the same type referred to by FIG. 35 and FIG. 36 as a function of reservoir volume (units of m³) under two different conditions of local (overlying) topography. Curve 3802 shows construction time as a function of reservoir volume for flat overlying topography (e.g., similar to that depicted in FIG. 9B). Curve 3804 shows construction time as a function of reservoir volume for some high-relief overlying topographies (e.g., similar to that depicted in FIG. 9C) that permit minimal access-tunnel length.

Construction time for open-shaft-style construction of a lined underground reservoir (e.g., as depicted in FIGS. 21A-21D) may be as low as one-fifth that for access-tunnel-style construction of a reservoir of comparable volume for small-scale (e.g. 10,000 m³) high-pressure storage (e.g., 3000 psi). This drastic difference in estimated construction time arises from the rapidity with which a roadheader type shaft-excavating device or other mechanized rock drilling machine such as that depicted FIG. 12A-12B can excavate a volume of rock as compared to excavation of access tunnels and a cavity by the standard drill-blast-and-clear method, which is comparatively slow, expensive, and hazardous to workers. For large volume (e.g., 100,000 m³) LURs, drill-and-blast techniques may proceed more rapidly than mechanized excavating machines due to both better area/volume ratio and quicker excavation.

In various embodiments of the invention, the heat-exchange fluid utilized to thermally condition gas within one or more cylinders and/or storage vessels (e.g., IPVs and/or recessed storage reservoirs) incorporates one or more additives and/or solutes, as described in U.S. Pat. No. 8,171,128, filed Apr. 8, 2011 (the '128 patent), the entire disclosure of which is incorporated herein by reference. As described in the '128 patent, the additives and/or solutes may reduce the surface tension of the heat-exchange fluid, reduce the solubility of gas into the heat-exchange fluid, and/or slow dissolution of gas into the heat-exchange fluid. They may also (i) retard or prevent corrosion, (ii) enhance lubricity, (iii) prevent formation of or kill microorganisms (such as bacteria), and/or (iv) include an agent to modify surface tension, as desired for a particular system design or application.

Embodiments of the invention may, during operation, convert energy stored in the form of compressed gas and/or recovered from the expansion of compressed gas into gravitational potential energy, e.g., of a raised mass, as described in U.S. patent application Ser. No. 13/221,563, filed Aug. 30, 2011, the entire disclosure of which is incorporated herein by reference.

Generally, the systems described herein may be operated in both an expansion mode and in the reverse compression mode as part of a full-cycle energy storage system with high efficiency. For example, the systems may be operated as both compressor and expander, storing electricity in the form of the potential energy of compressed gas and producing electricity from the potential energy of compressed gas. Alternatively, the systems may be operated independently as compressors or expanders.

The terms and expressions employed herein are used as terms of description and not of limitation, and there is no intention, in the use of such terms and expressions, of excluding any equivalents of the features shown and described or portions thereof, but it is recognized that various modifications are possible within the scope of the invention claimed.

What is claimed is:

1. A compressed-gas energy storage and recovery system comprising:
a cylinder assembly for at least one of compressing gas to store energy or expanding gas to recover energy;
a heat-exchange subsystem for thermally conditioning the gas via heat exchange between the gas and a heat-transfer liquid; and
selectively fluidly connected to the cylinder assembly, one or more insulated pipeline vessels (IPVs) for at least one of (i) storage of gas after compression, (ii) supply of compressed gas for expansion, (iii) storage of heat-transfer liquid, or (iv) supply of heat-transfer liquid.

2. The system of claim 1, wherein each IPV comprises a base material at least partially surrounded by insulation for retarding heat exchange between contents of the IPV and surroundings of the IPV.

3. The system of claim 1, wherein each IPV comprises, disposed on at least a portion of its interior surface, a corrosion-resistant coating.

4. The system of claim 1, wherein at least one IPV contains gas at a pressure higher than an ambient pressure.

5. The system of claim 1, wherein at least one IPV contains gas at a temperature higher than an ambient temperature.

6. The system of claim 1, wherein the one or more IPVs are at least partially buried underground.

7. The system of claim 6, wherein at least one IPV comprises an unburied access point for the inflow and outflow of at least one of gas or heat-transfer liquid.

8. The system of claim 1, wherein each IPV is at least partially disposed within a separate fill capsule (i) containing insulating fill and (ii) comprising an outer envelope substantially impermeable to at least one of liquid or air.

9. The system of claim 8, wherein each fill capsule is at least partially buried underground.

10. The system of claim 1, wherein the one or more IPVs comprises a plurality of IPVs, and two or more IPVs are at least partially disposed within a fill capsule (i) containing insulating fill and (ii) comprising an outer envelope substantially impermeable to at least one of liquid or air.

11. The system of claim 10, wherein the fill capsule is at least partially buried underground.

12. The system of claim 10, wherein all of the plurality of IPVs are at least partially disposed within the fill capsule.

13. The system of claim 12, wherein the fill capsule is at least partially buried underground.

14. The system of claim 1, wherein the one or more IPVs are each substantially linear and disposed lengthwise at a first non-zero angle to the horizontal such that a downhill end of each IPV is lower than an uphill end.

15. The system of claim 14, wherein at least one IPV comprises, proximate the downhill end thereof, a first access point for the inflow and outflow of heat-transfer liquid.

16. The system of claim 15, wherein the at least one IPV comprises, proximate the first access point, a second access point for the inflow and outflow of gas.

17. The system of claim 16, wherein the second access point is disposed at a distance from the downhill end sufficient to prevent blockage of the second access point by heat-transfer liquid accumulating proximate the downhill end.

18. The system of claim 15, further comprising a manifold pipe fluidly connectable to the first access points of one or more IPVs.

19. The system of claim 18, wherein the manifold pipe is inclined lengthwise at a second non-zero angle to the horizontal.

20. The system of claim 19, wherein the manifold pipe is disposed approximately perpendicular to lengths of the one or more IPVs.

21. The system of claim 19, wherein the second non-zero angle is different from the first non-zero angle.

22. The system of claim 1, wherein at least two of the one or more IPVs are fluidly connected by a connector.

23. The system of claim 22, wherein the connector comprises at least one of a manifold or a U-bend connector.

24. The system of claim 1, wherein at least one IPV comprises therewithin a mechanism for the introduction of heat-transfer liquid.

25. The system of claim 24, wherein the mechanism for the introduction of heat-transfer liquid comprises at least one of a nozzle, a spray head, or a spray rod.

26. The system of claim 24, further comprising a pump for supplying heat-transfer liquid to the mechanism.

27. The system of claim 1, wherein each IPV has a length exceeding its diameter by a factor of at least 100.

28. The system of claim 1, wherein each IPV does not fall within ASME regulations for pressure vessels.

29. The system of claim 1, wherein the heat-exchange subsystem comprises a mechanism for at least one of (i) the introduction of heat-transfer liquid into gas in the form of droplets or (ii) the mingling of heat-transfer liquid with gas to form foam.
